(19) United States
(12) Patent Application Publication
(10) Pub. No.: US 2002/0040282 A1
(43) Pub. Date: Apr. 4, 2002

(54) Drug monitoring and alerting system

(76) Inventors: Thomas C. Bailey, Kirkwood, MO (US); Laura McNamee Noirot, St. Louis, MO (US); Michael G. Kahn, Boulder, CO (US); Sherry A. Steib, St. Louis, MO (US)

Correspondence Address: LAW OFFICES OF JAMES D. IVEY, 3025 TOTTERDELL STREET, OAKLAND, CA, 94611-1742, US

(21) Appl. No.: 09/816,649

(22) Filed: Mar. 22, 2001

Related U.S. Application Data
(60) Provisional application No. 60/191,119, filed on Mar. 22, 2000.

(51) Int. Cl. G06F 15/00

(52) U.S. Cl. 702/188

(57) ABSTRACT

A clinical decision support application screens drug orders for drug dosing errors based on patient-specific information. The support application verifies that medication dosages are appropriately adjusted for renal function based upon calculated creatinine clearance (CrCI). In addition to looking for overdosing errors, other important features are its ability to detect under-dosing, and dosages and intervals that are not consistent with institution policy. The clinical decision support application also detects potentially dangerous drug combinations and serves as a safety net by providing a drug-drug interaction alert to a healthcare professional as well as reminders and escalations. Alert reports contain patient demographic data, the dose and start date of the interacting medications, pertinent laboratory or drug data, an educational comment with a recommendation for alternative therapy, and a customized outcome section that includes expected adverse events and treatment options for the detected interaction.

### FIELD OF THE INVENTION

The invention relates to computer-implemented expert systems and, in particular, to a computer system for monitoring drug orders for a medical practice.

### BACKGROUND OF THE INVENTION

It is widely known that the primary goal of healthcare organizations is the health and well-being of patients under the care of such an organization. To promote the health and well-being of patients at a competitive cost, healthcare organizations, such as hospitals for example, have become quite large and many clinicians may contribute to the treatment of a particular patient. Each such clinician can prescribe medication to such a patient and such prescriptions without full knowledge of other medications administered to the patient are increasingly common.

As a result, inappropriate medication administration in such healthcare organizations is a serious problem. Improperly administered medications can cost the patient their comfort, their health, and even their lives. Accordingly, proper medication administration is an extremely important matter for such healthcare organizations. Any system which improves medication administration has significant value to such healthcare organizations.

### SUMMARY OF THE INVENTION

In accordance with the present invention, drug orders and laboratory results for patients of a healthcare organization such as a hospital are automatically monitored and analyzed for dosing errors and drug-drug interactions. The monitoring is accomplished by using triggers on one or more databases which store patient records and drug orders for the healthcare organization. The use of triggers enables such monitoring and analysis to be accomplished without requiring physicians to enter data specific to a particular patient and/or drug order or otherwise increasing the workload of physicians. Instead, updates and additions to the databases already used for treating patients automatically initiate analysis of such updated information for dosing errors and drug-drug interactions.

Dosage monitoring verifies that drug doses are appropriately adjusted for renal function based upon calculated creatinine clearance. Overdosing, under-dosing, and dosages and intervals or frequencies that are not consistent with policies of the healthcare organization are detected.

Analysis of drug orders and laboratory results for dosing errors includes application of predetermined rules for allowable doses. Each rule specifies a range of patient weights and creatinine clearances for which the rule is applicable. Each rule can further specify one or more allowable dose amounts and one or more allowable dose frequencies. The dose amounts can be specified as absolute amounts, amount per unit of the patient's actual weight, or amount per unit of the patient's dosage weight calculated from the patient's weight and serum creatinine levels represented in laboratory results. Allowable dosing can also be specified in terms of predicted peak and trough blood levels of the drug as estimated from the dose amount and frequency and the patient's calculated creatinine clearance and ideal body weight. Rules can also specify allowable rounding values of drug orders. For example, a rule can specify that a particular drug is to be given in doses of integer multiples of 500 mg.

If a particular drug order does not comport with the predetermined rules for allowable drug orders, an alert message is directed to a clinician who then reviews the drug order and can override the dosage monitor to indicate the drug order is allowable or can modify the drug order for compliance with the predetermined rules. The alert message indicates the patient and the drug order which violates the allowable rules. In addition, the alert message includes recommendations for the drug of the violating drug order. The recommendations include recommended dosage amounts and frequencies. The dosage amounts of the recommendations, like the dosage amounts of the rules, can be expressed in absolute values or weighted values. If the recommended dosage amount is expressed in weighted values, absolute dosage amount values are calculated from patient data and laboratory result data to provide absolute recommended dosage amounts to the clinician in the alert message.

In one implementation of dosage monitoring according to the present invention, physicians agreed with recommended dosage changes 75% of the time. Approximately 3% of all drug orders so monitored are changed as a result of alert messages. Even though dosage monitoring is performed without direct interaction by the prescribing physician, prescription appropriateness is improved as evidenced by a 50% reduction in the rate of drug orders resulting in alert messages.

Drug-drug interactions are detected by monitoring and analyzing new and updated drug orders and laboratory results for patients of the healthcare organization. For example, a new drug order for a particular patient triggers analysis of all drug orders of the patient. An alert is generated if orders for any two interacting drugs are concurrently active, if orders for two interacting drugs are active too close to one another in time, or if an order for a precipitating drug follows too closely after an order for an object drug which is affected by the precipitating drug. Drug interactions, including the drugs that interact with one another and the relative timing required for interaction, are predetermined and stored in a rule database. An alert is similarly generated if a single drug order exceeds a predetermined duration limit.

A new laboratory result can also indicate a potential adverse drug effect. In particular, new and updated laboratory results are compared to predetermined ranges of acceptable values. If a laboratory result exceeds a corresponding predetermined range of acceptable values, an alert message is sent to a clinician so that the clinician can assess the patient's situation and determine whether intervention is appropriate.

Alert messages are sent to a clinician by e-mail. High priority alert messages are sent to the clinician by pager, wireless telephone, fax, and/or printer in an attempt to get the clinician's immediate attention. High priority alerts pertain to dosing errors and/or drug-drug interactions which are potentially life threatening. In either case, the clinician is required to acknowledge the alert message and enter data describing the resolution of the matter to which the alert message pertains. If the alert message is not acknowledged within a predetermined amount of time, the alert message is sent again. After a predetermined number of times of sending the alert message, the alert message is escalated. Escalation can include sending the message by a different communications channel, e.g., wireless telephone to an on-call physician, and/or by altering the message to draw more attention to itself.

The particular clinician to which the alert messages are sent is determined according to a scheduled contact database which includes contact information for each day of the week, various times of the day, and various other schedules. Such schedules can also include special schedules for holidays and vacation time for various clinicians.

### BRIEF DESCRIPTION OF THE DRAWINGS

FIG. 1 is a block diagram of a medication supervisor system according to the present invention.

FIG. 2 is a block diagram of a drug prescription and patient records database of FIG. 1 in greater detail.

FIG. 3 is a block diagram of dosage monitor records of FIG. 2 in greater detail.

FIG. 4 is a block diagram of a predetermined drug dosing rule in accordance with the present invention.

FIG. 5 is a logic flow diagram of the initialization of database triggers to initial dosing analysis in accordance with the present invention.

FIG. 6 is a logic flow diagram of dosage monitoring in accordance with the present invention.

FIG. 7 is a logic flow diagram of the determination of whether a particular drug order is allowable in accordance with the present invention.

FIG. 8 is a logic flow diagram of the evaluation of a value rule.

FIG. 9 is a logic flow diagram of the evaluation of a weighted rule.

FIG. 10 is a logic flow diagram of the evaluation of an amino rule.

FIG. 11 is a logic flow diagram of the evaluation of a first-value rule.

FIG. 12 is a logic flow diagram of the evaluation of a peak and trough rule.

FIG. 13 is a logic flow diagram of the determination by the dosage monitor of FIG. 1 of whether peak-and-trough rules indicate that a particular drug order is allowable.

FIG. 14 is a logic flow diagram of the preparation of alert message by the dosage monitor of FIG. 1.

FIG. 15 is a block diagram of ADE monitor records of FIG. 2 in greater detail.

FIG. 16 is a logic flow diagram of ADE monitoring in accordance with the present invention.

FIGS. 17-18 are logic flow diagrams of the analysis of drug orders for drug-drug interactions and drug duration errors.

FIG. 19 is a logic flow diagram of the analysis of laboratory results for panic levels.

FIG. 20 is a logic flow diagram of the sending of alert messages generated by dosage and ADE monitoring.

FIG. 21 is a logic flow diagram of the re-sending and escalation of unacknowledged alert messages.

FIGS. 22A-B are example reports illustrating allowable rules and recommendations for dosage monitoring in accordance with the present invention.

FIGS. 23-24 are screen views of alert messages and an acknowledgment interface for ADE monitoring in accordance with the present invention.

FIGS. 25-26 are screen views of alert messages and an acknowledgment interface for dosage monitoring in accordance with the present invention.

FIGS. 27-53 are logic flow diagrams of dosage monitoring in accordance with the present invention.

FIGS. 54-80 are logic flow diagrams of ADE monitoring in accordance with the present invention.

FIGS. 81-95 are logic flow diagrams for delivery of alert messages in accordance with the present invention.

### DETAILED DESCRIPTION

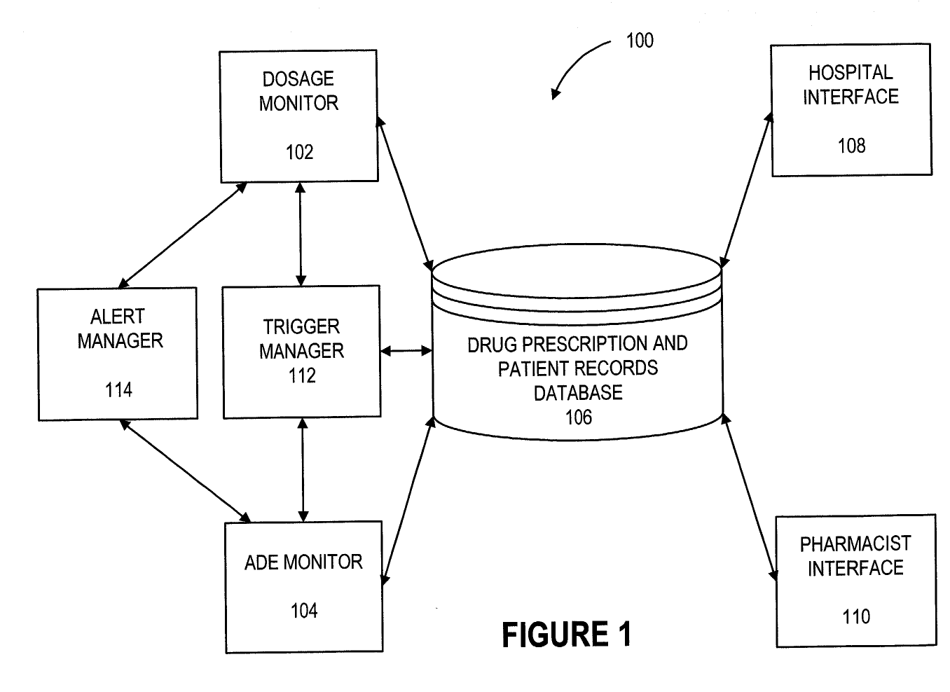

In accordance with the present invention, medication supervisor system 100 (FIG. 1) includes a dosage monitor 102 which monitors proper dosing of drugs administred to patients and an ADE monitor 104 which monitors drug orders for drug-drug interactions. In this illustrative embodiment, dosage monitor 102 and ADE monitor 104 operate without direct involvement by physicians on an ongoing basis such that work by the physicians is unimpaired by operation of dosage monitor 102 and ADE monitor 104. In particular, physicians treating patients interact with a hospital interface 108. Hospital interface 108 is a conventional hospital administration system in which clinicians and administrators enter and manage data representing various patients, their locations, their treatment, and their laboratory results. Such data is represented in a drug prescription and patient records database 106 in a conventional manner.

Similarly, pharmacists who provide drugs to such patients in accordance with prescriptions authored by physicians do so through a pharmacist interface 110. Pharmacist interface 110 is a conventional interface by which pharmacists manage patients' prescriptions. Such prescriptions are represented by data in drug prescription and patient records database 106 in a conventional manner.

Dosage monitor 102 and ADE monitor 104 operate without interrupting the conventional work of clinicians and pharmacists by use of a trigger manager 112. Trigger manager 112 sets triggers in drug prescription and patient records database 106 such that addition and/or modification of drug orders, patient records, and/or laboratory results initiate processing by dosage monitor 102 and ADE monitor 104 in the manner described more completely below. In addition, dosage monitor 102 and ADE monitor 104 use an alert manager 114 to notify one or more clinicians when an inappropriate medication order is detected in a manner described more completely below.

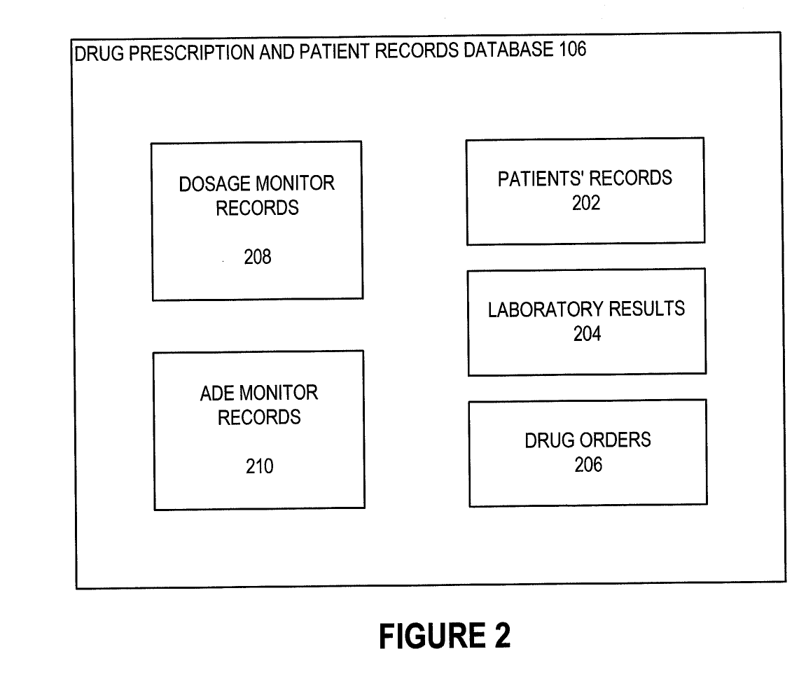

Drug prescription and patient records database 106 is shown in greater detail in FIG. 2 and includes (i) patient's records 202, (ii) laboratory results 204, (iii) drug orders 206, (iv) dosage monitor records 208, and (v) ADE monitor records 210. Patient's records 202 include data representing various patients under the care of a particular healthcare organization, including such information as the patient's name, location, admission date, discharge date, age, gender, height, and weight. Laboratory results 204 include data representing results of laboratory tests performed on such patients. Drug orders 206 include data representing various orders of drugs to be administered to the patients.

Dosage Monitor 102

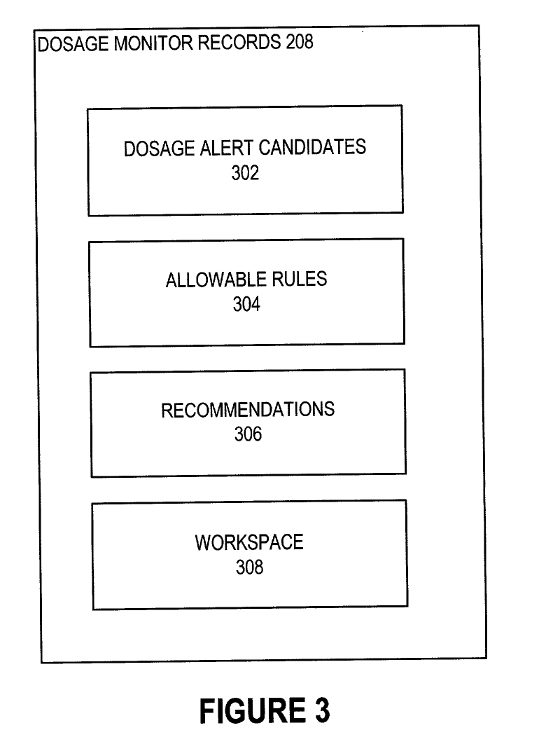

Dosage monitor records 208 is shown in greater detail in FIG. 3. Dosage monitor records 208 include (i) dosage alert candidates 302, (ii) allowable rules 304, (iii) recommendations 306, and (iv) a workspace 308. Dosage alert candidates 302 includes data representing drug orders to be analyzed by dosage monitor 102 in a manner described in greater detail below. Allowable rules 304 stores data representing rules of allowable drug orders. Such rules are configured by clinicians such that violations of the rules are to be reported. Workspace 308 which is used by dosage monitor 102 (FIG. 1) to analyze dosage alert candidates 302 (FIG. 3).

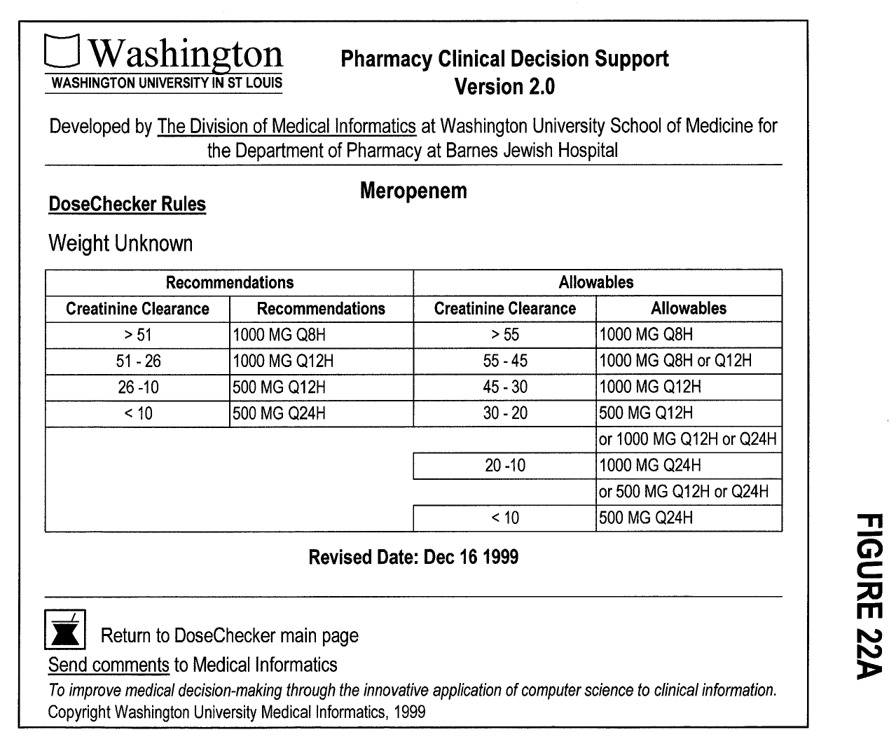

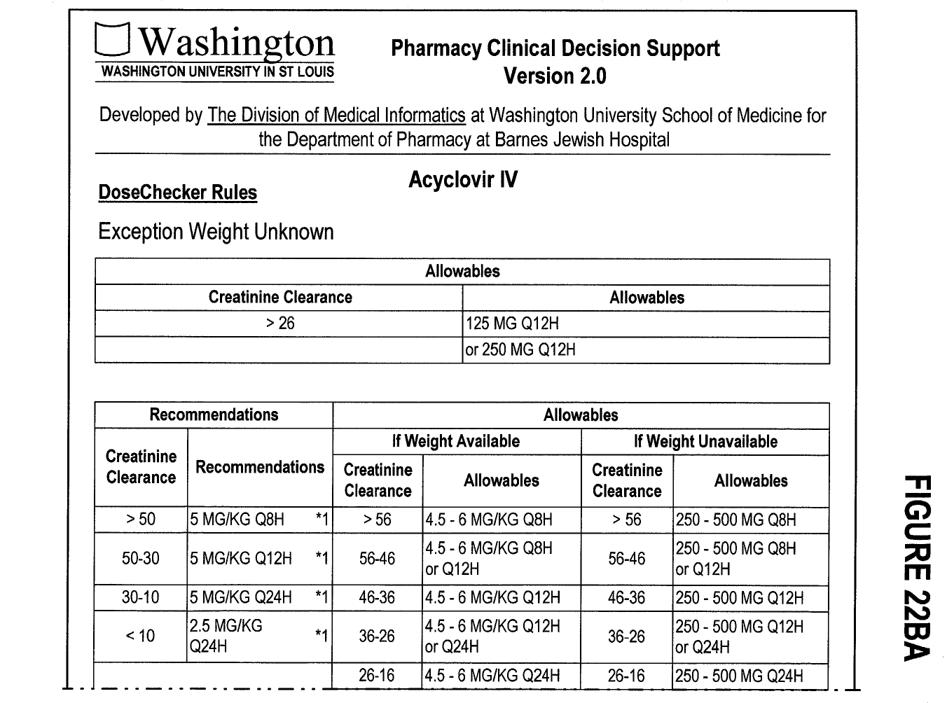

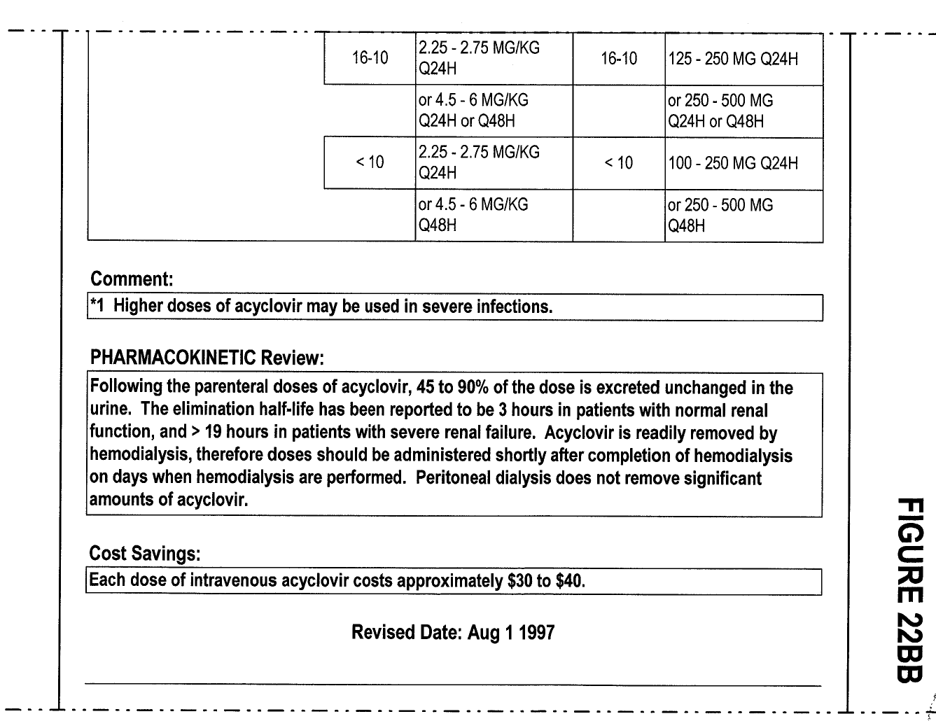

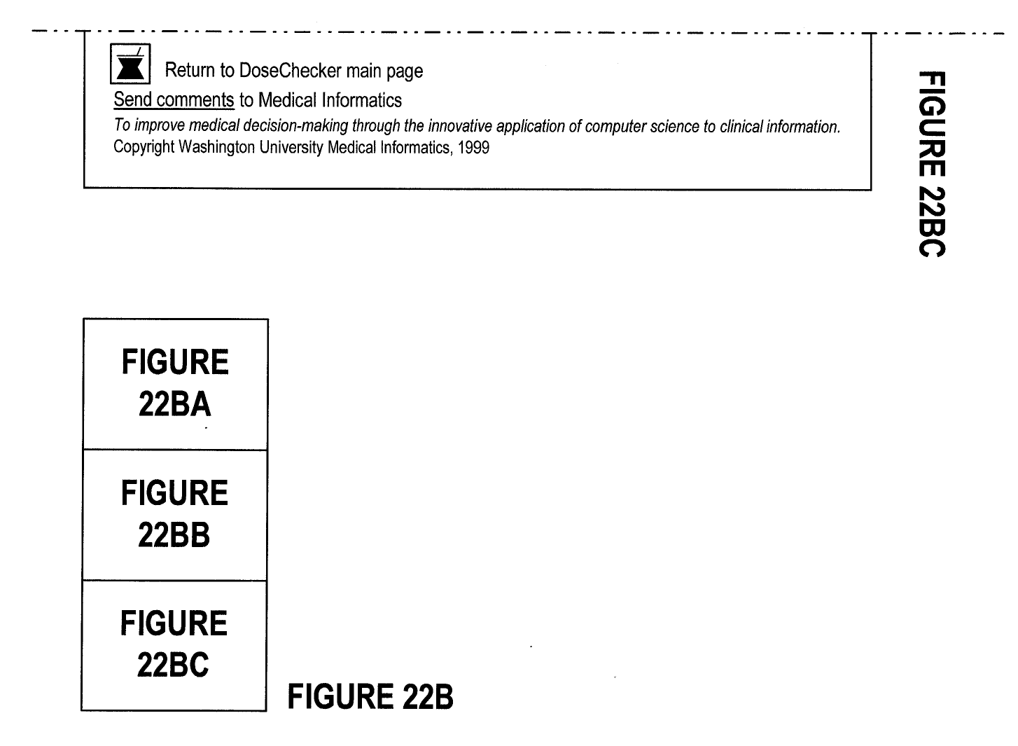

Illustrative descriptions of examples of allowable rules and recommendations are shown in FIGS. 22A-B. FIG. 22A includes an illustrative description of allowable rules and recommendations for Meropenem, and FIG. 22B includes an illustrative description of allowable rules and recommendations for Acyclovir IV according to one illustrative example of the present invention.

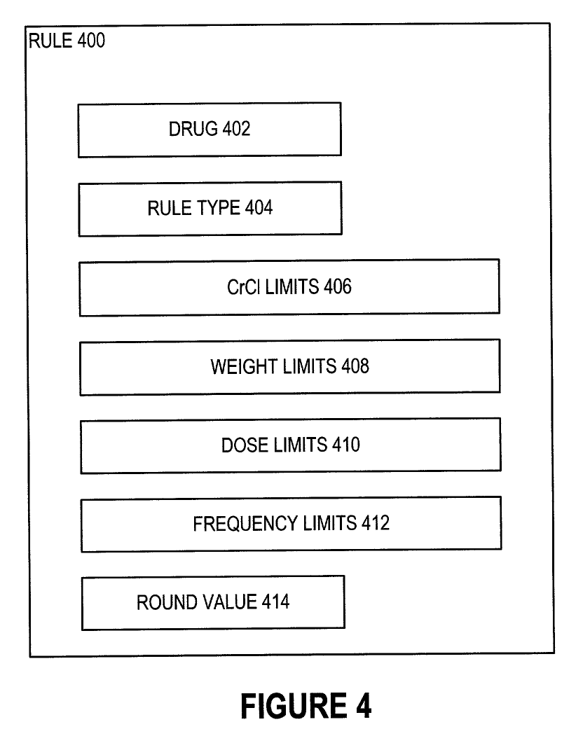

Rule 400 (FIG. 4) is representative of an allowable rule specified in allowable rules 304 (FIG. 3). Rule 400 (FIG. 4) includes a drug identifier 402 which specifies the drug to which rule 400 pertains. In one embodiment, drug identifier is a drug identifier used in Multum databases of Multum Information Services, Inc. of Denver, Colorado. Rule type 404 specifies the type of rule represented by rule 400. In this illustrative embodiment, a rule can be peak-and-trough, first-value, multiplied, amino, rounding, or value. Each of these rule types are described more completely below.

CrCl limits 406 and weight limits 408 specify creatinine clearance levels and body weights, respectively, of patients for which rule 400 is applicable. Dose limits 410 specify allowable dosage amounts according to rule 400. Frequency limits 412 specify allowable dosage frequency according to rule 400. Round value 414 specifies a dosage increment according to rule 400. For example, if round value 414 specifies 500 milligrams, an allowable dosage would be an integer multiple of 500 milligrams.

As described above, allowable rules 304 specify allowable drug orders. If dosage monitor 102 (FIG. 1) detects a violation of allowable rules 304 (FIG. 3), dosage monitor 102 (FIG. 1) alerts a clinician in the manner described below. Recommendations 306 include recommendation rules which are specified in a manner which is analogous to that described above with respect to allowable rules 304 and rule 400. The specification of allowable rules allows for minor changes in CrCl, whereas the specification for recommendations represents optimal drug therapy. As a result, a drug order which exceeds a recommended drug application by an insignificant amount (i.e., does not exceed an allowable drug application) does not generate an alert.

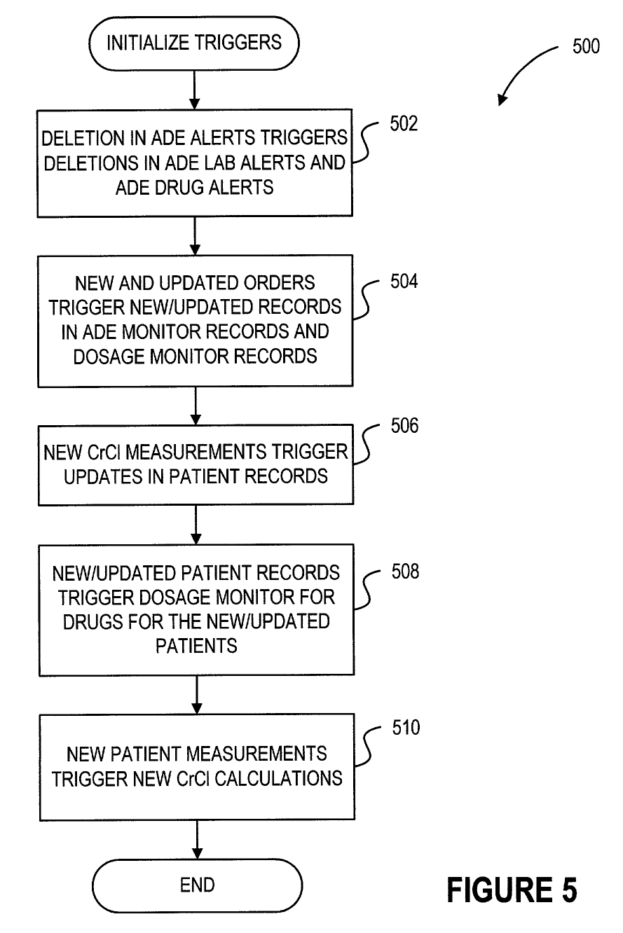

For monitoring by both dosage monitor 102 (FIG. 1) and ADE monitor 104, trigger manager 112 initializes a number of triggers on drug prescription and patient records database 106 as shown in logic flow diagram 500 (FIG. 5). In step 502, trigger manager 112 (FIG. 1) cleans up ADE alert records. Briefly, deletion of an ADE alert causes deletion of corresponding ADE drug alerts and ADE laboratory result alerts according to the trigger initialized in step 502 (FIG. 5).

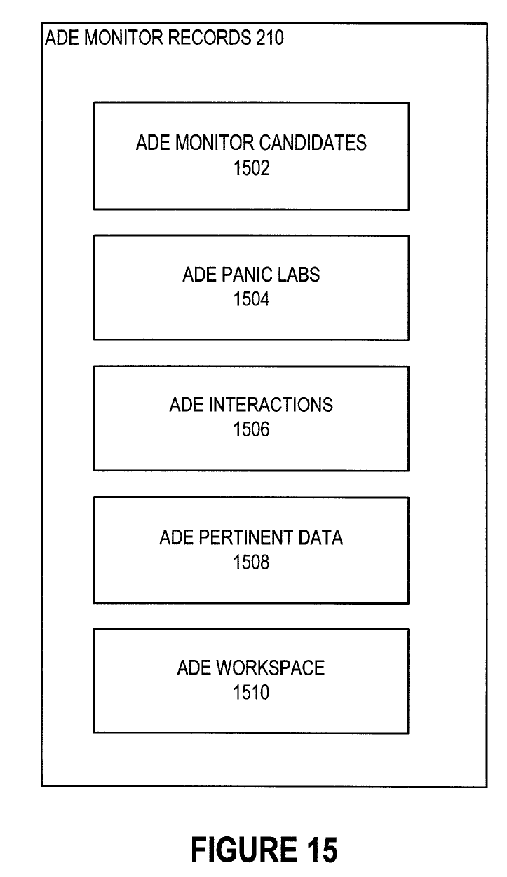

In step 504, trigger manager 112 (FIG. 1) initializes a trigger in which new and updated orders for drugs in drug orders 206 (FIG. 2) cause corresponding new records in dosage alert candidates 302 (FIG. 3) and ADE alert candidates 1502 (FIG. 15). In step 506 (FIG. 5), trigger manager 112 (FIG. 1) initializes a trigger in which new creatinine clearance measurements cause updates in patient records 202 (FIG. 2). In step 508 (FIG. 5), trigger manager 112 (FIG. 1) initializes a trigger in which new and updated records in patient records 202 cause dosage monitor 102 to analyze drug orders for those new and updated patients. In step 510 (FIG. 5), trigger manager 112 (FIG. 1) initializes a trigger in which new patient records in patient records 202 (FIG. 2) causes new creatinine clearance measurement and calculations for such new patients.

Thus, dosage monitor 102 (FIG. 1) is invoked by addition or modification of patients records 202 (FIG. 2) and/or addition or modification of drug orders 206. As described above, the invocation of dosage monitor 102 (FIG. 1) is without any direct interaction by clinicians. Specifically, no clinician is required to identify candidates for dosage monitor 102 and to invoke dosage monitor 102. Instead, clinicians go about their normal activity and dosage monitor 102 leverages from activity in drug prescription and patient records database 106, thus producing no additional workload for the clinicians.

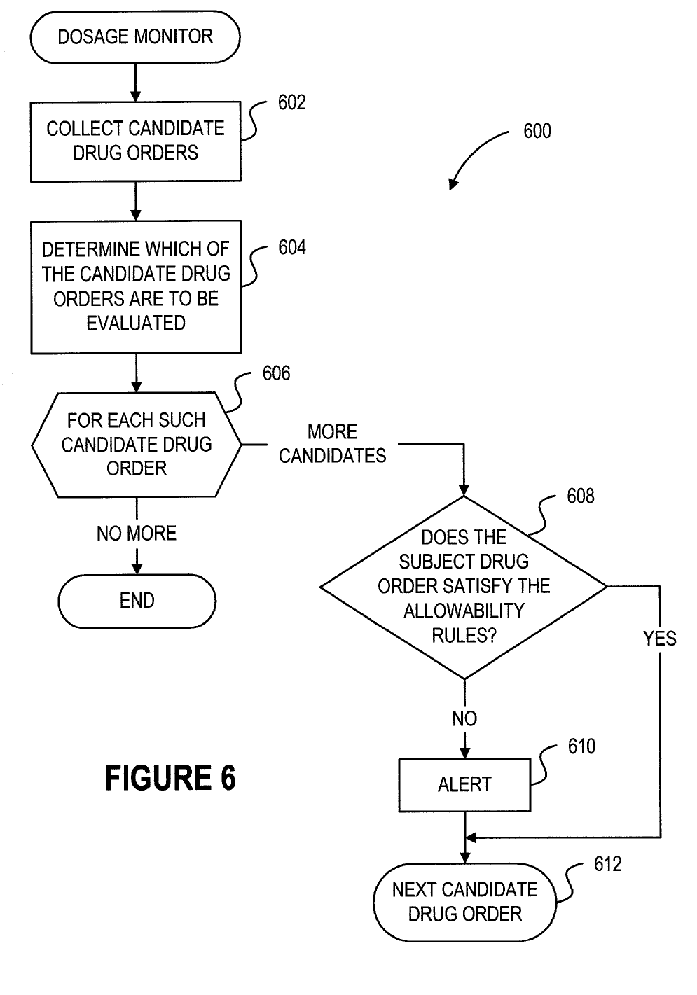

Processing by dosage monitor 102 is shown in logic flow diagram 600 (FIG. 6). In step 602, dosage monitor 102 collects candidates, e.g., dosage monitor candidates 302 (FIG. 3), for analysis. In step 604 (FIG. 6), dosage monitor 102 (FIG. 1) determines which of dosage monitor candidates 302 (FIG. 3) are to be currently evaluated. In this illustrative embodiment, dosage monitor 102 (FIG. 1) evaluates drug orders which are current, i.e., have begun and have not yet stopped, and drug orders which will begin soon. In addition, evaluation of some drug orders, e.g., drugs orders for Omeprazole and Lansoprazole, by dosage monitor 102 are postponed for a period of time, e.g., 121 hours.

Loop step 606 and next step 612 define a loop in which each of the drug orders evaluated by dosage monitor 102 is processed according to steps 608-610. During each iteration of the loop of steps 606-612, the particular drug order processed by dosage monitor 102 is sometimes referred to as the subject drug order. For each candidate drug order, processing transfers from loop step 606 to test step 608. Once all candidate drug orders have been processed according to the loop of steps 606-612, processing according to logic flow diagram 600 completes.

In test step 608, dosage monitor 102 (FIG. 1) determines whether the subject drug order satisfies allowable rules 304 (FIG. 3) in the manner described below. If the subject drug order satisfies allowable rules 304, processing transfers to next step 612 (FIG. 6) and the next drug order is processed according to the loop of steps 606-612. Conversely, if the subject drug order violates allowable rules 304 (FIG. 3), dosage monitor 102 (FIG. 1) alerts a clinician of the violation in step 610 in a manner described more completely below.

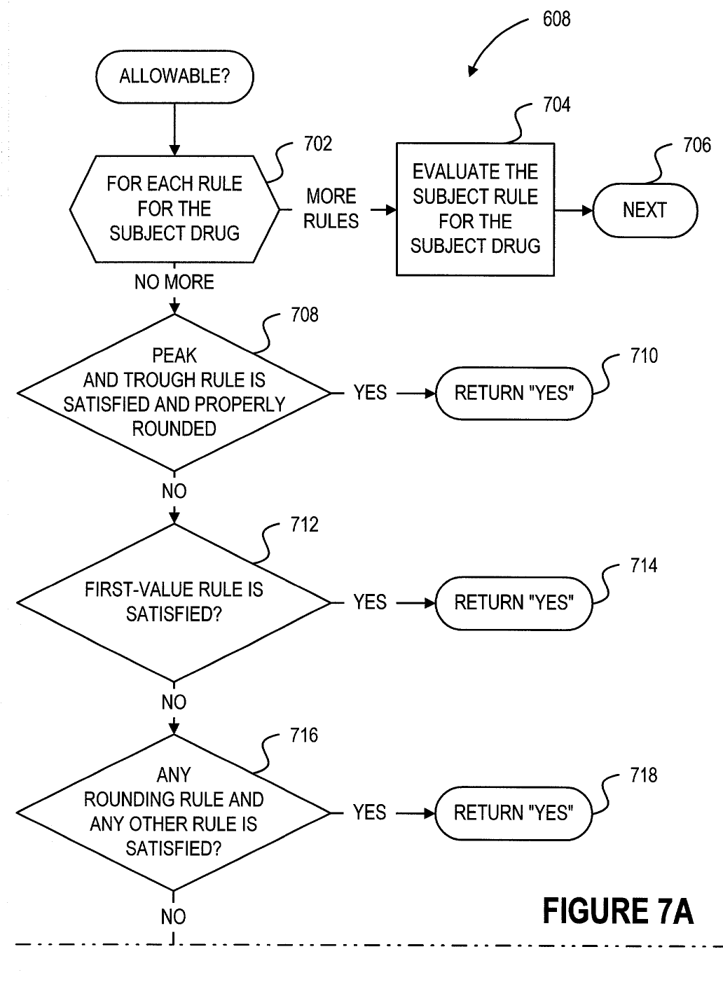

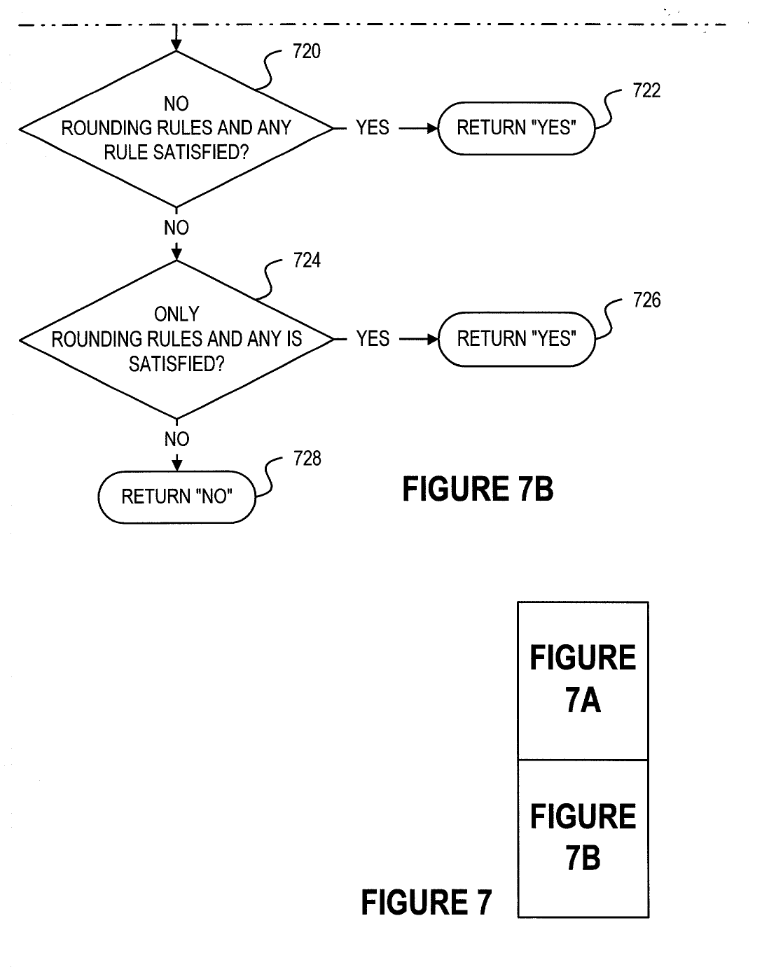

Thus, according to logic flow diagram 600, dosage monitor 102 (FIG. 1) determines whether drug orders comport with allowable rules 304 in test step 608 and report any violations in step 610. Test step 608 is shown in greater detail as logic flow diagram 608 (FIG. 7).

Loop step 702 and next step 706 define a loop in which dosage monitor 102 (FIG. 1) evaluates the subject drug order for each allowable rule corresponding to the drug of the subject drug order in step 704 (FIG. 7). A particular allowable rule applies to a particular drug order if drug identifier 402 (FIG. 4) identifies the subject drug of the drug order. During each iteration of the loop of steps 702-706, the particular allowable rule is sometimes referred to as the subject rule. When all allowable rules applicable to the subject drug order have been evaluated by dosage monitor 102, processing transfers to test step 708 which is described below.

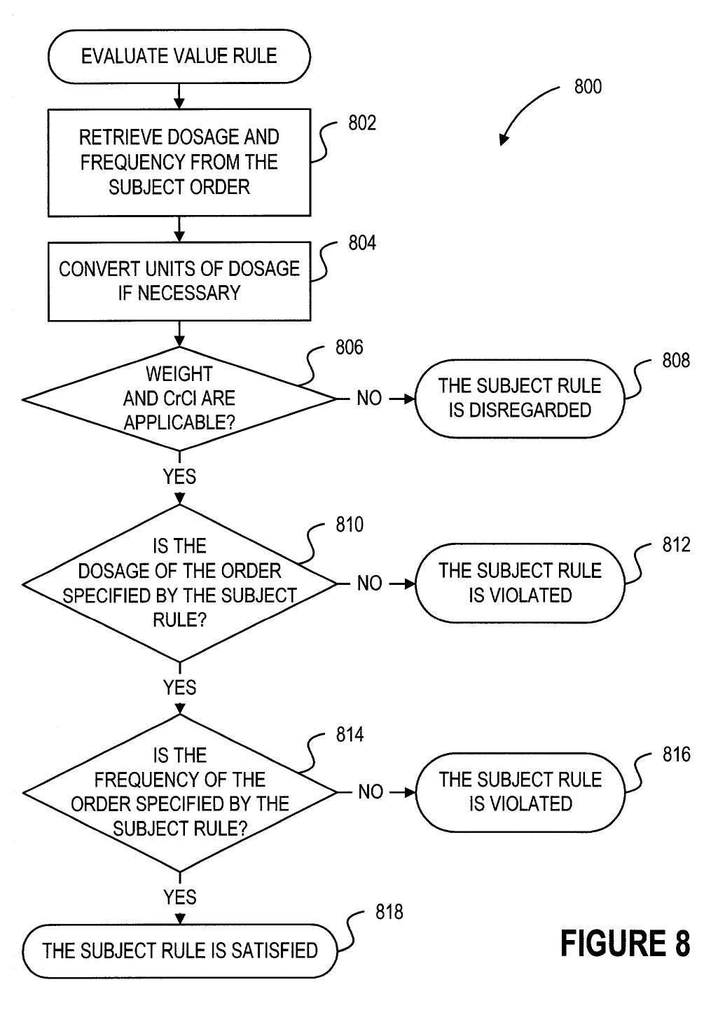

There are several types of rules in this illustrative embodiment of the present invention. As described above, a rule can be peak-and-trough, first-value, multiplied, amino, rounding, or value. A value rule is a rule which is not a peak-and-trough, first-value, multiplied, amino, or rounding rule, each of which is described more completely below. Dosage monitor 102 (FIG. 1) evaluates a drug order according to a value rule in step 704 (FIG. 7) in the manner shown in logic flow diagram 800 (FIG. 8).

In step 802, dosage monitor 102 (FIG. 1) retrieves the dosage amount and dosage frequency of the subject drug order from dosage alert candidates 302. In step 804 (FIG. 8), dosage monitor 102 converts the units of the dosage amount if necessary. For example, if the subject drug order specifies a dosage amount in ounces and the subject rule specifies allowable amounts in milligrams, the allowable amounts of the subject rule are converted to ounces and stored in workspace 308. Similarly, the dosage amount of the subject drug order can be converted to milligrams and represented in workspace 308. In either case, any difference in units in amount between the subject drug order and the subject rule are resolved in step 804.

In test step 806 (FIG. 8), dosage monitor 102 ensures that the weight and creatinine clearance of the patient is sufficiently recent and within limits of applicable weights as specified in weight limits 408 (FIG. 4) and CrCl limits 406 of the subject rule. If no recent serum creatinine result exists and the drug order has been active for more than12 hours, then a normal serum creatinine is assumed for the subject patient. If no recent serum creatinine results exists and the drug order has been active for less than 12 hours, the drug order screening is delayed for 12 hours. If no recent measured weight of the patient is available or if the weight and creatinine clearance of the subject patient are outside the limits specified in fields 406-408 of the subject rule, the subject rule is disregarded in step 808 and processed according to logic flow diagram 800, and therefore step 704 (FIG. 7), completes. Otherwise, if the weight and creatinine clearance of the subject patient are within the limits specified in fields 406-408 of the subject rule, processing continues with test step 810.

In test step 810 (FIG. 8), dosage monitor 102 (FIG. 1) determines whether the dosage amount of the subject drug order is specified by the subject rule as allowable. Dose limits 410 (FIG. 4) of the subject rule can specify either a range of amounts or one or more specific discrete amounts which are allowable dosages for the drug of the subject drug order. Dosage monitor 102 (FIG. 1) determines whether the dosage amount of the subject drug order is included within the range or included in the one or more discrete amounts specified by the subject rule.

If the dosage amount of the subject rule is not specified as allowable by the subject rule, processing transfers to step 812 (FIG. 8) in which dosage monitor 102 determines that the subject drug order violates the subject rule and processing according to logic flow diagram 800, and thus, step 704 (FIG. 7), completes. Conversely, if the dosage amount of the subject rule is specified as allowable by the subject rule, processing transfers to test step 814 (FIG. 8).

In test step 814, dosage monitor 102 (FIG. 1) determines whether the dosage frequency of the subject drug order is specified by the subject rule as allowable. Frequency limits 412 (FIG. 4) of the subject rule can specify either a range of frequencies or one or more specific discrete frequencies which are allowable dosage frequencies for the drug of the subject drug order. Dosage monitor 102 (FIG. 1) determines whether the dosage frequency of the subject drug order is included within the range or included in the one or more discrete frequencies specified by the subject rule.

If the dosage frequency of the subject rule is not specified as allowable by the subject rule, processing transfers to step 816 (FIG. 8) in which dosage monitor 102 determines that the subject drug order violates the subject rule and processing according to logic flow diagram 800, and thus, step 704 (FIG. 7), completes. Conversely, if the dosage amount of the subject rule is specified as allowable by the subject rule, processing transfers to step 818 (FIG. 8) in which dosage monitor 102 (FIG. 1) determines that the subject drug order satisfies the subject rule and processing according to logic flow diagram 800, and thus, step 704 (FIG. 7), completes.

Thus, according to logic flow diagram 800, dosage monitor 102 compares the dosage amount and dosage frequency of the subject drug order to absolute limits in evaluating a value rule.

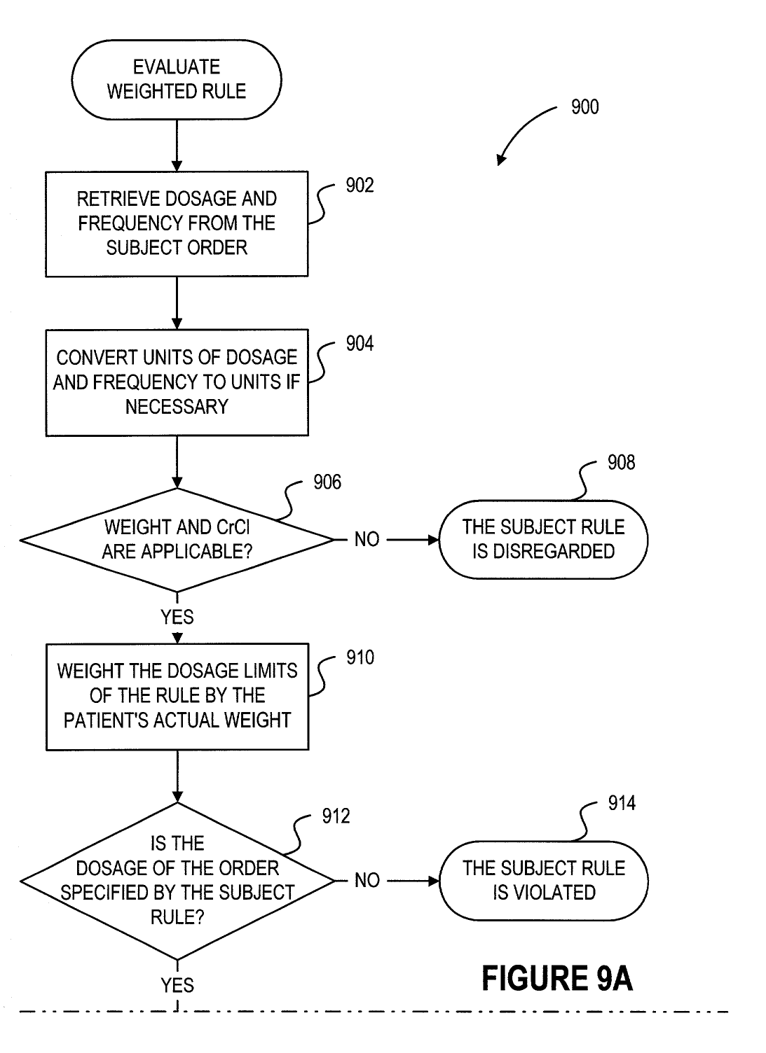

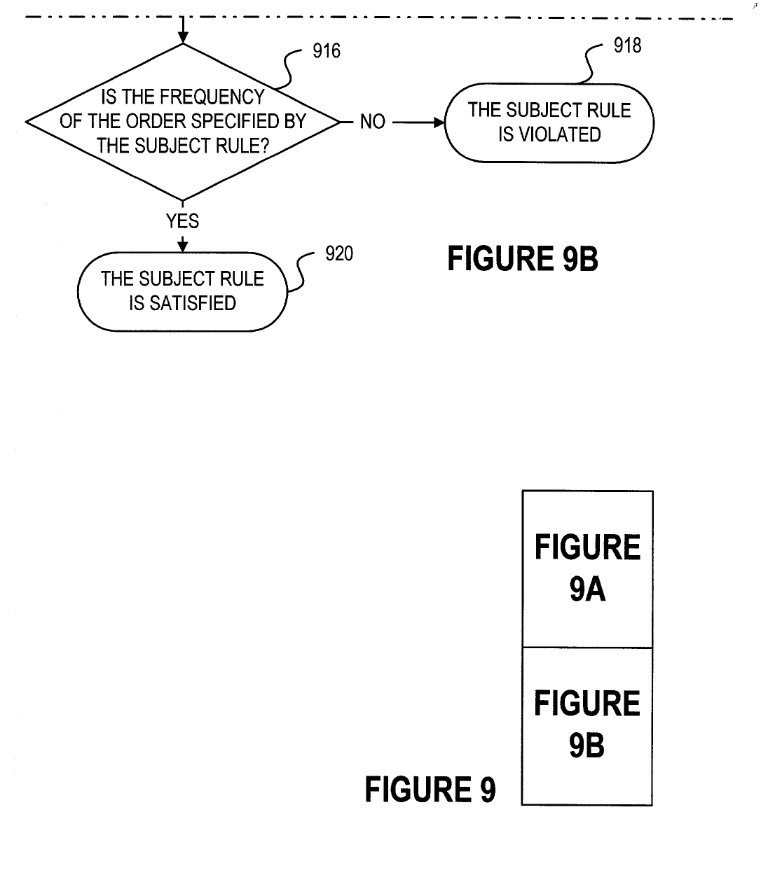

Dosage monitor 102 (FIG. 1) evaluates a drug order according to a multiplied rule in step 704 in the manner shown in logic flow diagram 900 (FIG. 9). In step 902, dosage monitor 102 (FIG. 1) retrieves the dosage amount and dosage frequency of the subject drug order from dosage alert candidates 302. In step 904 (FIG. 9), dosage monitor 102 converts the units of the dosage amount if necessary in the manner described above with respect to step 804.

In steps 906-908, dosage monitor 102 ensures that the weight and creatinine clearance of the patient is sufficiently recent and within limits of applicable weights as specified in weight limits 408 (FIG. 4) and CrCl limits 406 of the subject rule in the manner described above with respect to steps 806-808 (FIG. 8).

In step 910 (FIG. 9), dosage monitor 102 (FIG. 1) weights the allowable dosage amounts as represented in dosage limits 410 (FIG. 4) of the subject rule by the actual measured weight of the patient of the subject drug order. The resulting weighted dosage amount limits are stored in workspace 308 (FIG. 3) in this illustrative embodiment.

In test step 912 (FIG. 9), dosage monitor 102 (FIG. 1) determines whether the dosage amount of the subject drug order is specified by the subject rule as allowable. Dosage monitor 102 (FIG. 1) determines whether the dosage amount of the subject drug order is included within the range or included in the one or more discrete amounts specified by the weighted allowable dosage amounts determined in step 910.

If the dosage amount of the subject rule is not specified as allowable by the subject rule, processing transfers to step 914 (FIG. 9) in which dosage monitor 102 determines that the subject drug order violates the subject rule and processing according to logic flow diagram 900, and thus, step 704 (FIG. 7), completes. Conversely, if the dosage amount of the subject rule is specified as allowable by the subject rule, processing transfers to test step 916 (FIG. 9).

In test step 916, dosage monitor 102 (FIG. 1) determines whether the dosage frequency of the subject drug order is specified by the subject rule as allowable in the manner described above with respect to test step 814 (FIG. 8).

If the dosage frequency of the subject rule is not specified as allowable by the subject rule, processing transfers to step 918 (FIG. 9) in which dosage monitor 102 determines that the subject drug order violates the subject rule and processing according to logic flow diagram 900, and thus, step 704 (FIG. 7), completes. Conversely, if the dosage amount of the subject rule is specified as allowable by the subject rule, processing transfers to step 920 (FIG. 9) in which dosage monitor 102 (FIG. 1) determines that the subject drug order satisfies the subject rule and processing according to logic flow diagram 900, and thus, step 704 (FIG. 7), completes.

Thus, according to logic flow diagram 900, dosage monitor 102 compares the dosage amount and dosage frequency of the subject drug order to limits weighted by the patient's actual weight in evaluating a multiplied rule.

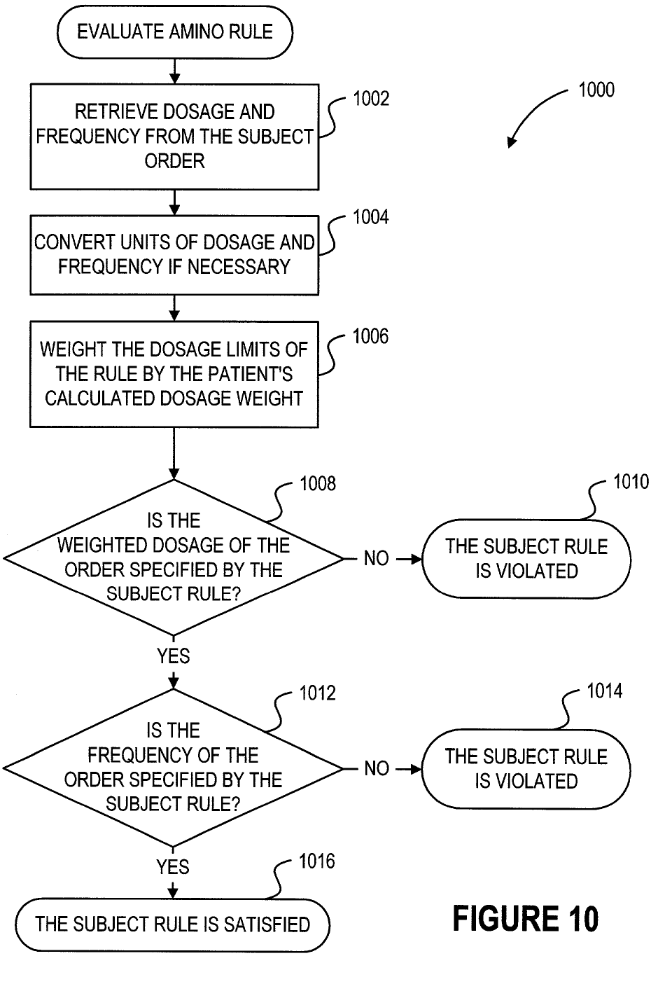

Dosage monitor 102 (FIG. 1) evaluates a drug order according to an amino rule in step 704 in the manner shown in logic flow diagram 1000 (FIG. 10). In step 1002, dosage monitor 102 (FIG. 1) retrieves the dosage amount and dosage frequency of the subject drug order from dosage alert candidates 302. In step 1004 (FIG. 10), dosage monitor 102 converts the units of the dosage amount and frequency if necessary in the manner described above with respect to step 804.

In step 1006 (FIG. 10), dosage monitor 102 (FIG. 1) weights the allowable dosage amounts as represented in dosage limits 410 (FIG. 4) of the subject rule by the calculated dosage weight of the patient of the subject drug order. Dosage monitor 102 (FIG. 1) calculates dosage weight of the patient from the patient's actual measured weight as represented in patient's records 202 and from the patient's serum creatinine as represented in laboratory results 204 according to a well-known equation. In this illustrative embodiment, dosage monitor 102 (FIG. 1) uses any of the following Cockroft-Gault equations to estimate creatinine clearance and to calculate an appropriate dosage weight:

$$MaleCrCl = \frac{( 140 - age ) [ 2.3 ( HeightInInches - 60 ) + 50 ]}{Scr \times 72}$$

$$FemaleCrCl = \frac{( 140 - age ) [ 2.3 ( HeightInInches - 60 ) + 45.5 ] ( 0.85 )}{Scr \times 72}$$

If the subject patient's height is not available or is not between 54 and 87 inches, dosage monitor 102 uses a normalized Cockroft-Gault equation to estimate creatinine clearance:

MaleCrCl=140−age

FemaleCrCl=(140−age)×0.85

The resulting weighted dosage amount limits are stored in workspace 308 (FIG. 3) in this illustrative embodiment. Dosage monitor 102 ensures that the measured actual weight of the patient is sufficiently recent before weighting the allowable dosage amounts in step 1006 (FIG. 10). Similarly, dosage monitor 102 ensures that the creatinine clearance levels calculated from measured serum creatinine of the patient are sufficiently recent before weighting the allowable dosage amounts in step 1006 (FIG. 10). If no recent serum creatinine result exists and the drug order has been active for more than 12 hours, then a normal serum creatinine is assumed. If no recent serum creatinine results exists and the drug order has been active for less than 12 hours, the drug order screening is delayed for 12 hours. If no recent measured weight of the patient is available, the subject rule is disregarded and processed according to logic flow diagram 1000, and step 704 (FIG. 7), completes.

In test step 1008 (FIG. 10), dosage monitor 102 (FIG. 1) determines whether the dosage amount of the subject drug order is specified by the subject rule as allowable. Dosage monitor 102 (FIG. 1) determines whether the dosage amount of the subject drug order is included within the range or included in the one or more discrete amounts specified by the weighted allowable dosage amounts determined in step 1006.

If the dosage amount of the subject rule is not specified as allowable by the subject rule, processing transfers to step 1010 (FIG. 10) in which dosage monitor 102 determines that the subject drug order violates the subject rule and processing according to logic flow diagram 1000, and thus, step 704 (FIG. 7), completes. Conversely, if the dosage amount of the subject rule is specified as allowable by the subject rule, processing transfers to test step 1012 (FIG. 10).

In test step 1012, dosage monitor 102 (FIG. 1) determines whether the dosage frequency of the subject drug order is specified by the subject rule as allowable in the manner described above with respect to test step 810 (FIG. 8).

If the dosage frequency of the subject rule is not specified as allowable by the subject rule, processing transfers to step 1014 (FIG. 10) in which dosage monitor 102 determines that the subject drug order violates the subject rule and processing according to logic flow diagram 1000, and thus, step 704 (FIG. 7), completes. Conversely, if the dosage amount of the subject rule is specified as allowable by the subject rule, processing transfers to step 1016 (FIG. 10) in which dosage monitor 102 (FIG. 1) determines that the subject drug order satisfies the subject rule and processing according to logic flow diagram 1000, and thus, step 704 (FIG. 7), completes.

Thus, according to logic flow diagram 1000, dosage monitor 102 compares the dosage amount and dosage frequency of the subject drug order to limits weighted by the patient's calculated dosage weight in evaluating an amino rule.

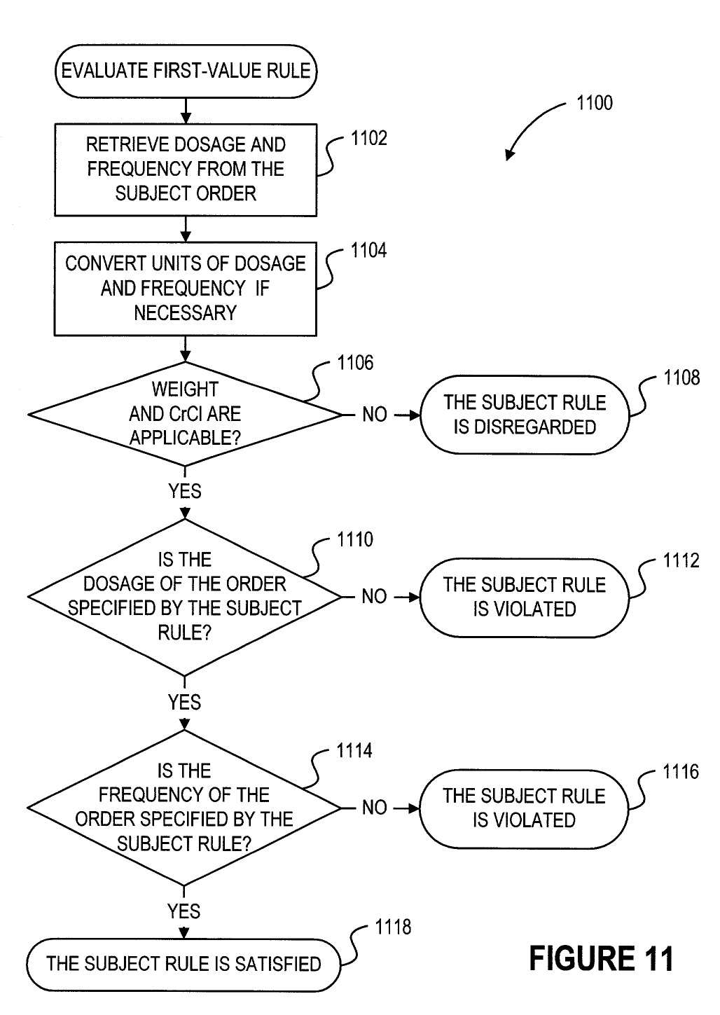

Dosage monitor 102 (FIG. 1) evaluates a drug order according to a first-value rule in step 704 in the manner shown in logic flow diagram 1100 (FIG. 11). Briefly, a first-value rule is an exception rule in which other rounding rules are inapplicable of the first-value rule is satisfied. The utility of first-value rules is described more completely below in conjunction with test step 712 (FIG. 7).

In step 1102, dosage monitor 102 (FIG. 1) retrieves the dosage amount and dosage frequency of the subject drug order from dosage alert candidates 302. In step 1104 (FIG. 11), dosage monitor 102 converts the units of the dosage amount and frequency if necessary in the manner described above with respect to step 804.

In steps 1106-1108, dosage monitor 102 ensures that the weight and creatinine clearance of the patient is sufficiently recent and within limits of applicable weights as specified in weight limits 408 (FIG. 4) and CrCl limits 406 of the subject rule in the manner described above with respect to steps 806-808 (FIG. 8).

In test step 1110 (FIG. 11), dosage monitor 102 (FIG. 1) determines whether the dosage amount of the subject drug order is specified by the subject rule as allowable in the manner described above with respect to test step 810 (FIG. 8).

If the dosage amount of the subject rule is not specified as allowable by the subject rule, processing transfers to step 1112 (FIG. 11) in which dosage monitor 102 determines that the subject drug order violates the subject rule and processing according to logic flow diagram 1100, and thus, step 704 (FIG. 7), completes. Conversely, if the dosage amount of the subject rule is specified as allowable by the subject rule, processing transfers to test step 1114 (FIG. 11).

In test step 1114, dosage monitor 102 (FIG. 1) determines whether the dosage frequency of the subject drug order is specified by the subject rule as allowable in the manner described above with respect to test step 814 (FIG. 8).

If the dosage frequency of the subject rule is not specified as allowable by the subject rule, processing transfers to step 1116 (FIG. 11) in which dosage monitor 102 determines that the subject drug order violates the subject rule and processing according to logic flow diagram 1100, and thus, step 704 (FIG. 7), completes. Conversely, if the dosage amount of the subject rule is specified as allowable by the subject rule, processing transfers to step 1118 (FIG. 11) in which dosage monitor 102 (FIG. 1) determines that the subject drug order satisfies the subject rule and processing according to logic flow diagram 1100, and thus, step 704 (FIG. 7), completes.

Thus, according to logic flow diagram 1100, dosage monitor 102 compares the dosage amount and dosage frequency of the subject drug order to absolute limits in evaluating a first-value rule.

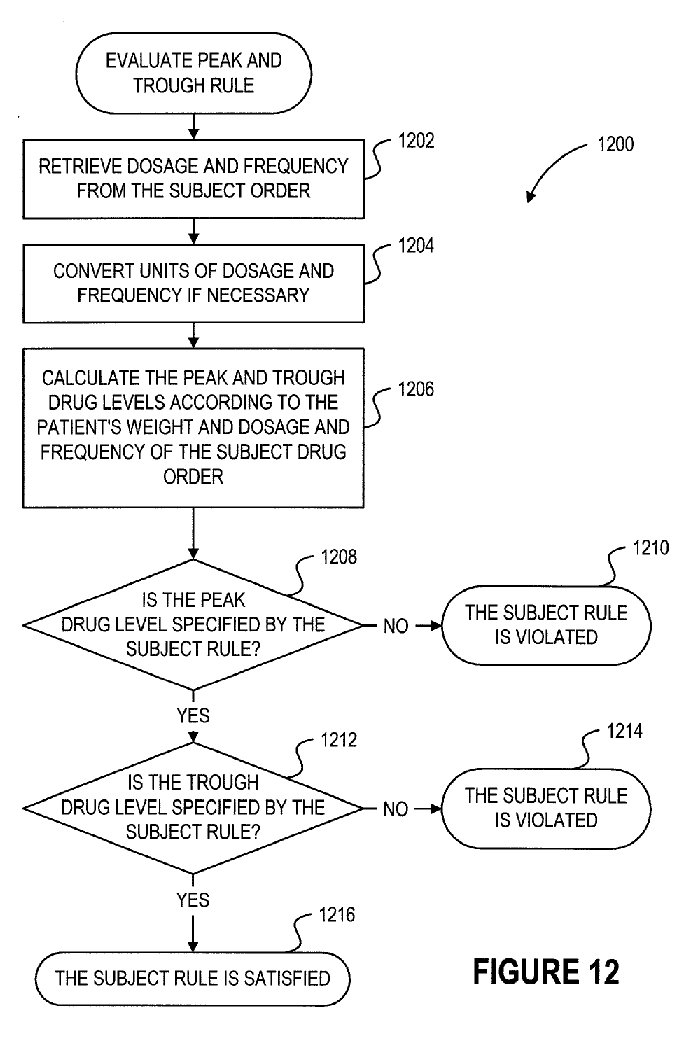

Dosage monitor 102 (FIG. 1) evaluates a drug order according to a peak-and-trough rule in step 704 in the manner shown in logic flow diagram 1200 (FIG. 12). Briefly, a peak-and-5 trough rule specifies limits in drug levels in the patient's blood.

In step 1202, dosage monitor 102 (FIG. 1) retrieves the dosage amount and dosage frequency of the subject drug order from dosage alert candidates 302. In step 1204 (FIG. 12), dosage monitor 102 converts the units of the dosage amount if necessary in the manner described above with respect to step 804.

In step 1206 (FIG. 12), dosage monitor 102 (FIG. 1) predicts peak and trough drug levels for the patient using the dosage amount and frequency and the patient's age and dosage weight. In one embodiment, dosage monitor 102 uses the following equations for predicting peak and trough blood levels of the subject drug:

$$Pr edictedPeak = \frac{[ D ( 1 - {ⅇ}^{- Kt} ) ]}{[ ( k \times Vd ) ( 1 - {ⅇ}^{- KT} ) ]}$$

In the above equation, (i) D is the dose (e.g., of gentamicin) expressed in mg/hour; (ii) K=(0.0024CrCl)+0.01;(iii)Vd=0.29 times the ideal body weight of the patient (or the obese dose weight of the patient when appropriate); (iv) T is the dosing interval; and (v) t is the infusion period expressed in hours.

Pr edictedtrough=Pr edicitedPeak×e^{-K(T-t)}

In the above equation, K, T, and t have the same meaning as in the previous equation. Obese dosing weight is calculated according to the following equation:

ObeseDoseWeight=IBW+0.4(ActualBodyWeight−IBW)

In the above equation, IBW is the patient's ideal body weight.

In test step 1208 (FIG. 12), dosage monitor 102 (FIG. 1) determines whether the predicted peak blood level of the subject drug order is specified by the subject rule as allowable. If rule 400 (FIG. 4) represents a peak-and-trough rule, dose limits 410 specify a maximum peak level and a minimum trough level. In test step 1208 (FIG. 12), dosage monitor compares the predicted peak level with the maximum allowable peak level.

If the predicted peak blood level exceeds the maximum peak level specified as allowable by the subject rule, processing transfers to step 1210 (FIG. 12) in which dosage monitor 102 determines that the subject drug order violates the subject rule and processing according to logic flow diagram 1200, and thus, step 704 (FIG. 7), completes. Conversely, if the predicted peak blood level does not exceed the maximum peak level specified as allowable by the subject rule, processing transfers to test step 1212 (FIG. 12).

In test step 1212, dosage monitor 102 (FIG. 1) determines whether the predicted trough blood level of the subject drug order is specified by the subject rule as allowable. In particular, dosage monitor 102 compares the predicted trough to the minimum allowable trough blood level specified in dose limits 410 in the manner described above.

If the predicted trough blood level is below the minimum trough level specified as allowable by the subject rule, processing transfers to step 1214 (FIG. 12) in which dosage monitor 102 determines that the subject drug order violates the subject rule and processing according to logic flow diagram 1200, and thus, step 704 (FIG. 7), completes. Conversely, if the predicted trough blood level is not below the minimum trough level specified as allowable by the subject rule, processing transfers to step 1216 (FIG. 12) in which dosage monitor 102 (FIG. 1) determines that the subject drug order satisfies the subject rule and processing according to logic flow diagram 1200, and thus, step 704 (FIG. 7), completes.

Thus, according to logic flow diagram 1200, dosage monitor 102 compares the predicted peak and trough blood levels of the subject drug order to peak and trough limits in evaluating a peak-and-trough rule.

In evaluating a rounding rule in step 704 (FIG. 7), dosage monitor 102 (FIG. 1) ensures that the dosage amount of the subject drug order is an integer multiple of round value 414 (FIG. 4) of the subject rule. If the dosage amount is an integer multiple of the round value, dosage monitor 102 determines that the subject rounding rule is satisfied. Conversely, if the dosage amount of the subject drug order is not an integer multiple of the round value, dosage monitor 102 determines that the subject drug order violates the subject rounding rule.

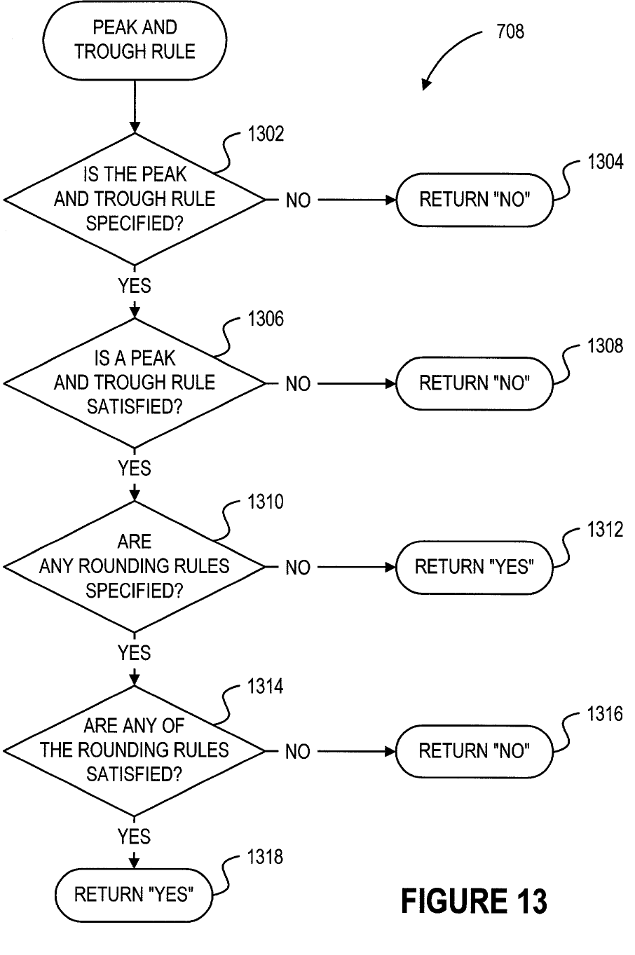

Once all rules for the subject drug order have been evaluated in the loop of steps 702-706 (FIG. 7), dosage monitor 102 (FIG. 1) determines whether the various evaluated rules warrant an alert according to steps 708-728. In test step 708, dosage monitor 102 determines whether any peak-and-trough rule is satisfied by the subject drug order. Briefly, dosage monitor determines that a peak-and-trough rule is satisfied if a peak-and-trough rule exists for the drug of the subject drug order and the drug order satisfies the peak-and-trough rule and at least one rounding rule is satisfied if any are specified for the subject drug order. Test step 708 is shown in greater detail as logic flow diagram 708 (FIG. 13).

In test step 1302, dosage monitor 102 determines whether a peak-and-trough rule is specified for the subject drug order. If not, dosage monitor 102 determines that no peak-and-trough rule is satisfied in step 1304 and processing according to test step 708 (FIG. 7) completes. Conversely, if a peak-and-trough rule is specified for the subject drug order, processing transfers to test step 1306.

In test step 1306, dosage monitor 102 determines whether at least one peak-and-trough rule for the subject drug order is satisfied. In not, dosage monitor 102 determines that no peak and trough rule is satisfied and processing terminates in step 1308. Conversely, if at least one peak-and-trough rule is satisfied by the subject drug order, processing transfers to test step 1310. Since only one of the peak-and-trough rules specified for the subject drug order must be satisfied, multiple peak-and-trough rules have a logical OR relationship with respect to one another.

In test step 13 10, dosage monitor 102 determines whether any rounding rules are specified for the subject drug order. If not, then at least one peak-and-trough rule is specified and satisfied and no rounding rules are specified. Accordingly, dosage monitor 102 determines that peak-and-trough analysis indicates that the subject drug order is allowable and processing according to logic flow diagram 708 terminates in step 1312. If dosage monitor 102 determines that at least one rounding rule is specified for the subject drug order, processing transfers to test step 1314.

In test step 1314, dosage monitor 102 determines whether any of the rounding rules specified for the subject rule are satisfied. If any of the rounding rules is satisfied, dosage monitor 102 determines, in test step 1314 to terminal step 1318, that at least one peak-and-trough rule and at least one rounding rule of the subject drug order is satisfied and the drug order is allowable. Since only one rounding rule must be satisfied, rounding rules have a logical OR relationship to one another. If no rounding rule is satisfied by the subject rule, dosage monitor 102 determines, in step 1316, that the subject rule is not allowable, specifically not properly rounded, in test step 708 (FIG. 7).

Thus, in test step 708, dosage monitor 102 determines whether any peak-and-trough rule is satisfied by the subject order and whether the subject order is properly rounded. If so, dosage monitor 102 determines that the subject order is allowable and logic flow diagram 608, and therefore step 608 (FIG. 6), completes. Satisfaction of a peak-and-trough rule with proper rounding therefore terminates consideration of any other rules and the subject drug order is allowable. Conversely, if no peak-and-trough rule is specified for the subject drug order or if no peak-and-trough rule is satisfied by the drug order or if the drug order is not properly rounded, processing by dosage monitor 102 transfers to test step 712 (FIG. 7).

In test step 712, dosage monitor 102 determines whether the subject rule satisfies a first-value rule. If at least one first-value rule is specified for the subject drug order and at least one of those first-value rules is satisfied by the subject drug order, dosage monitor 102 determines that the subject order is allowable in step 714 and processing according to logic flow diagram 608, and therefore step 608 (FIG. 6), terminates. It should be noted that, when evaluating first-value rules, violation of all rounding rules specified for the subject drug order is immaterial. In essence, first-value rules are exceptions to rounding rules. If dosage monitor 102 determines that there are no first-value rules specified or that no specified first-value rules are satisfied by the subject drug order, further analysis of allowable rules for the subject drug order is needed and processing transfers to test step 716.

In test step 716, dosage monitor 102 determines whether at least one rounding rule and at least one other, non-rounding rule is satisfied by the subject drug order. If at least one rounding rule is specified for and satisfied by the subject rule and at least one non-rounding rule is specified for and satisfied by the subject rule, the subject drug order is allowable and no further analysis is needed. Accordingly, under such circumstances, dosage monitor 102 terminates processing in step 718 and determines that the subject rule is allowable. Otherwise, analysis of the subject drug order by dosage monitor 102 continues in test step 720.

In test step 720, dosage monitor 102 determines whether no rounding rules are specified for the subject drug order and at least one non-rounding rule is specified for and satisfied by the subject drug order. If no rounding rules are specified for the subject drug order and at least one By. non-rounding rule is specified for and satisfied by the subject drug order, dosage monitor 102 determines that the subject drug order is allowable and no further analysis of the subject drug order is necessary. Accordingly, dosage monitor 102 terminates processing in step 722 and processing according to logic flow diagram 608, and therefore step 608, completes upon such circumstances. Conversely, if at least one rounding rule is specified and none are satisfied by the subject drug order or if no non-rounding rule is specified for and satisfied by the subject drug order, processing transfers to test step 724 and analysis by drug monitor 102 of the subject drug order continues.

In test step 724, dosage monitor 102 determines whether only rounding rules are specified for the subject drug order and whether any of those are satisfied by the subject drug order. If only rounding rules are specified for the subject drug order and any of those rounding rules are satisfied by the subject drug order, dosage monitor 102 determines that the subject drug order is allowable and terminates processing of logic flow diagram 608, and therefore step 608, in step 726. Conversely, if any non-rounding rules are specified for the subject drug order or if no rounding rules are satisfied by the subject drug order, dosage monitor 102 determines in step 728 that the subject drug order is not allowable and processing according to logic flow diagram 608, and therefore step 608, terminates.

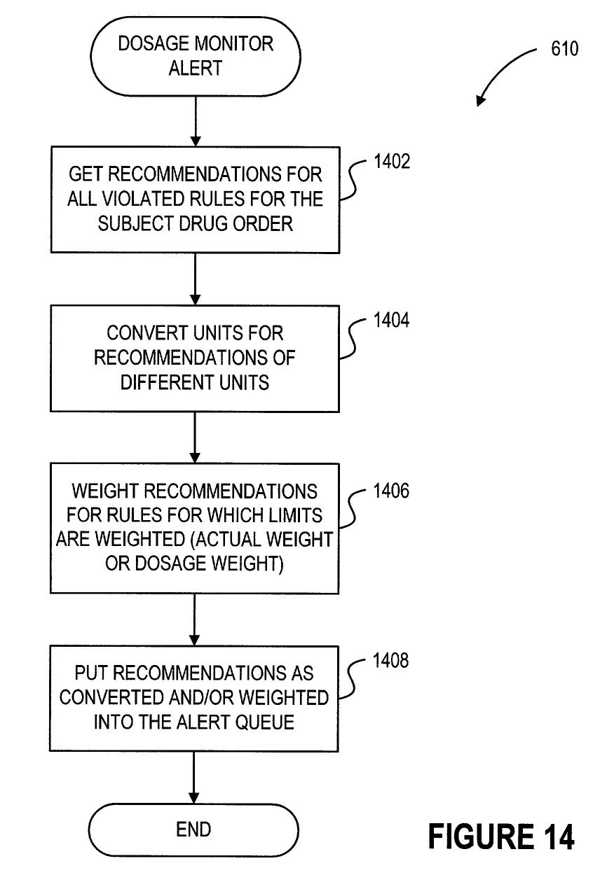

As described above, dosage monitor 102 alerts a clinician in step 610 of any drug order which is determined not to be allowable according to allowable rules 304 (FIG. 3). Step 610 is shown in greater detail as logic flow diagram 610 (FIG. 14).

In step 1402, dosage monitor 102 retrieves a recommendation for the subject drug order from recommendations 306. As described above, recommendations 306 express proper dosage amounts, dosage frequencies, and rounding values for specific drugs, typically in ranges narrower than the ranges which trigger alerts as expressed in allowable rules 304.

In step 1404, dosage monitor 102 converts the units of the retrieved recommendation to the units of the subject drug order if the units are different. Thus, when the alert is received by the clinician, the recommended dosage amount and frequency is easily compared to the originally ordered dosage amount and frequency.

In step 1406, dosage monitor 102 weights recommended dosage amounts (i) by the measured actual weight of the patient of the subject drug order if the subject drug order type is “multiplied” or (ii) by the calculated dosage weight of the patient of the subject drug order if the subject drug order type is “amino.” Accordingly, the recommendation is specific to the patient's condition as represented in patient3 s records 202 and laboratory results 204.

In step 1408, dosage monitor 102 constructs an alert record from the unit-converted and properly weight dosage amount and frequency recommendations and places the alert record on an alert queue which is described more completely below. Alert manager 114 subsequently alerts a clinician to the improper dosing of the patient of the subject drug order and provides the clinician with the recommended dosing information.

Thus, in accordance with the present invention, dosage monitor 102 monitors drug orders and patient information and notifies a clinician if any improper dosing is detected. As described above, dosage monitor 102 responds to triggers which are activated when any new drug order is stored. Accordingly, drug orders for all patients are concurrently analyzed by drug monitor 102 in the manner described above.

ADE Monitor

As described above, ADE monitor 104 (FIG. 1) monitors drug orders 206 to detect possible drug-drug interactions and drug duration violations. ADE monitor 104 also analyzes laboratory results 204 to detect laboratory results whose values are outside predetermined allowable ranges. Such allowable ranges are sometimes referred to herein as panic labs. ADE monitor records 210 are shown in greater detail in FIG. 3.

ADE monitor records 210 include ADE monitor candidates 1502, ADE panic labs 1504, ADE interactions 1506, ADE pertinent data 1508, and ADE workspace 1510. ADE monitor candidates 1502 stores records representing newly prescribed drug orders and/or newly received laboratory results as candidates for ADE analysis by ADE monitor 104.

ADE panic labs 1504 store redetermined acceptable ranges of laboratory result values. Laboratory result values which lie outside such acceptable ranges can indicate an adverse drug effect and are alerted by ADE monitor 104.

ADE interactions 1506 stores records representing interaction relationships between drugs. Interaction can occur when two incompatible drugs are simultaneously prescribed and when one drug order follows too soon after a second, incompatible drug order. These latter sequential interactions can be either order-dependent or order-independent.

ADE interactions 1506 also stores records representing maximum duration of drug orders. For example, Ketorolac can only be given for a maximum of five (5) days. Such a limitation is specified in ADE interactions 1506.

ADE pertinent data 1508 stores records representing additional data needed by a clinician to help in the assessment of the patient's status or potential harm. For example, an ADE interaction may be more severe if the patient is on a third drug that can accelerate the adverse symptoms of the drug-drug interaction. ADE pertinent data 1508 includes drug orders, laboratory results, and information pertaining to the type of alert.

ADE workspace 1510 is used by ADE monitor 104 as workspace for analyzing new drug orders for ADE issues.

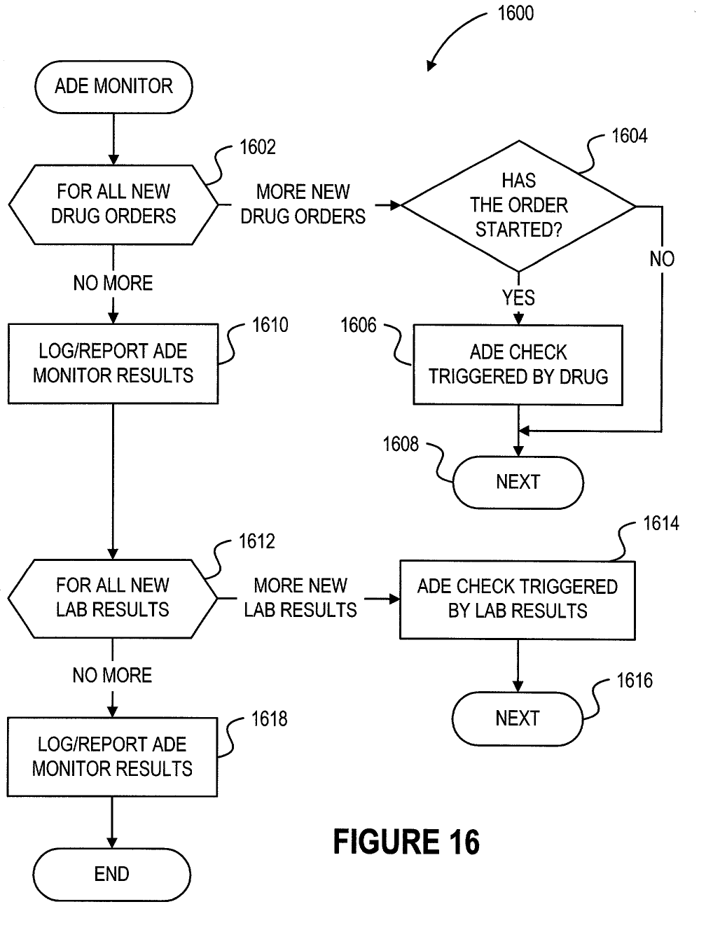

ADE analysis as performed by ADE monitor 104 is illustrated by logic flow diagram 1600 (FIG. 16). Loop step 1602 and next step 1608 define a loop in which each new drug order represented in ADE monitor candidates 1502 is processed according to steps 1604-1606. During each iteration of the loop of steps 1602-1608, the particular drug order processed according to steps 1604-1606 is sometimes referred to as the subject drug order.

In test step 1604, ADE monitor 104 determines whether the subject drug order has started or will start within a predetermined amount of time by reference to the start date and time as represented in the subject drug order. If the subject drug order has started, processing transfers to step 1606 in which ADE monitor 104 analyzes the subject drug order for ADE risk in a manner described more completely below. If the subject drug has not yet started, ADE monitor skips step 1606 and the subject drug order is not processed until a subsequent performance of the steps of logic flow diagram 1600 once the subject drug order has indeed started.

Once all new drug orders have been processed according to the loop of steps 1602-1608, ADE monitor 104 logs and reports ADE monitor results in step 1610.

Loop step 1612 and next step 1616 define a loop in which each new laboratory result represented in ADE monitor candidates 1502 is processed according to step 1614. During each iteration of the loop of steps 1612-1616, the particular laboratory result processed according to step 1614 is sometimes referred to as the subject laboratory result.

In step 1614, ADE monitor 104 analyzes the subject laboratory result for ADE indication in a manner described more completely below.

Once all new laboratory results have been processed according to the loop of steps 1612-1616, ADE monitor 104 logs and reports ADE monitor results in step 1618.

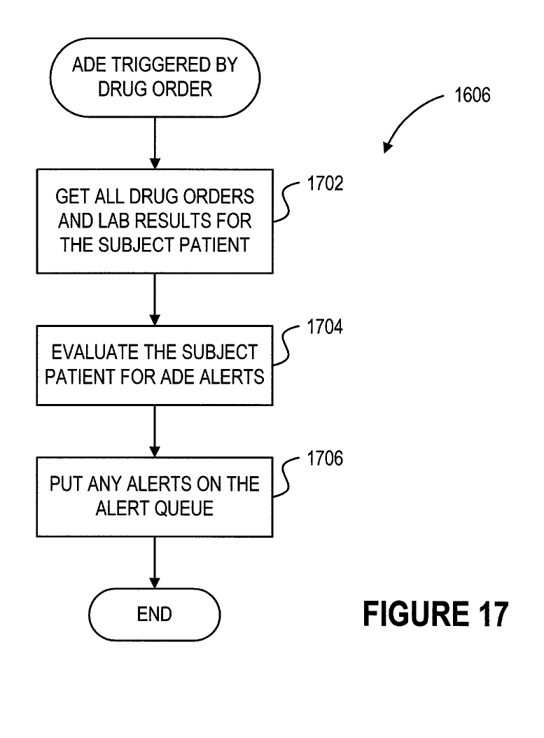

ADE analysis by ADE monitor 104 in step 1606 when triggered by a new drug order is shown in greater detail as logic flow diagram 1606 (FIG. 17). In step 1702, ADE monitor 104 determines to which patient the subject drug order pertains (sometimes referred to as the subject patient) and retrieves all drug orders and laboratory results of the subject patient.

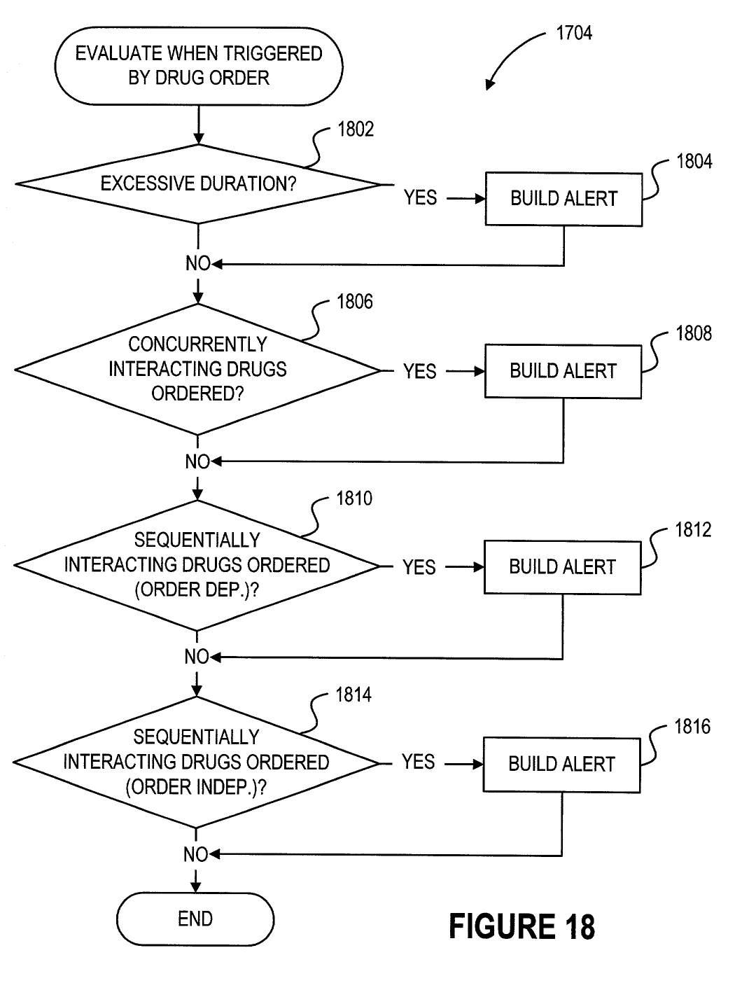

In step 1704, ADE monitor 104 evaluates the subject patient's drug order and laboratory results for ADE risks. Step 1704 is shown in greater detail as logic flow diagram 1704 (FIG. 18).

In test step 1802, ADE monitor 104 determines whether a drug order for the subject patient exceeds the allowable duration as represented in ADE interactions 1506. If so, processing transfers to step 1804 in which ADE monitor 104 builds an alert message including identification and location of the subject patient, the drug order whose excessive duration triggers the ADE alert, and the nature of the potential ADE as represented in ADE pertinent data 1508 (FIG. 15).

Whether from step 1804 (FIG. 18) or from test step 1802 when no order for an indicator drug is found for the subject patient, processing transfers to test step 1806. In test step 1806, ADE monitor 104 determines whether the subject patient has concurrent drug orders for drugs that interact with one another when concurrently administered. If a drug currently administered to the patient interacts adversely with another drug currently administered to the subject patient according to ADE interactions 1506 (FIG. 15), ADE monitor 104 builds an alert message including identification and location of the subject patient, the concurrently interacting drugs triggering the ADE alert, and the nature of the potential ADE as represented in ADE recommendations 1508 (FIG. 15) in step 1808 (FIG. 18). If no currently administered drug of the subject patient interacts with any other currently administered drug of the subject patient, step 1808 is skipped.

In test step 1810, ADE monitor 104 determines whether a currently administered drug of the subject patient interacts with a recently administered drug of the subject patient and the time lapsed between the former drug and the current drug is less than a predetermined threshold time. The interacting drugs and the predetermined threshold lapse between drugs are specified in ADE interactions 1506. In test step 1810, the order of the drugs is significant as specified in ADE interactions 1506. If a currently administered drug of the subject patient follows administration of a recently administered, interacting drug of the subject patient within the predetermined threshold time, processing transfers to step 1812.

In step 1812, ADE monitor 104 builds an alert message including identification and location of the subject patient, the sequentially interacting drugs triggering the ADE alert, and the nature of the potential ADE as represented in ADE recommendations 1508 (FIG. 15). If no currently administered drug of the subject patient interacts with any recently administered drug of the subject patient in an order-dependent manner, step 1812 is skipped.

In test step 1814, ADE monitor 104 determines whether a currently administered drug of the subject patient interacts with a recently administered drug of the subject patient and the time lapsed between the former drug in an order-independent manner and the current drug is less than a predetermined threshold time. The interacting drugs and the predetermined threshold lapse between drugs are specified in ADE interactions 1506. In test step 1814, the order of the drugs is insignificant as specified in ADE interactions 1506. If a currently administered drug of the subject patient follows administration of a recently administered, interacting drug of the subject patient within the predetermined threshold time, processing transfers to step 1816.

In step 1816, ADE monitor 104 builds an alert message including identification and location of the subject patient, the sequentially interacting drugs triggering the ADE alert, and the nature of the potential ADE as represented in ADE recommendations 1508 (FIG. 15). If no currently administered drug of the subject patient interacts with any recently administered drug of the subject patient in an order-independent manner, step 1816 is skipped.

After steps 1814-1816, processing according to logic flow diagram 1704, and therefore step 1704 (FIG. 17), completes. It should be noted that a single drug order for the subject patient can generate multiple alert messages in logic flow diagram 1704. For example, one drug can interact adversely with both a currently administered drug and a recently administered drug of the subject patient.

In step 1706 (FIG. 17), ADE monitor 104 places all alert messages built in step 1704 on the alert queue for subsequent processing by alert manager 114 in the manner described below. After step 1706, processing according to logic flow diagram 1606, and therefore step 1606 (FIG. 16), completes.

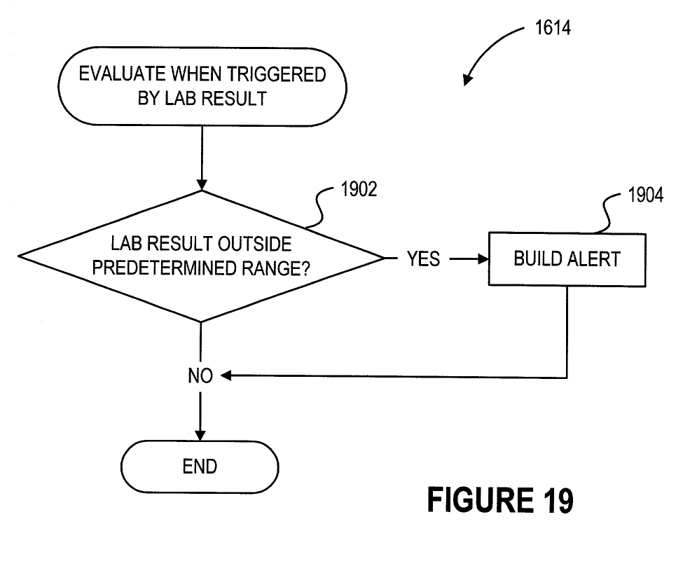

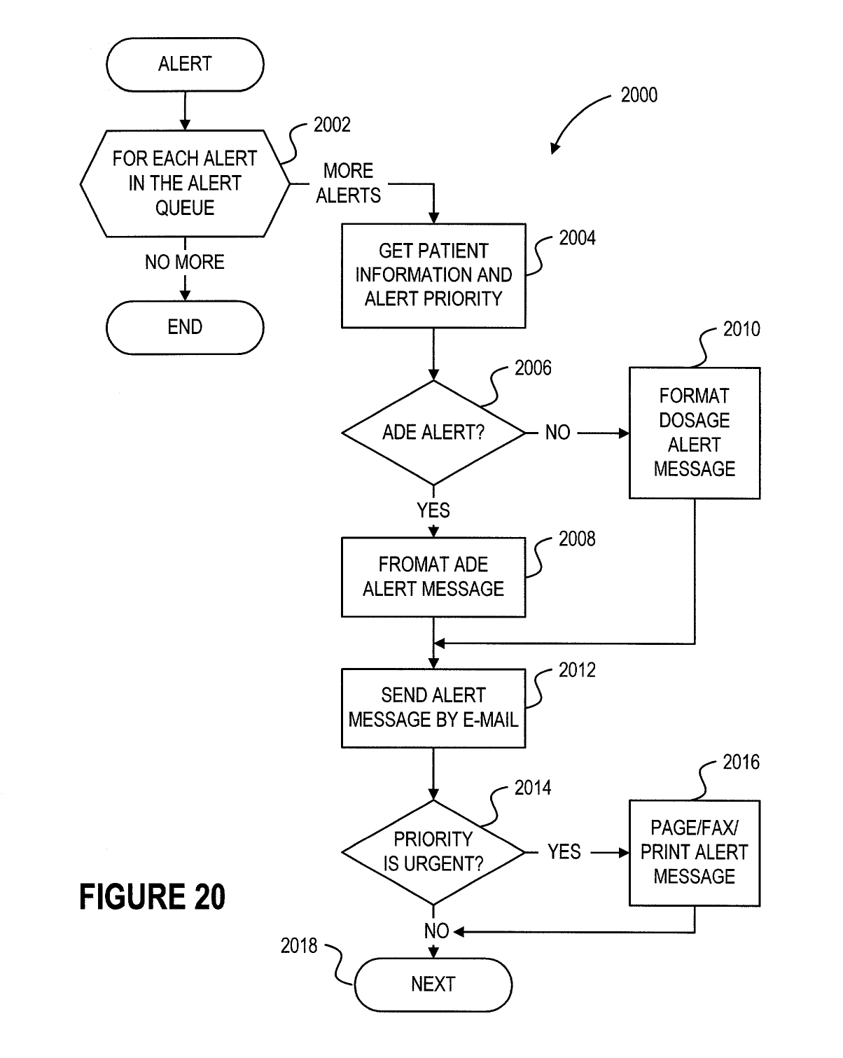

ADE analysis by ADE monitor 104 in step 1614 when triggered by a new laboratory result is shown in greater detail as logic flow diagram 1614 (FIG. 19). In test step 1902, ADE monitor 104 determines whether the subject laboratory result lies outside a predetermined range of allowable laboratory result values as represented in ADE panic labs 1504. If so, ADE monitor 104 determines that the subject laboratory result can be an indication of an ADE in the subject patient and builds an alert message and place the alert message in the alert queue in step 1904. The alert message includes identification and location of the subject patient, the laboratory result triggering the ADE alert, and the nature of the potential ADE as represented in ADE recommendations 1508 (FIG. 15). Conversely, if the subject laboratory result lies within the predetermined range of allowable laboratory result values as represented in ADE panic labs 1504 (FIG. 15), step 1904 (FIG. 19) is skipped.

After steps 1902-1904, processing according to logic flow diagram 1614, and therefore step 1608 (FIG. 16), completes.

Thus, ADE monitor 104 analyzes drug orders and laboratory results of individual patients for potential ADE risks and notifies a clinician of the potential ADE in sufficient time that the ADE can be averted.

Alert Manager

Alert manager 114 (FIG. 1) processes alert messages on an alert queue to send the alert messages to appropriate clinicians for evaluation and corrective action. Processing by alert manager 114 is shown by logic flow diagram 2000. Loop step 2002 and next step 2018 define a loop in which each alert message on the alert queue is processed according to steps 2004-2016. During each iteration of the loop of steps 2002-2018, the particular alert message processed is sometimes referred to as the subject alert message. Alert manager 114 (FIG. 1) processes the alert messages of the alert queue according to logic flow diagram 2000 continually and periodically. It is generally not necessary to process alert messages more frequently than once every five (5) minutes but it is preferred that alert messages are processed no less frequently than once every thirty (30) minutes.

In step 2004, alert manager 114 retrieves information of the patient of the subject alert message and priority information of the subject alert message. In this illustrative embodiment, there are two levels of priority. Urgent priority is assigned to alert messages pertaining to potentially life-threatening ADEs. Normal priority is assigned to all other alerts. Low-risk situations are not alerted at all in this illustrative embodiment to avoid desensitizing clinicians to alert messages.

In test step 2006, alert manager 114 determines whether the subject alert message pertains to an ADE alert from ADE monitor 104 or to a dosage alert from dosage monitor 102. If the subject alert message pertains to an ADE alert, alert manager 114 formats the subject alert message for representation as an ADE alert in step 2008. Conversely, if the subject alert message pertains to a dosage alert, alert manager 114 formats the subject alert message for representation as a dosage alert in step 2010.

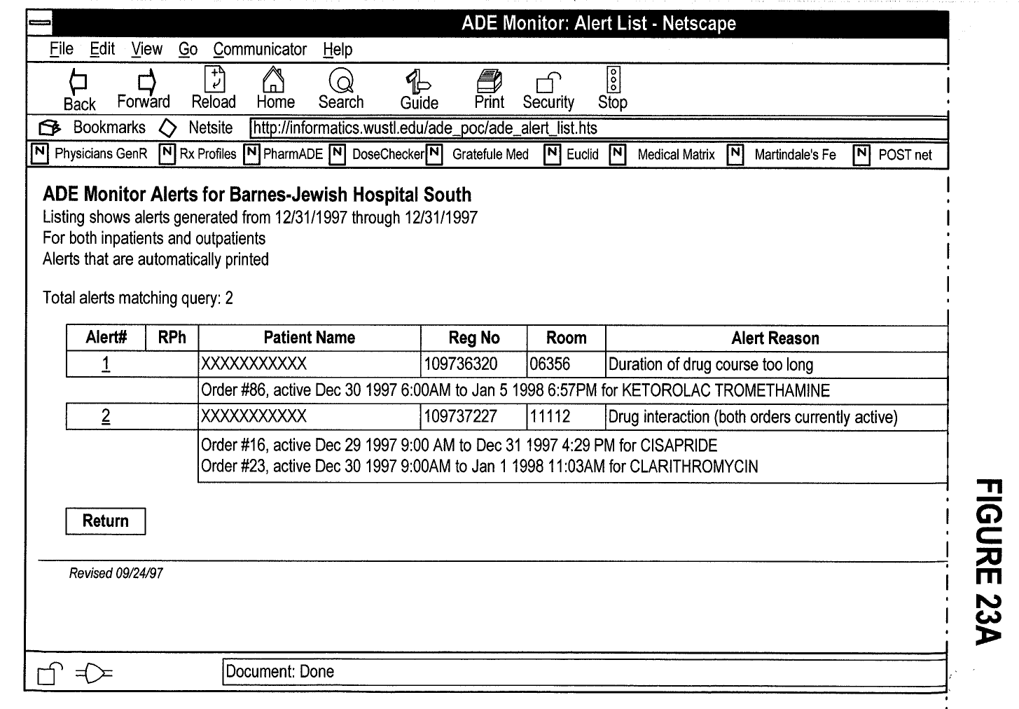

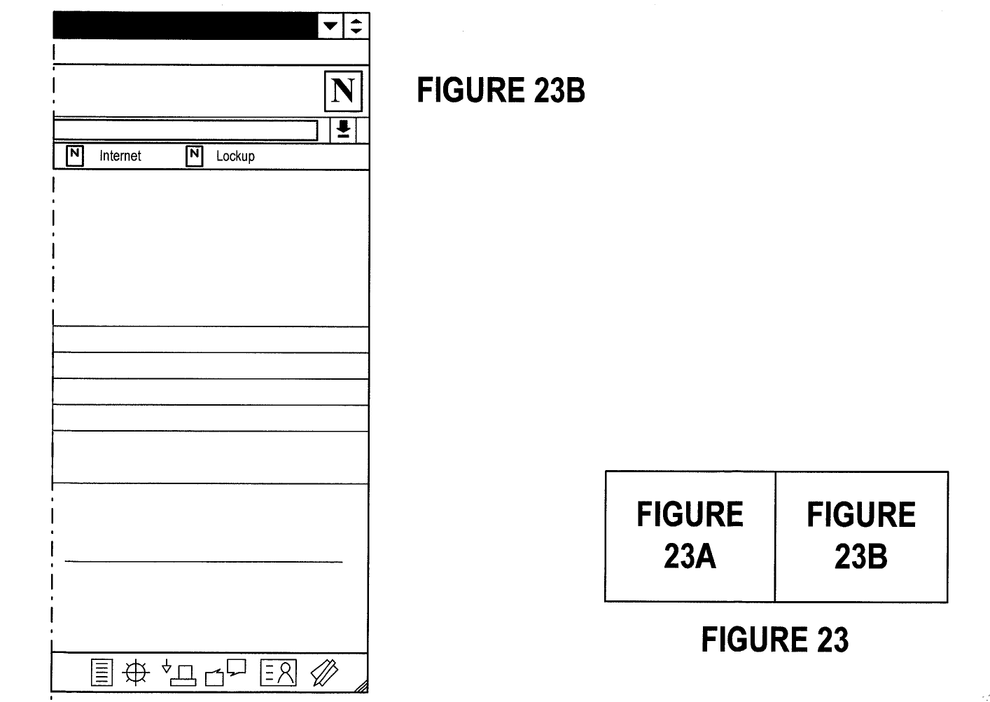

Alert manager 114 formats an ADE alert message in step 2008 by presenting the various information of the alert message in a readable manner, including the patient's name and location and a brief description of the particular reason for the ADE alert. The brief description can be “Drug interaction (both orders currently active)” or “Drug interaction (one order follows another too closely)” for example. ADE manager 114 also formats data representing the interacting drug orders, including drug identification, name, dosage amount, frequency, and order start and stop dates, in a readable manner for easy interpretation by the clinician. An example of an ADE alert message is shown in FIG. 23 as a screen view of an ADE alert report in HTML format.

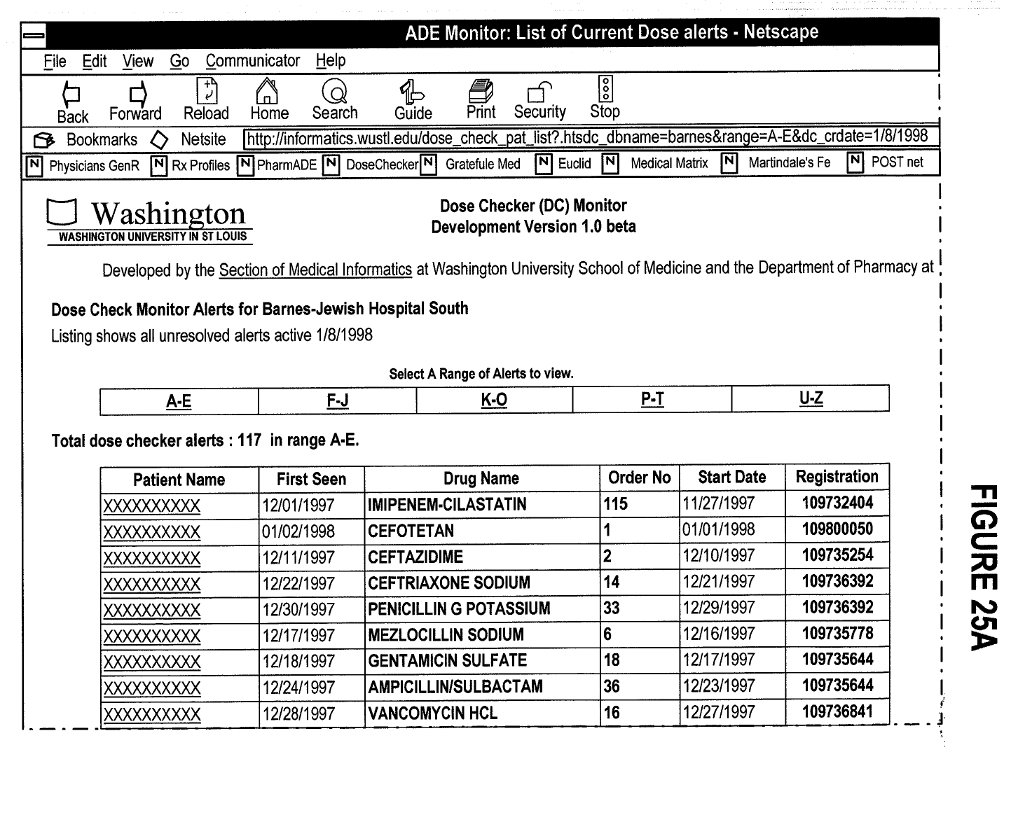

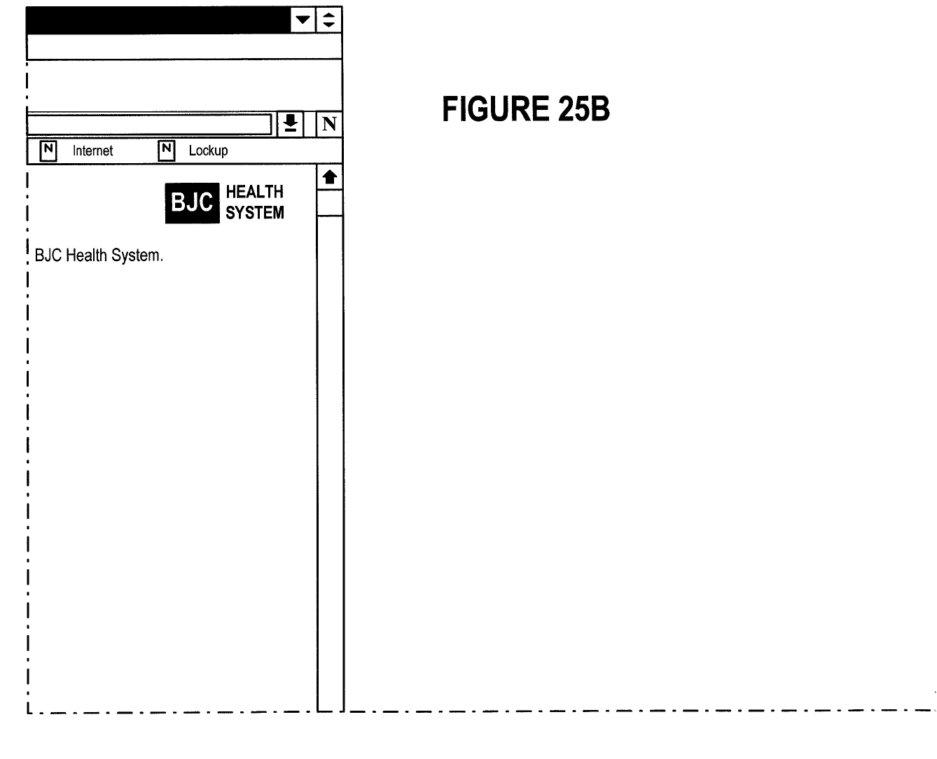

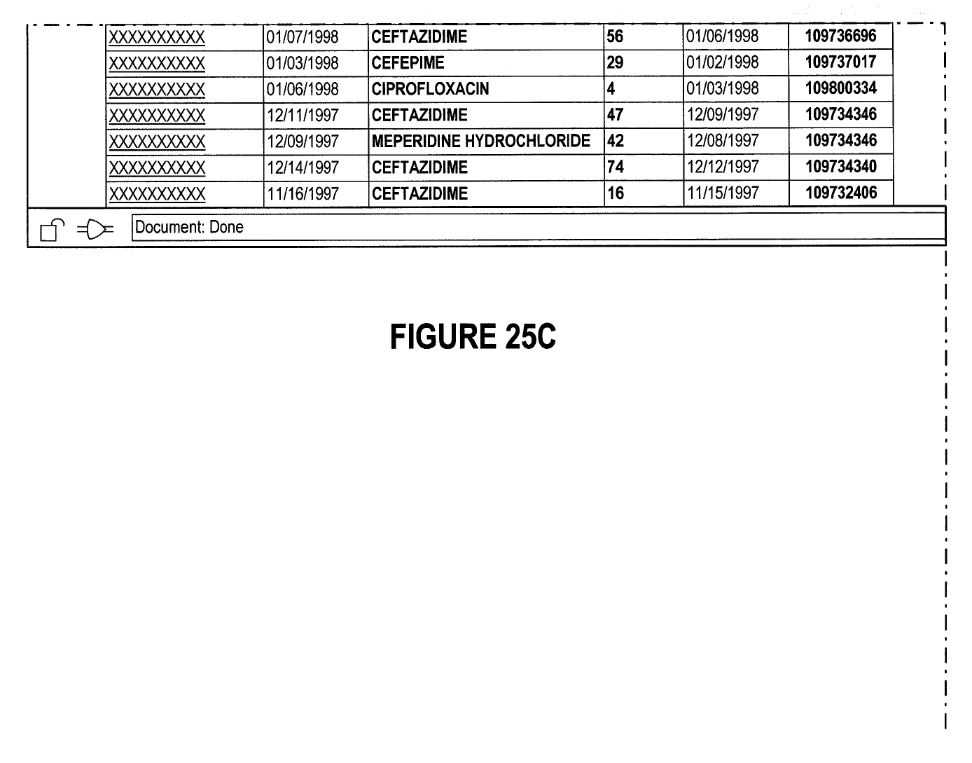

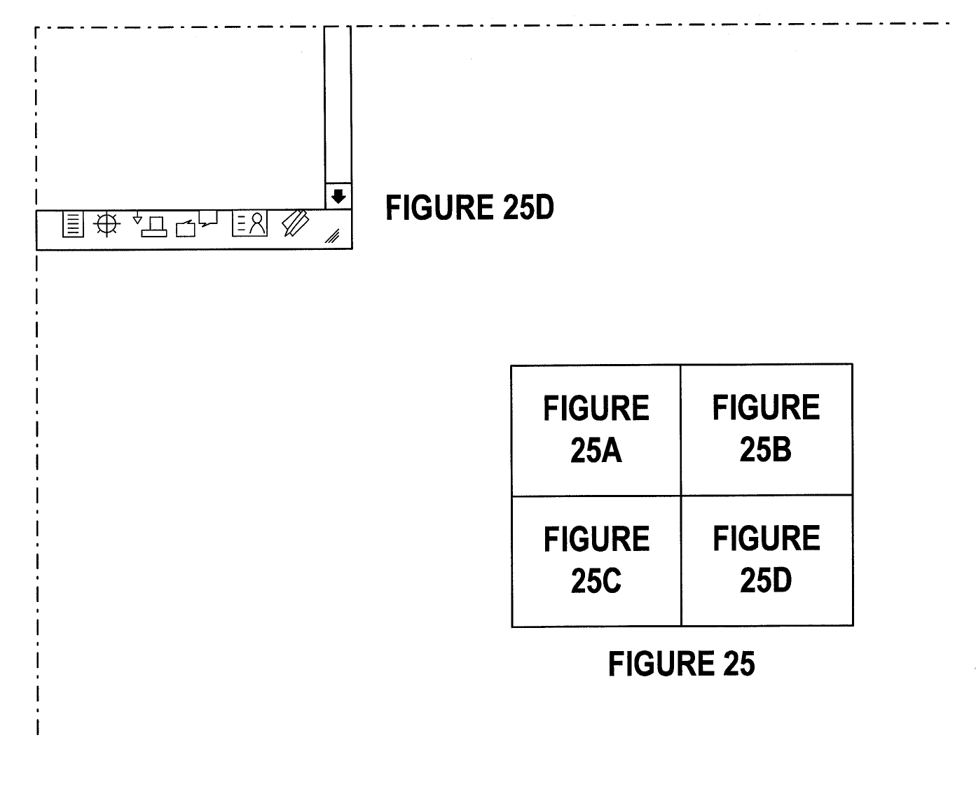

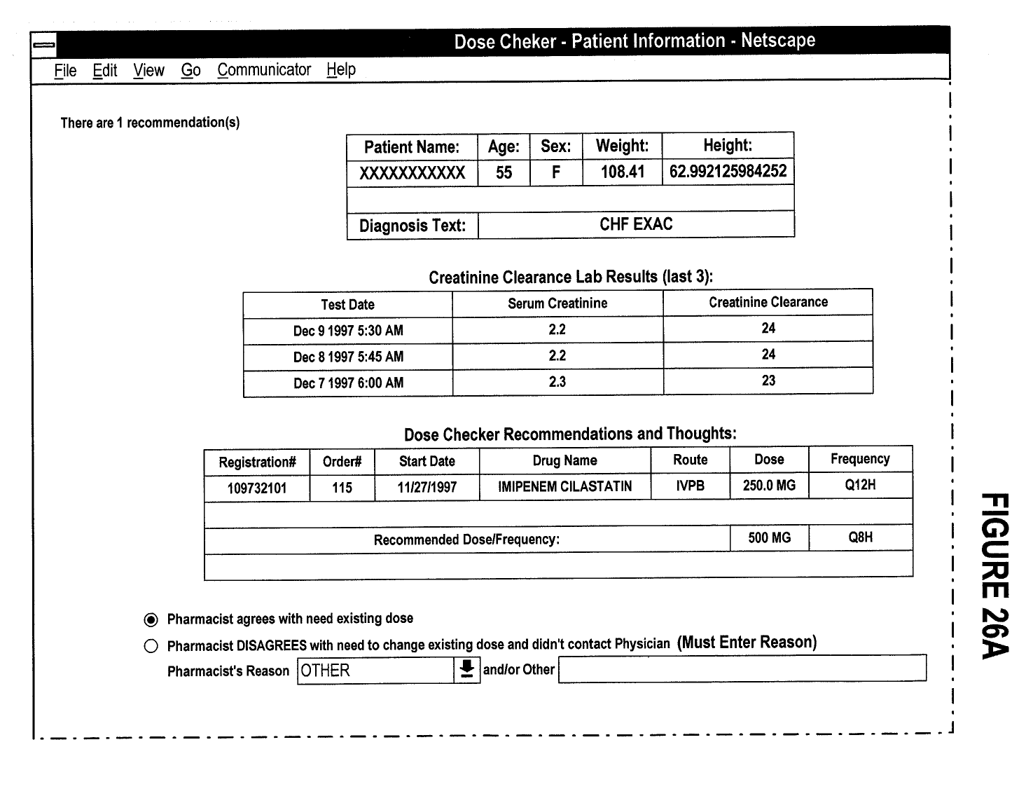

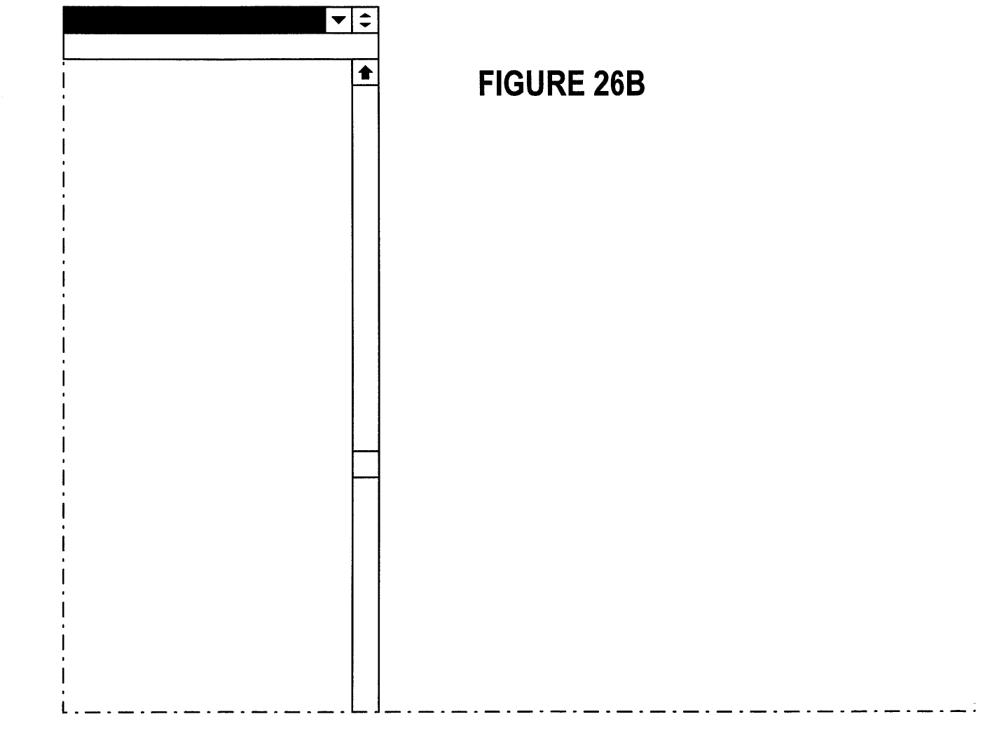

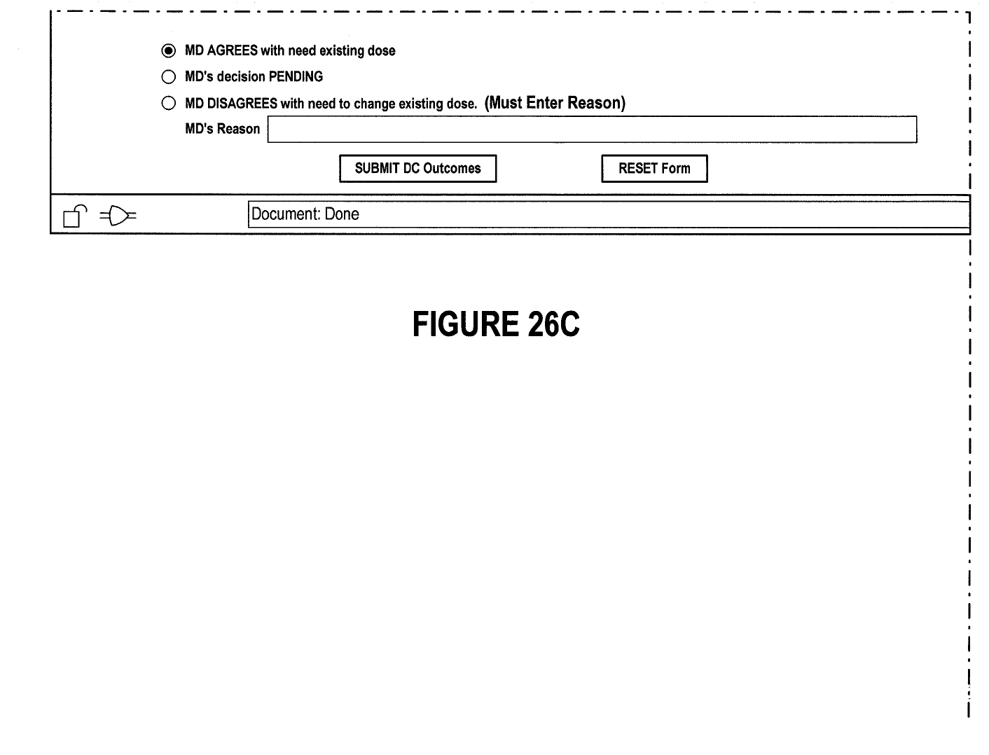

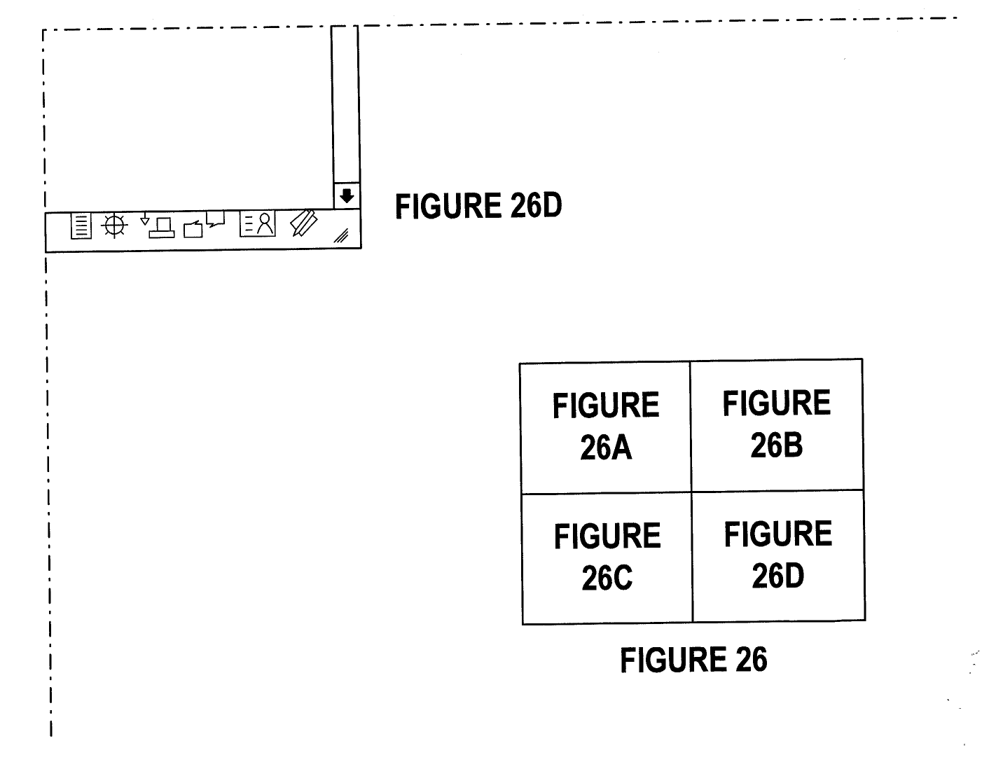

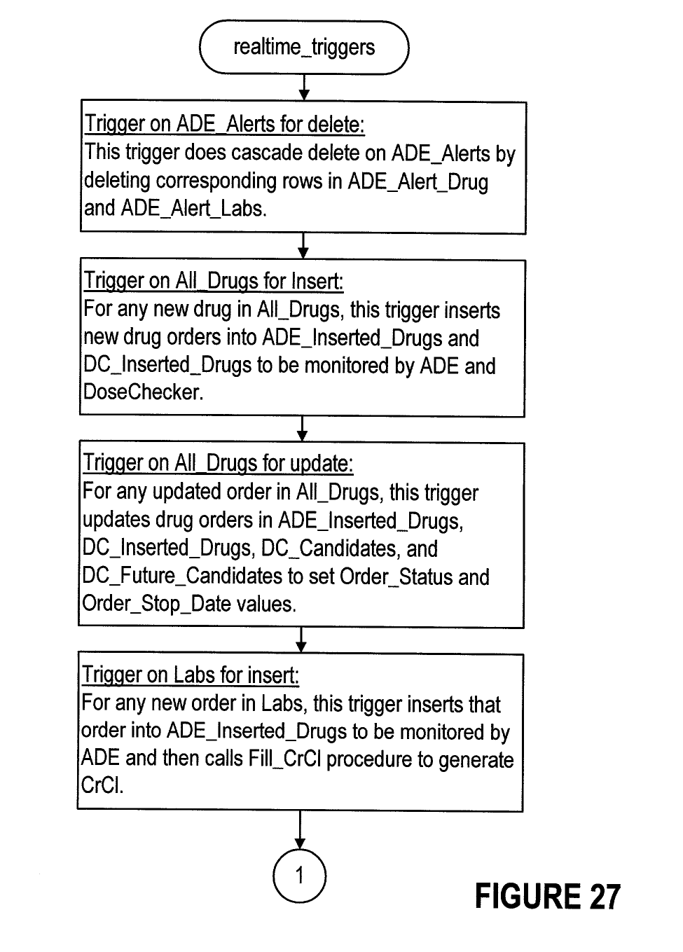

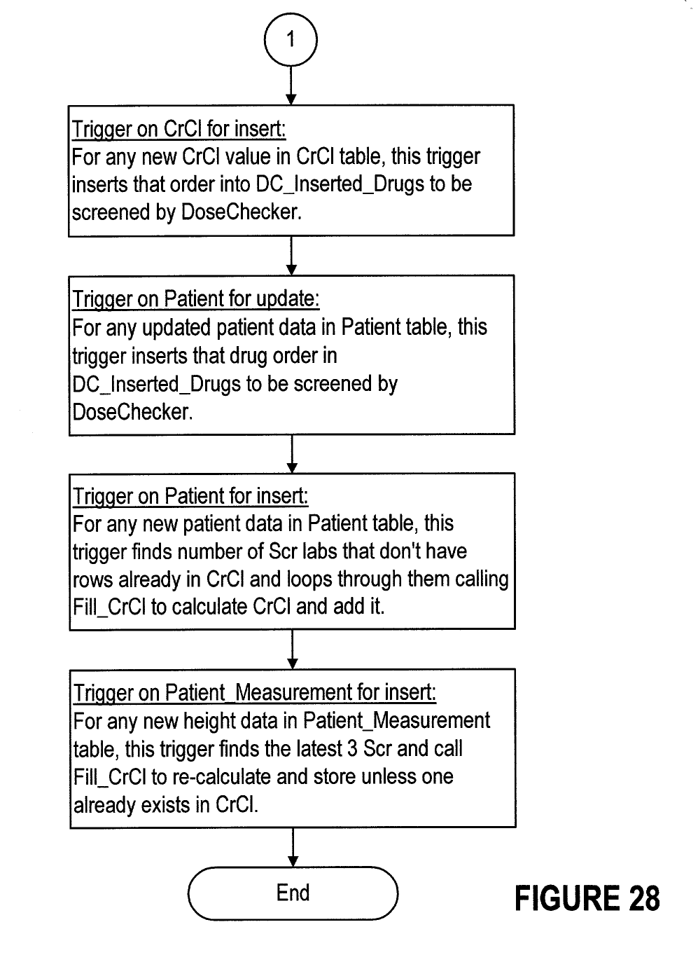

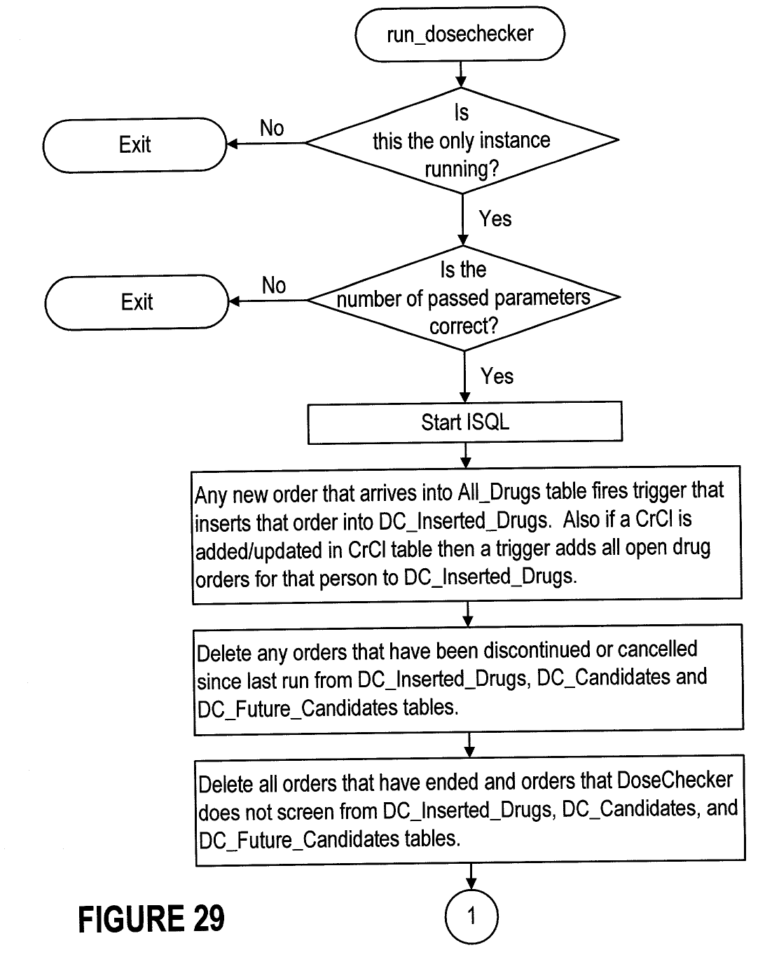

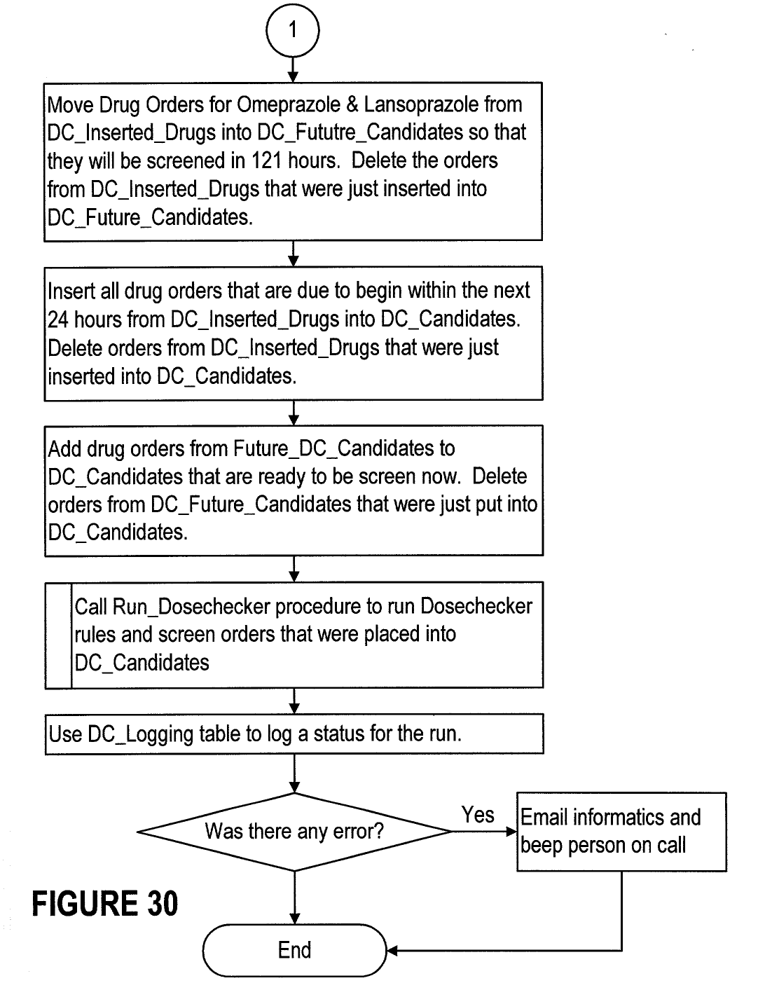

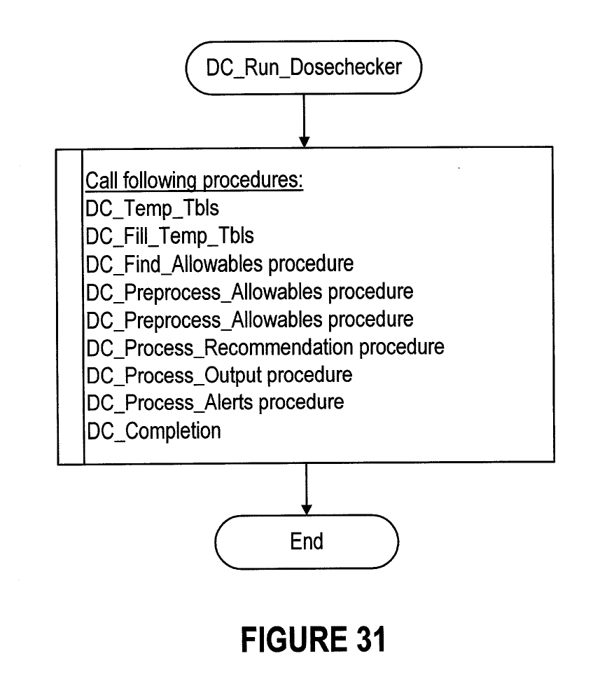

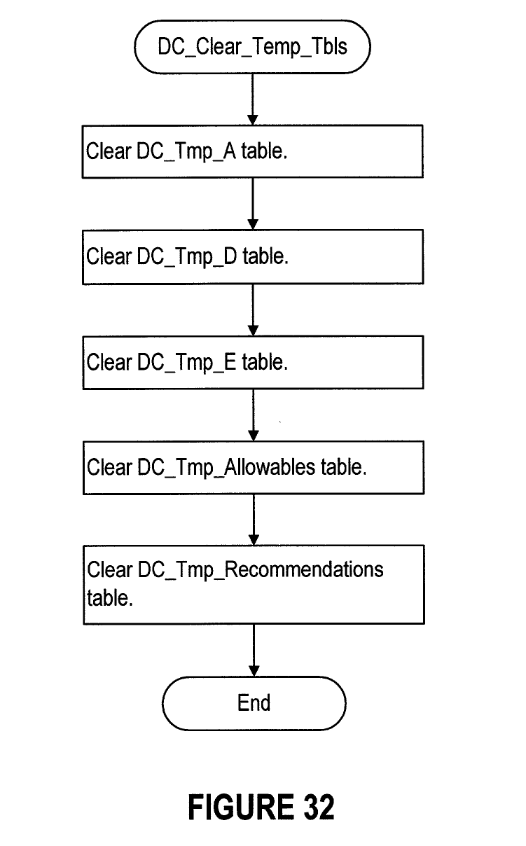

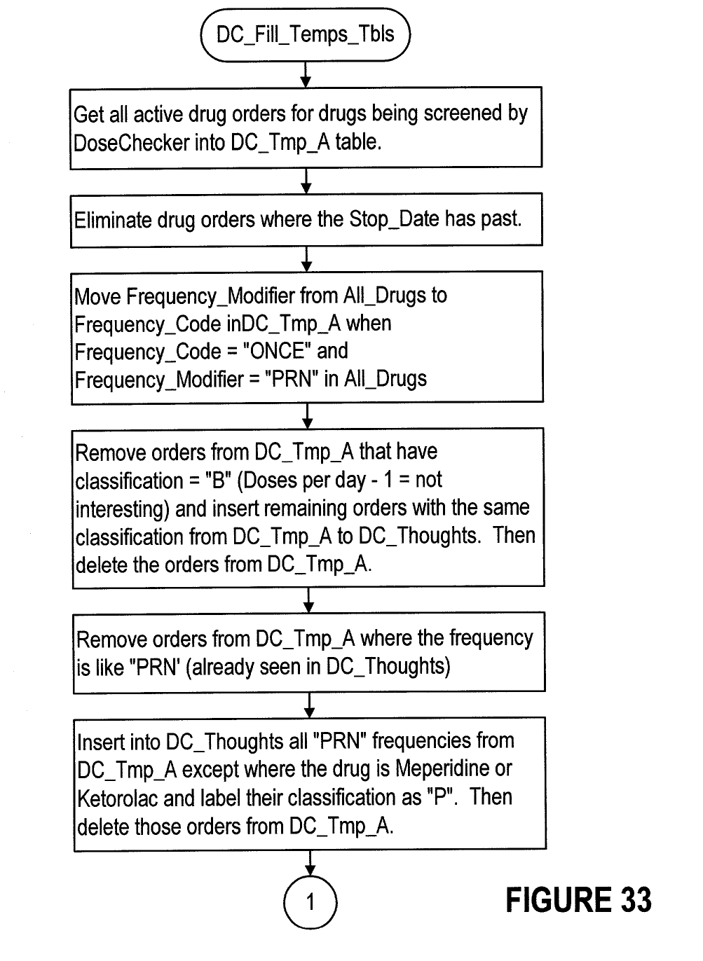

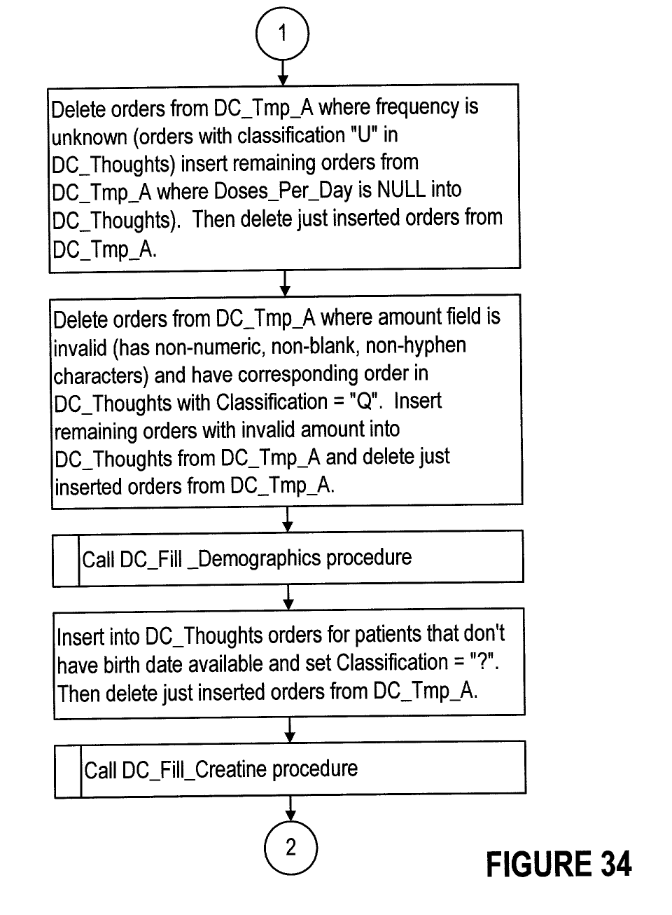

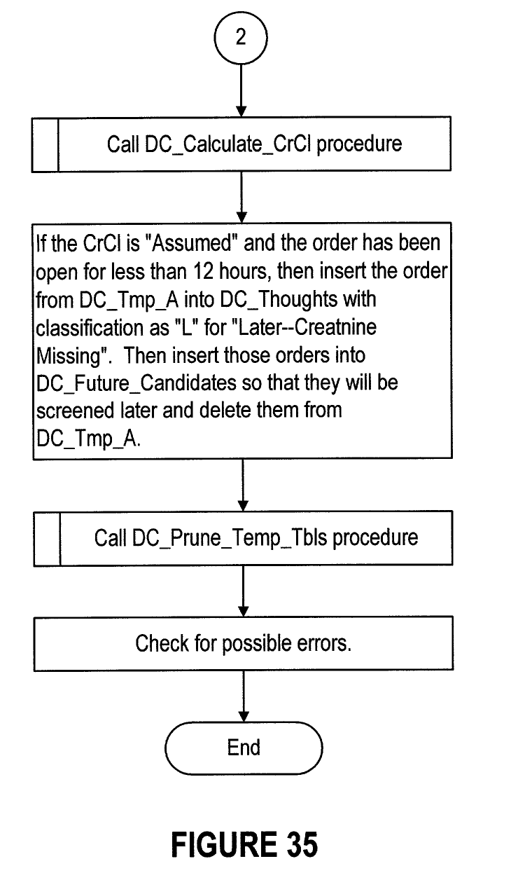

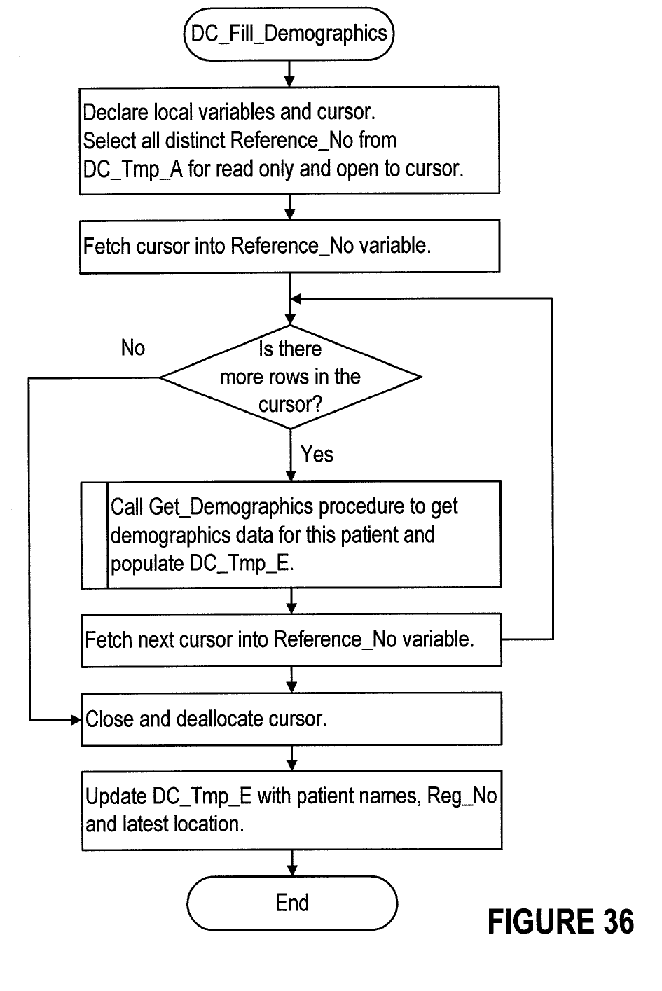

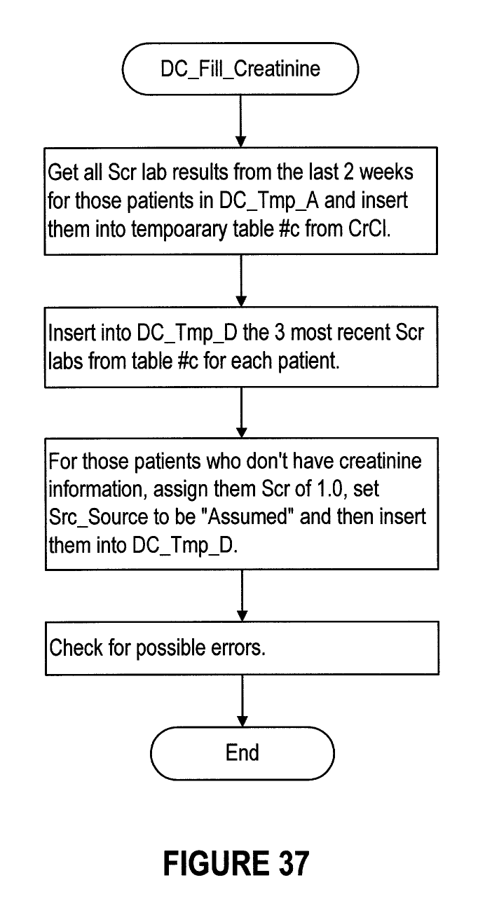

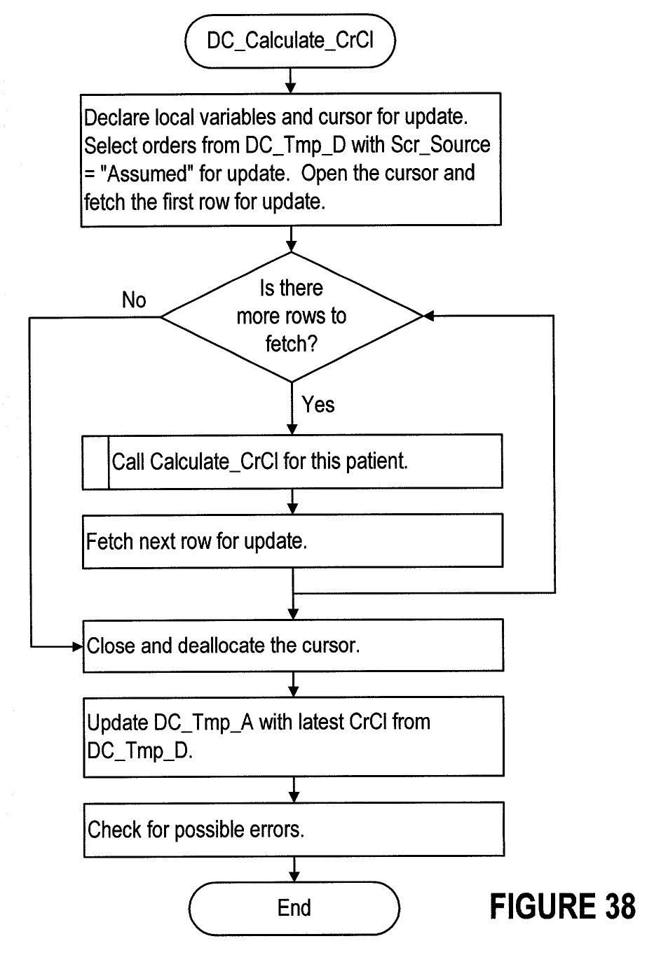

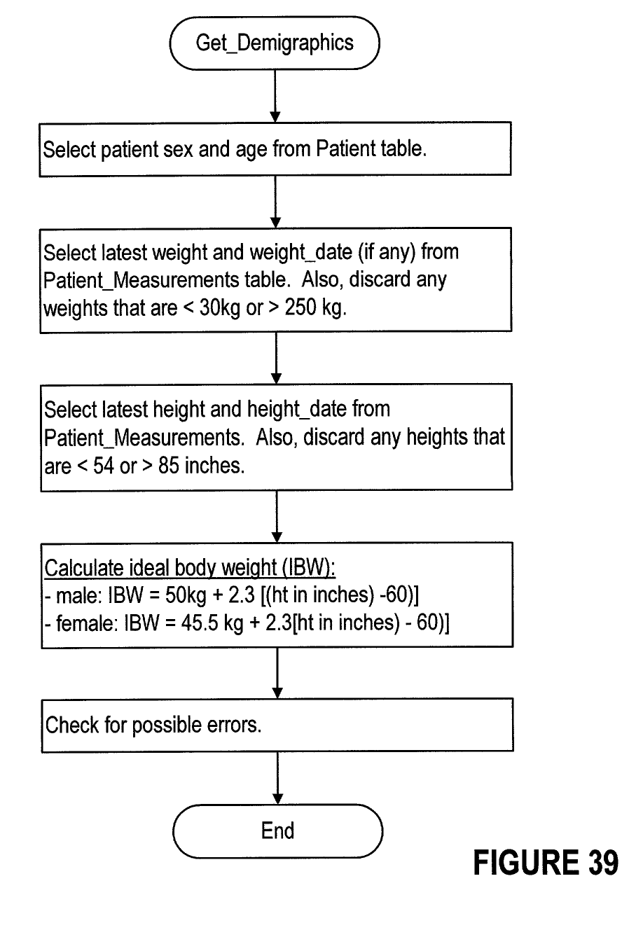

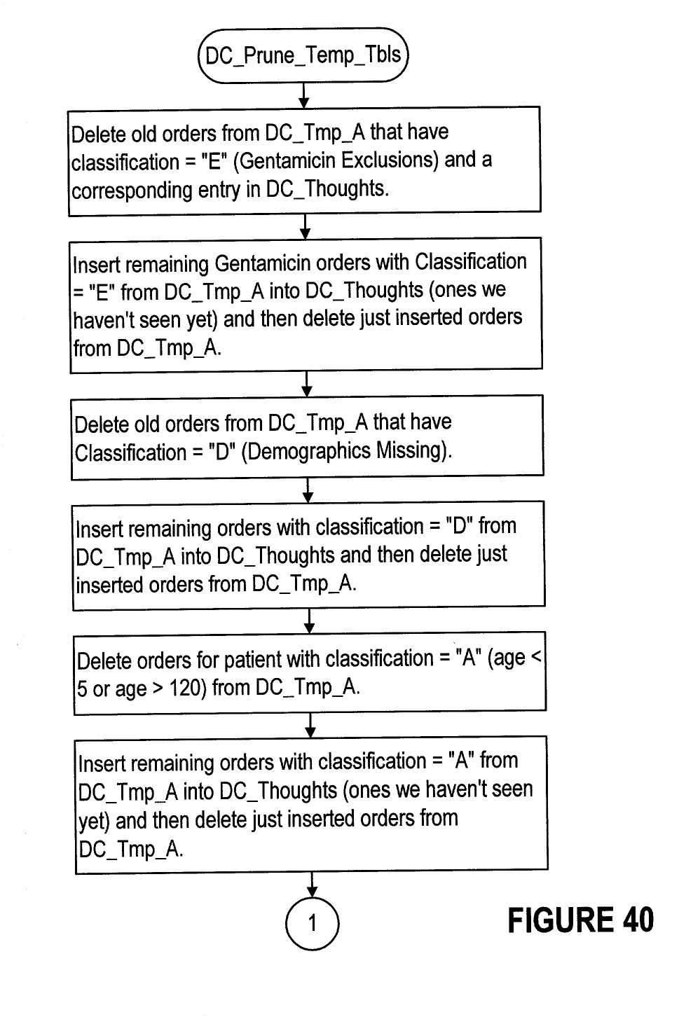

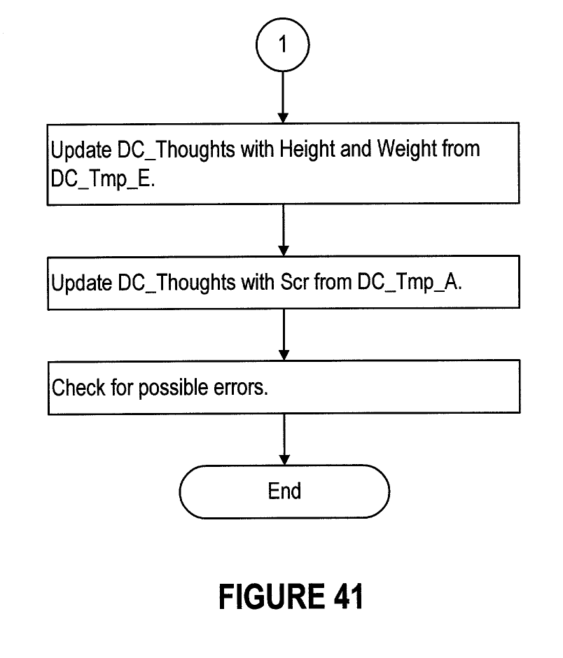

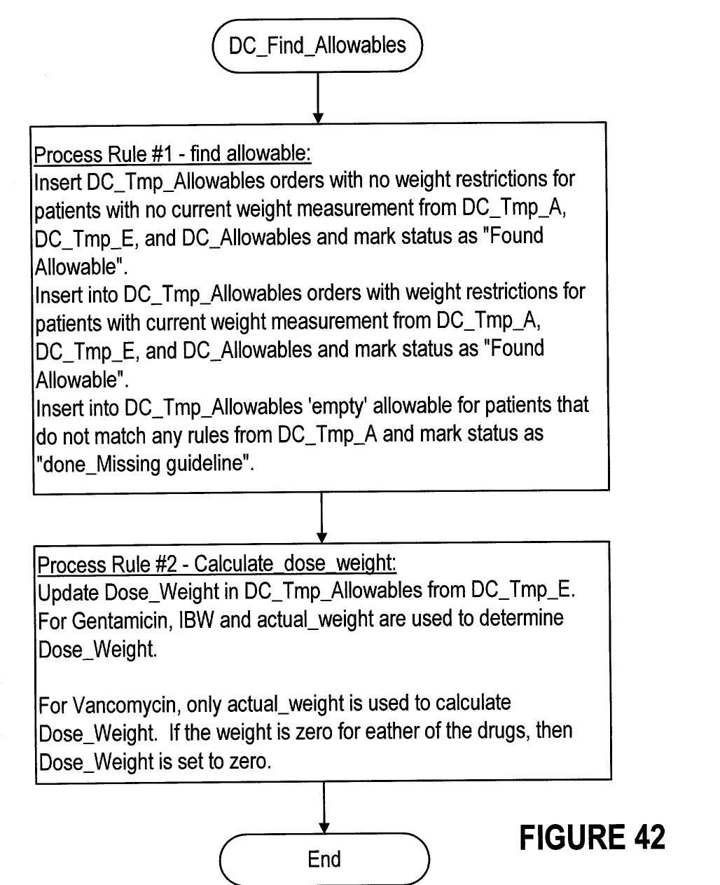

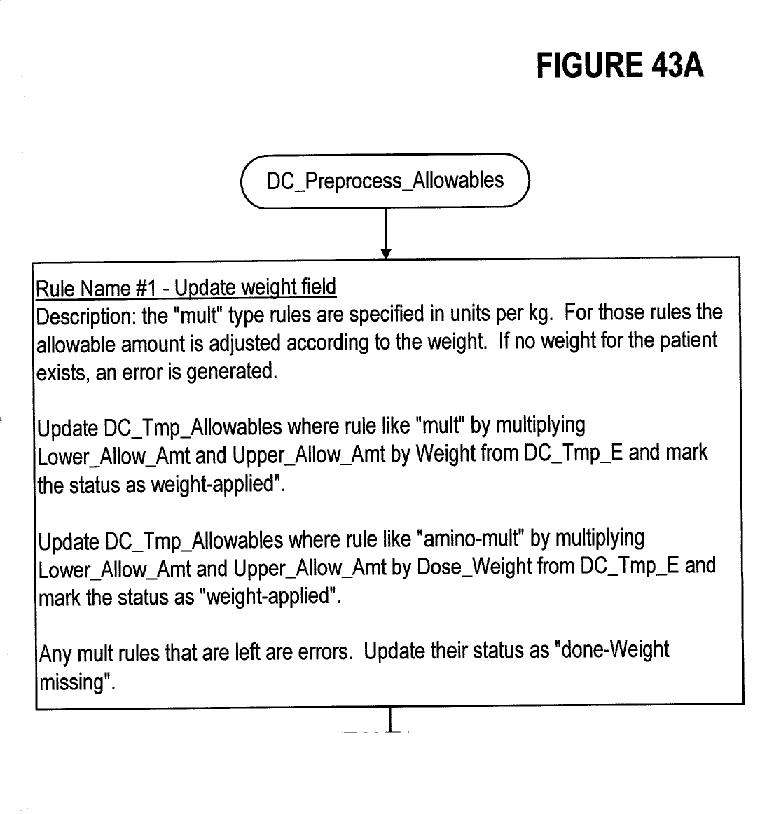

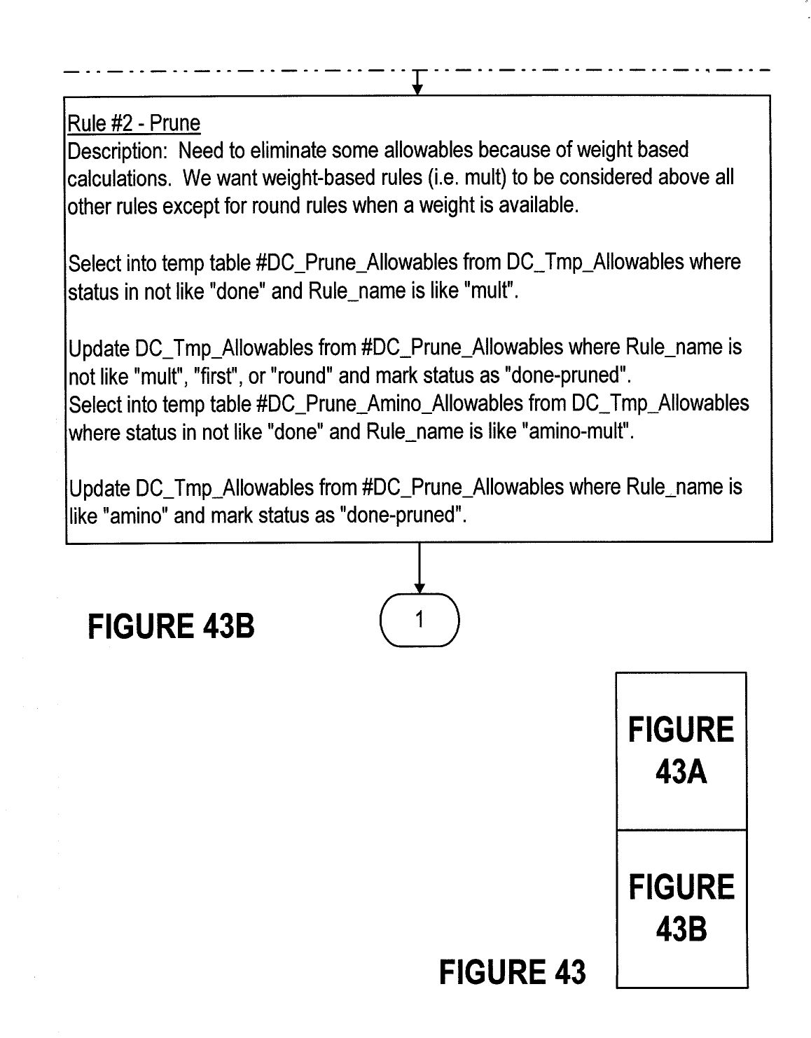

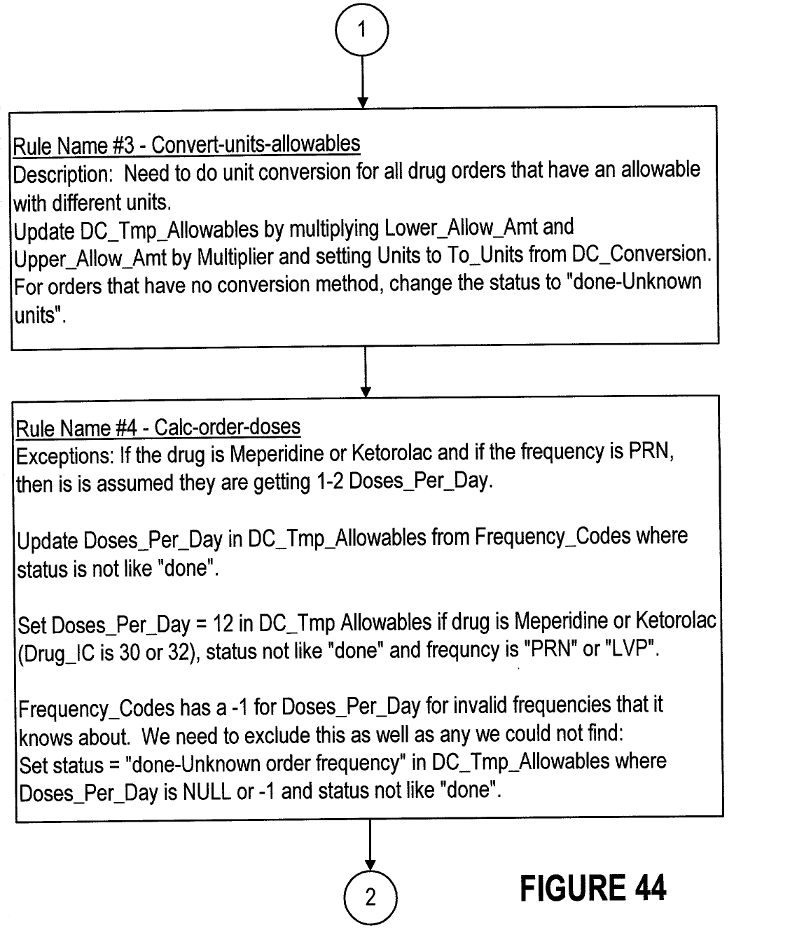

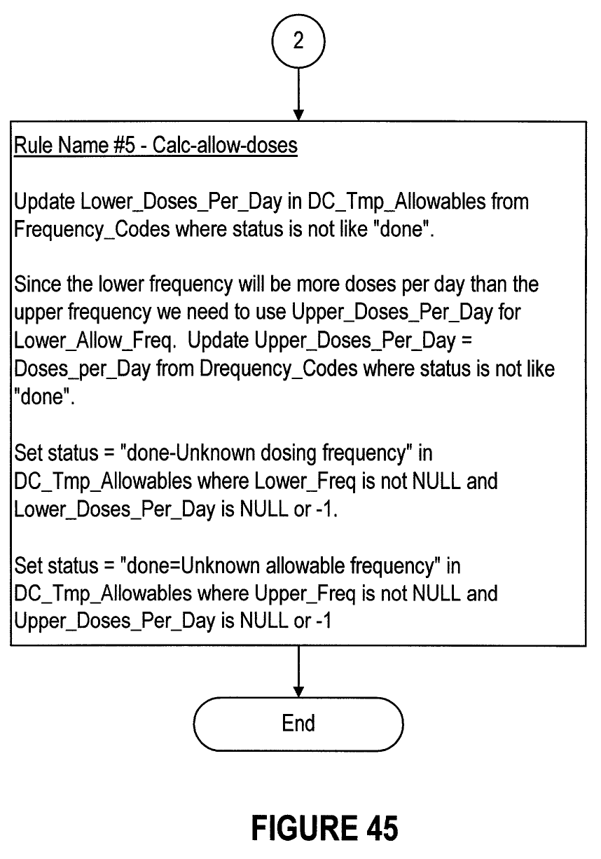

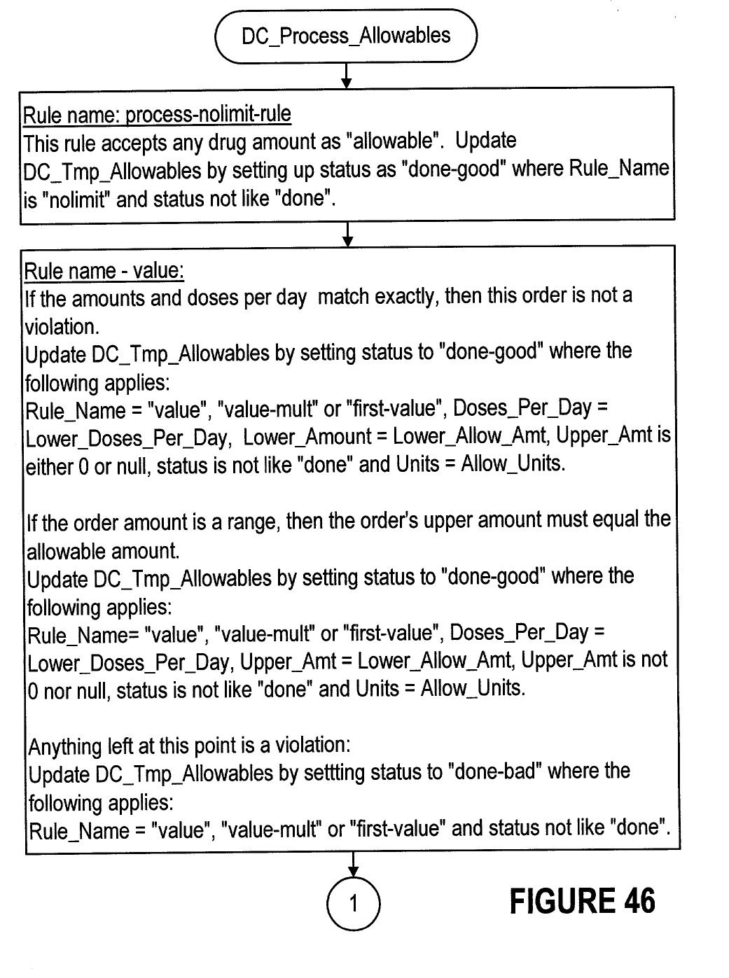

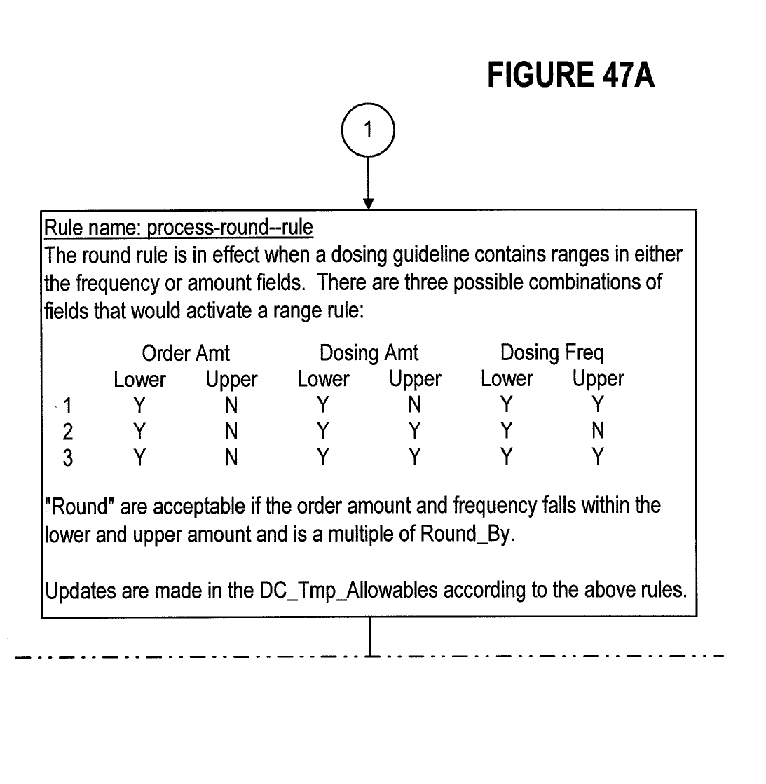

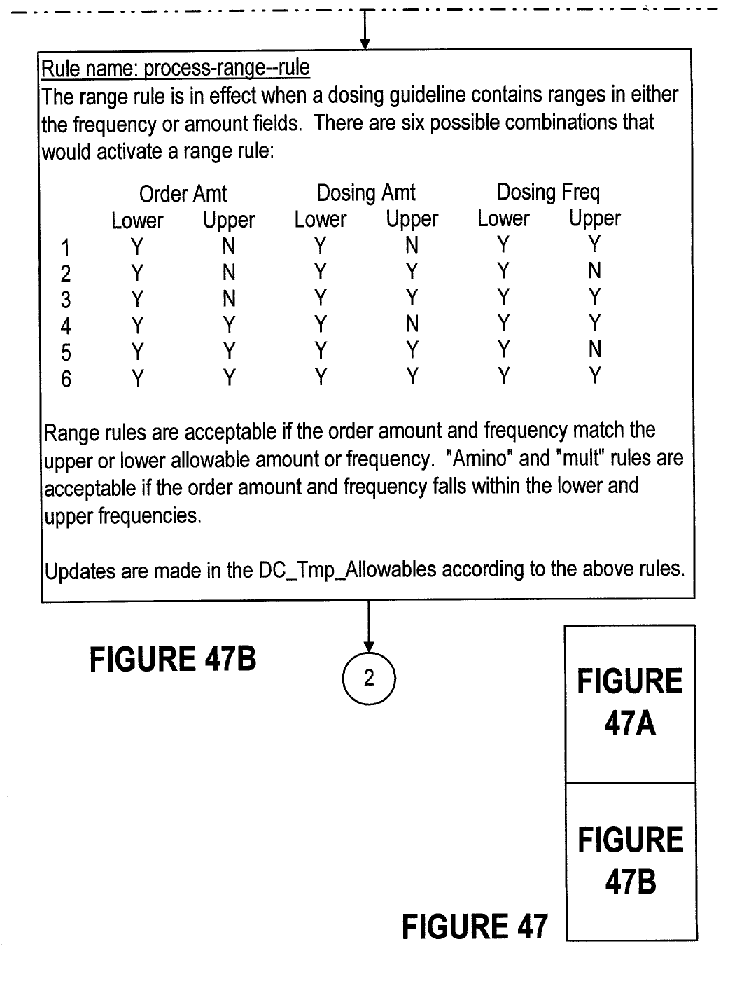

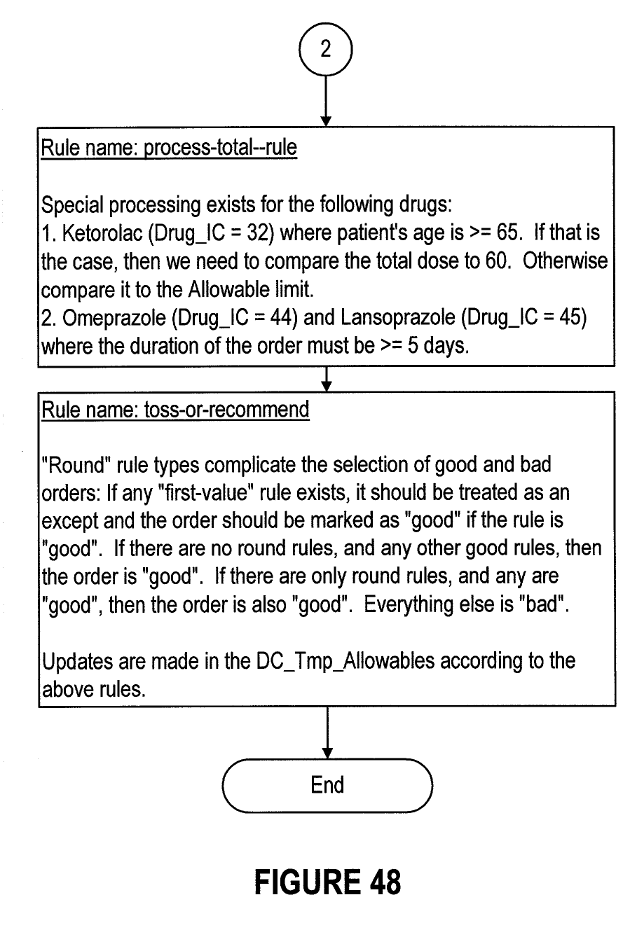

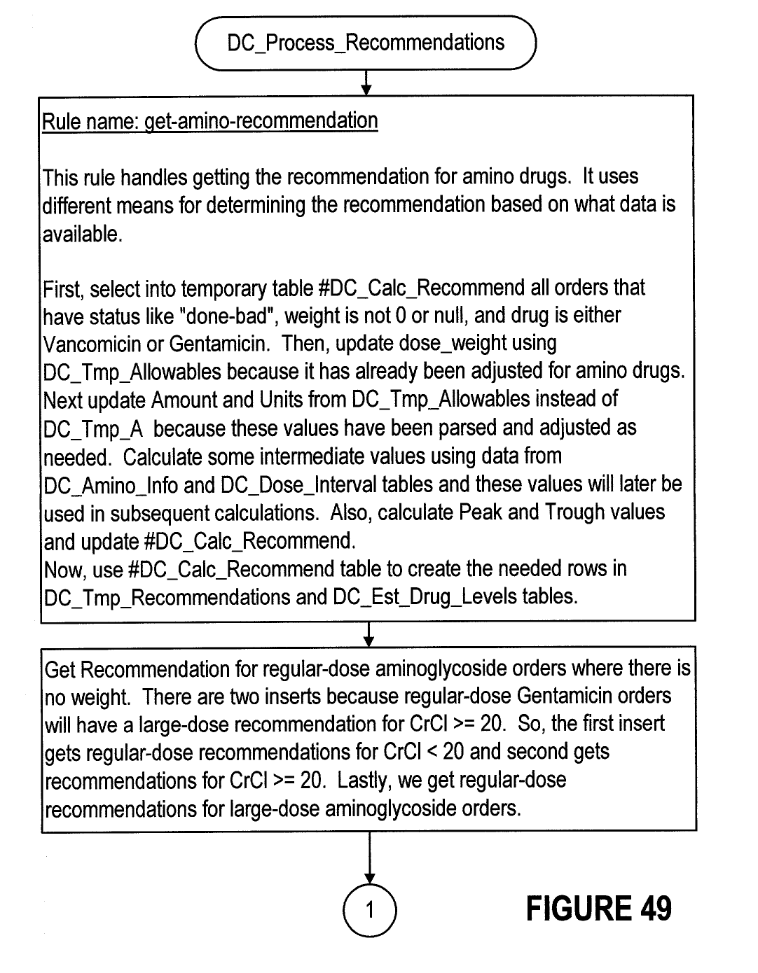

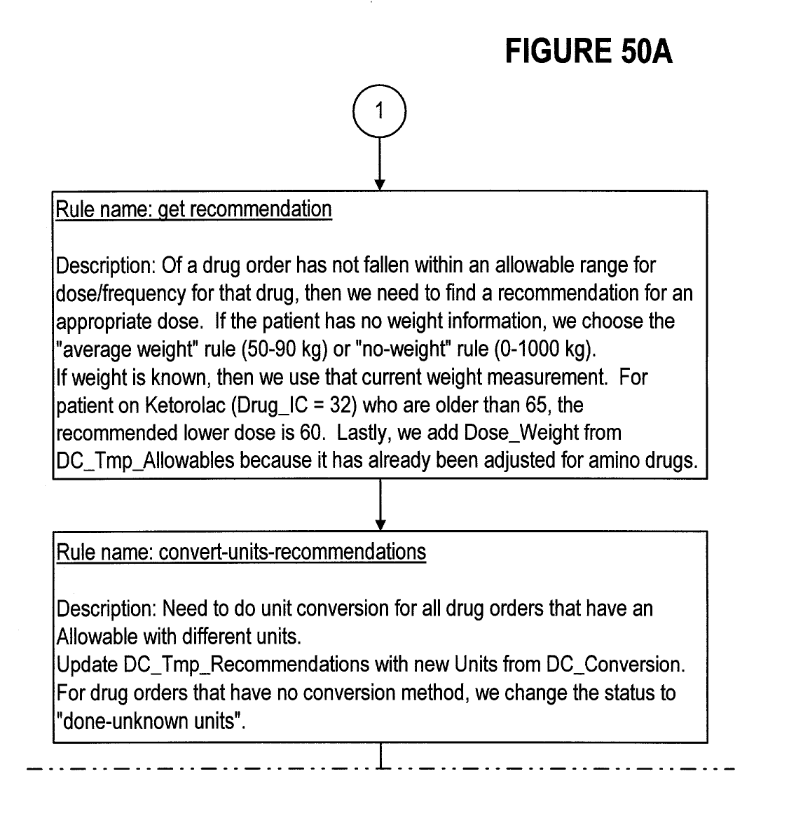

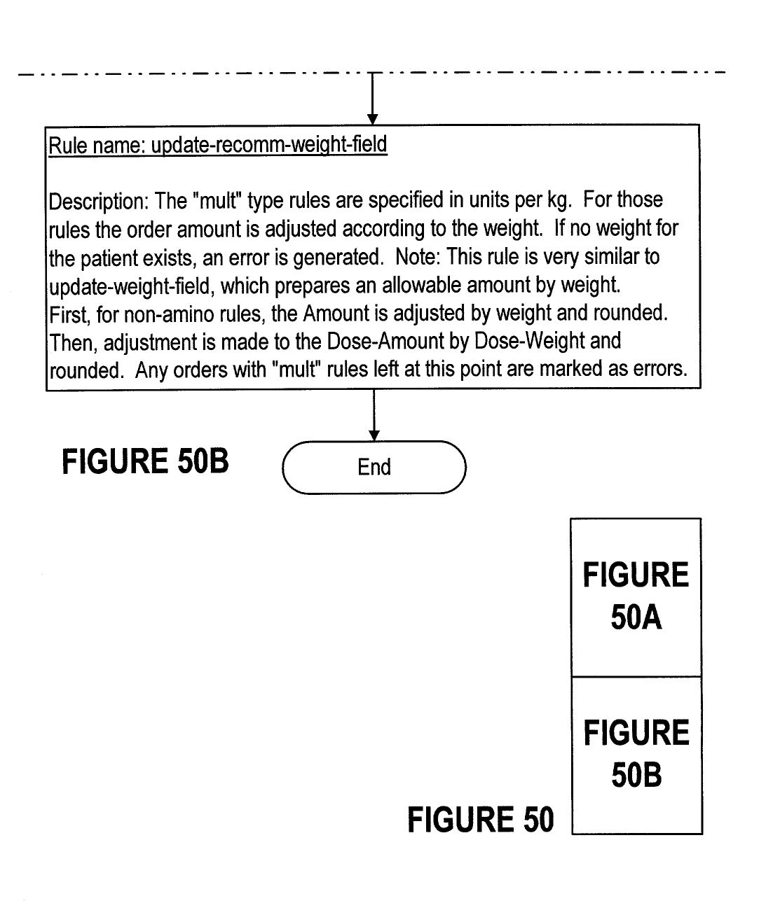

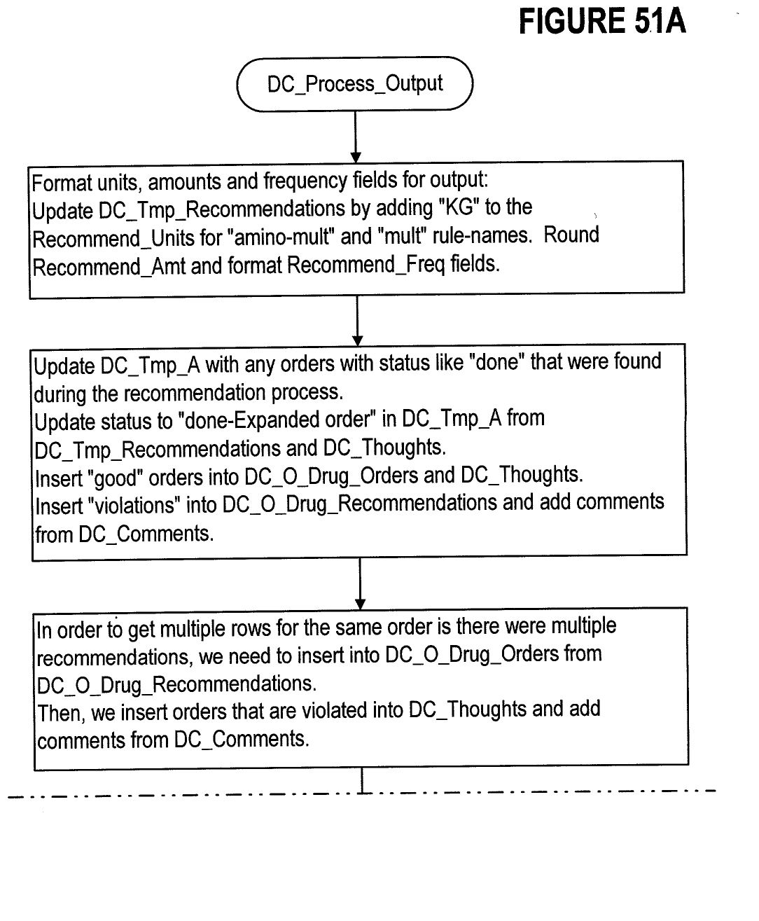

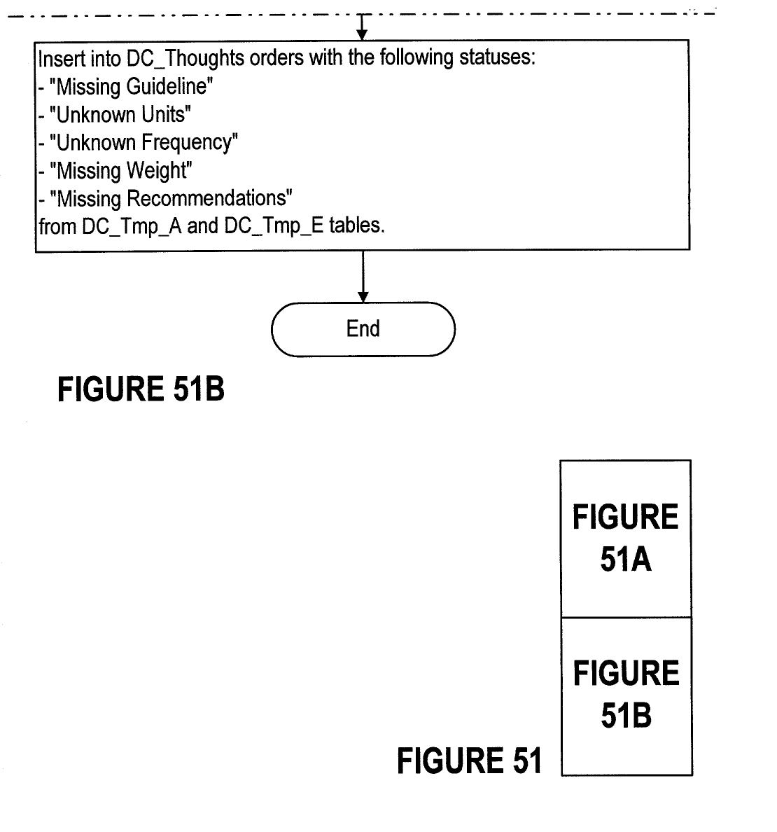

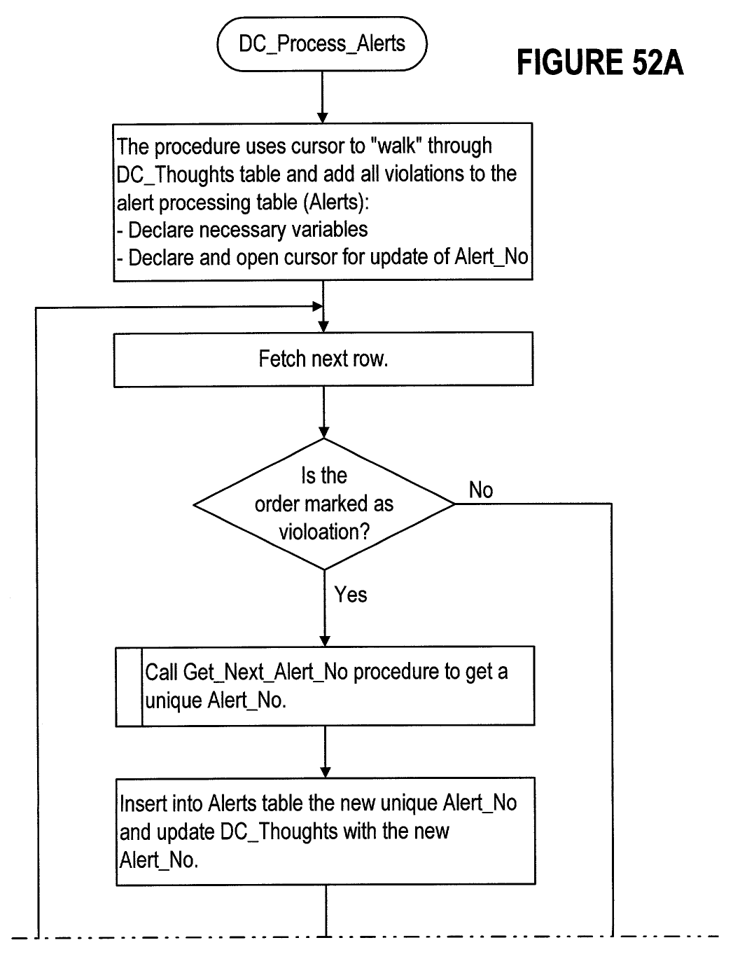

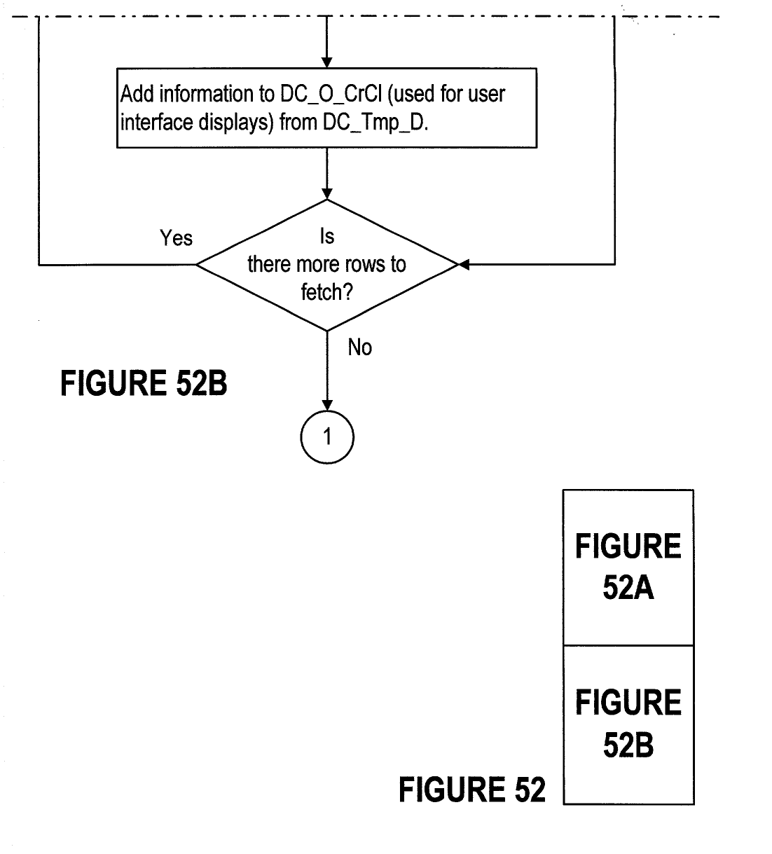

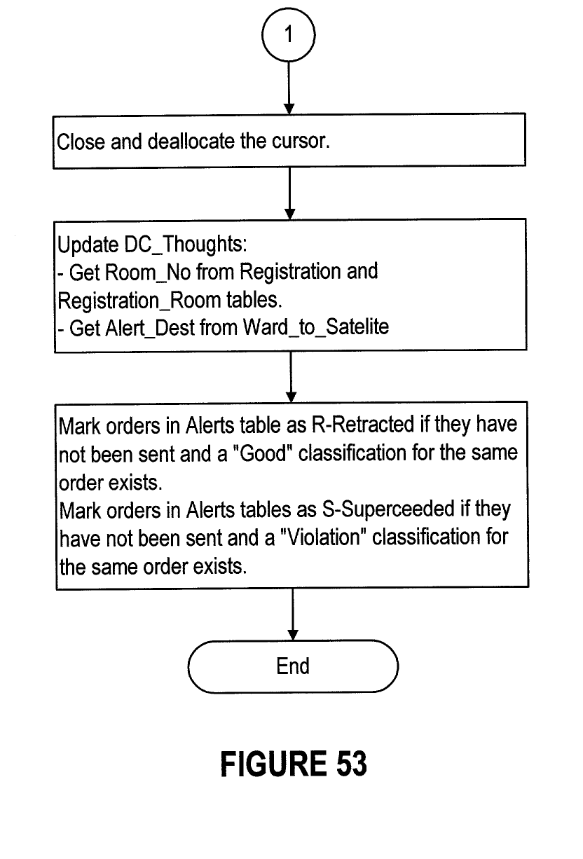

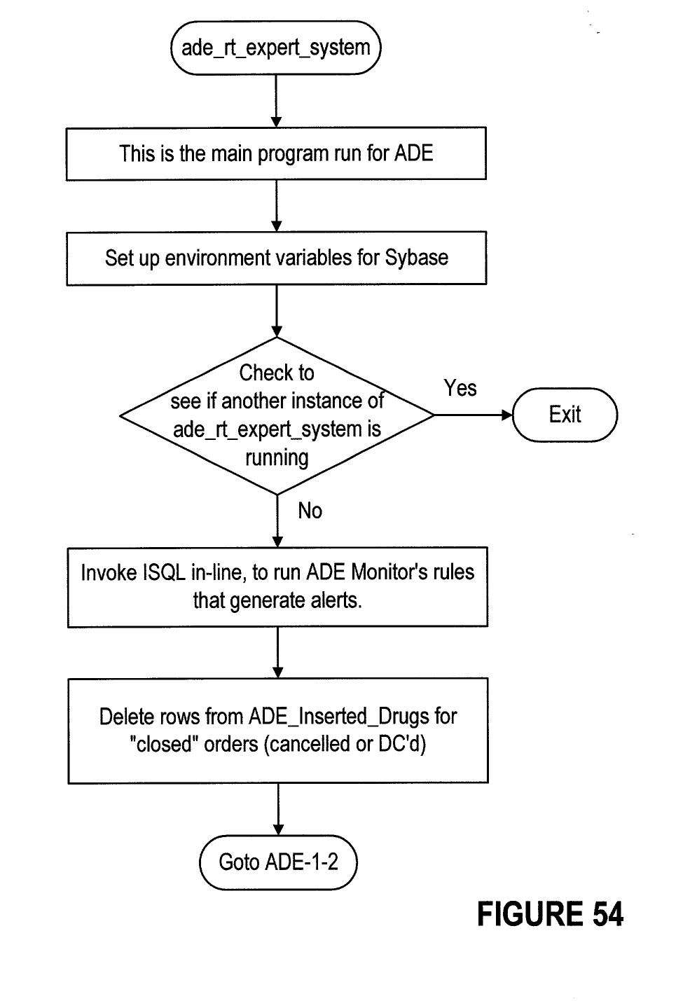

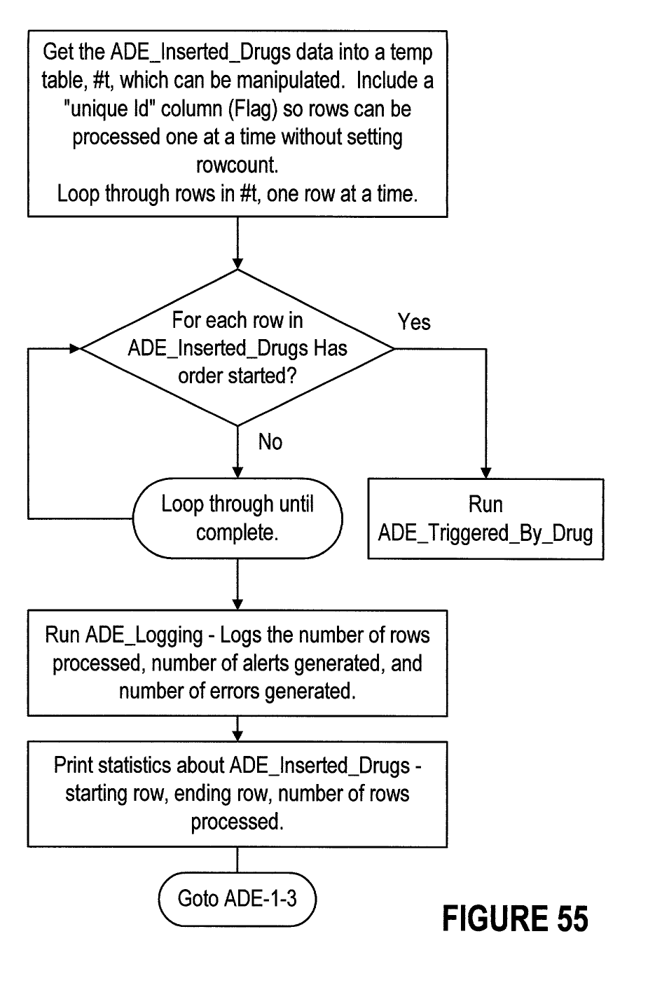

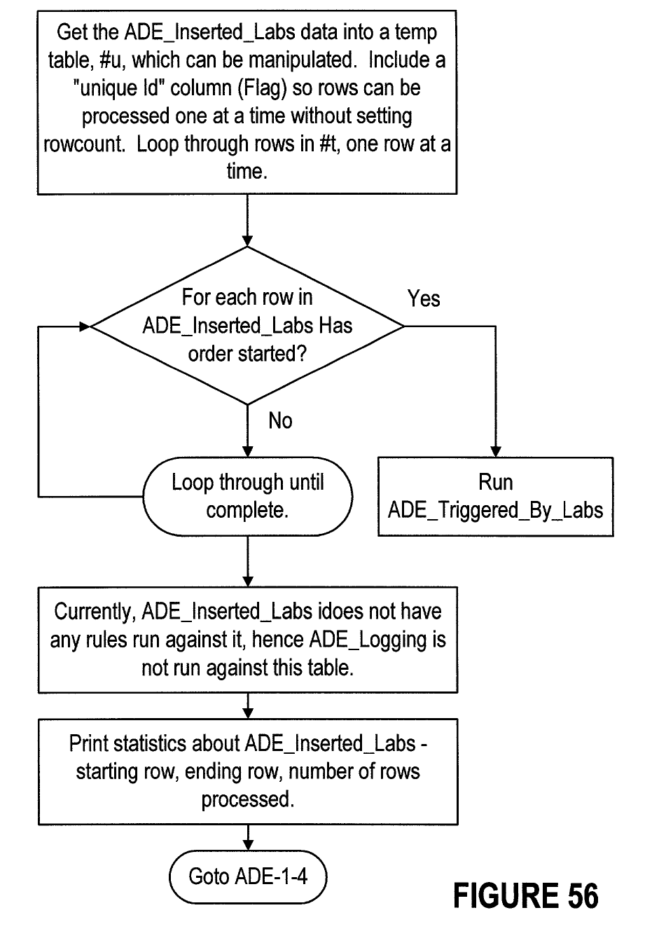

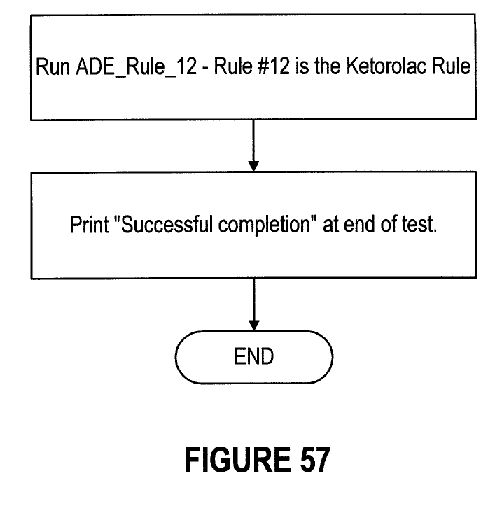

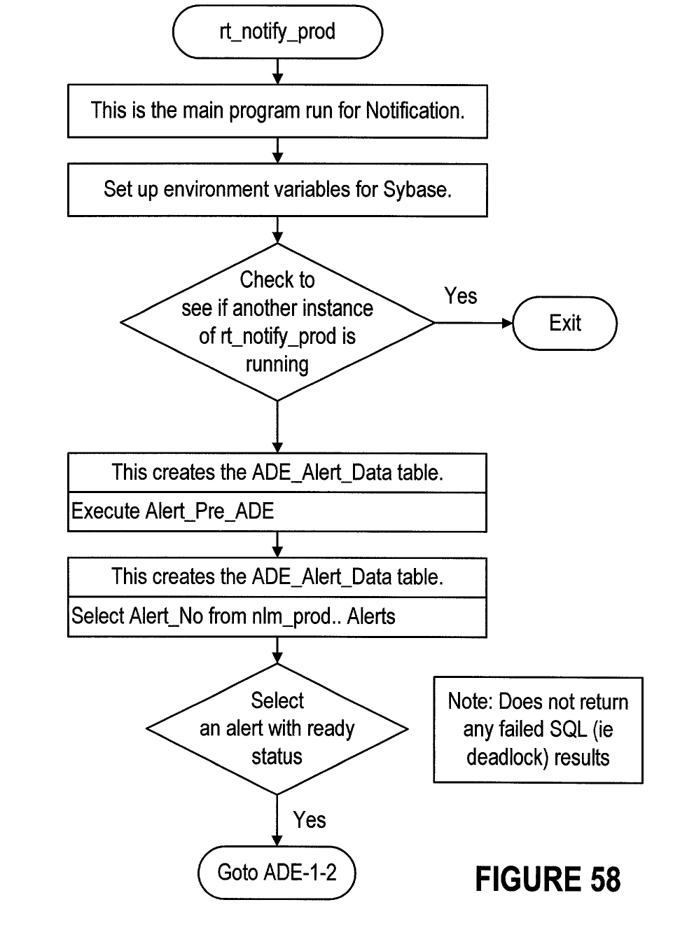

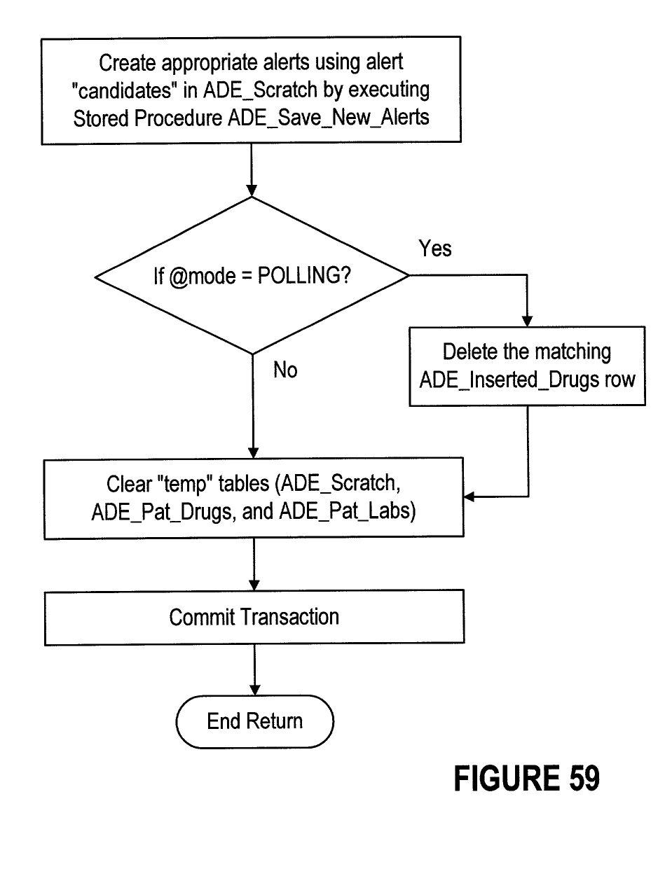

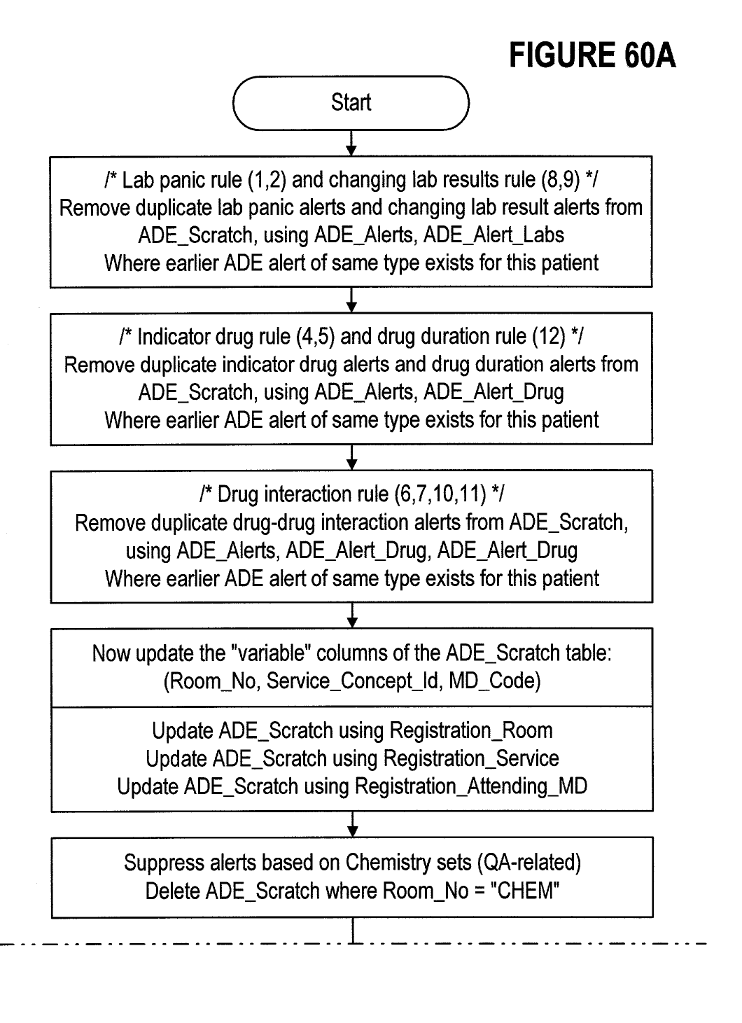

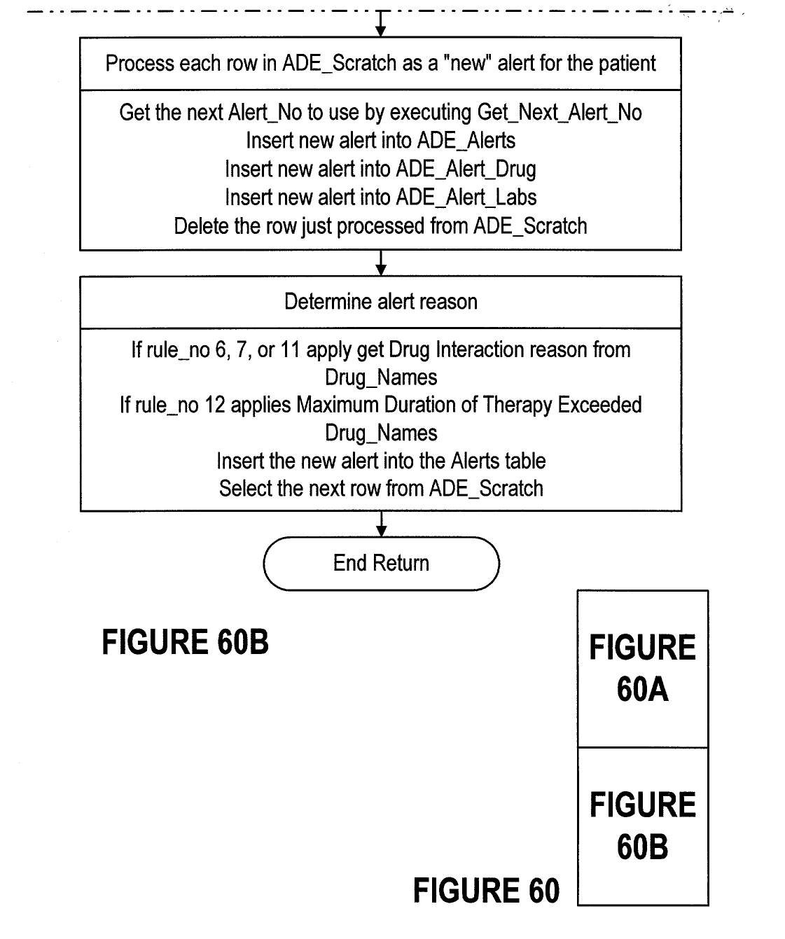

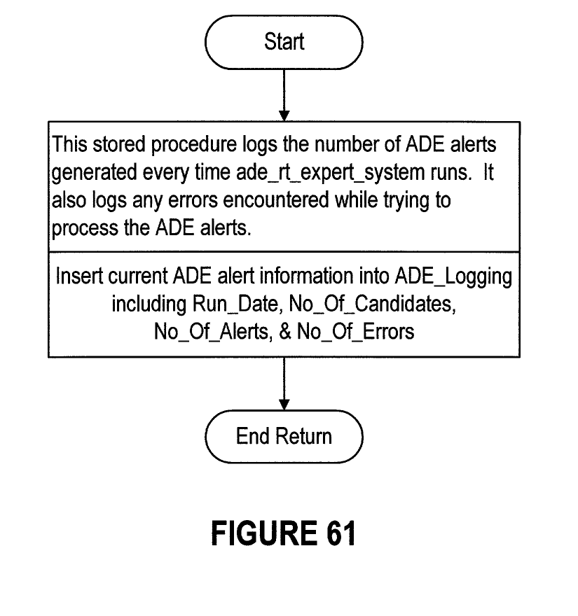

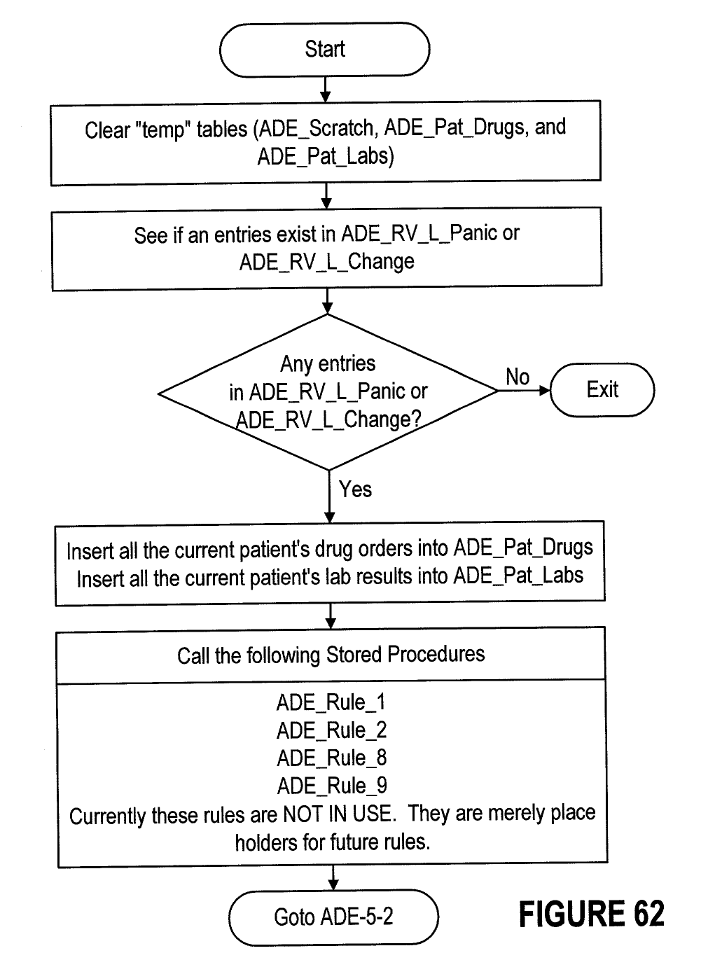

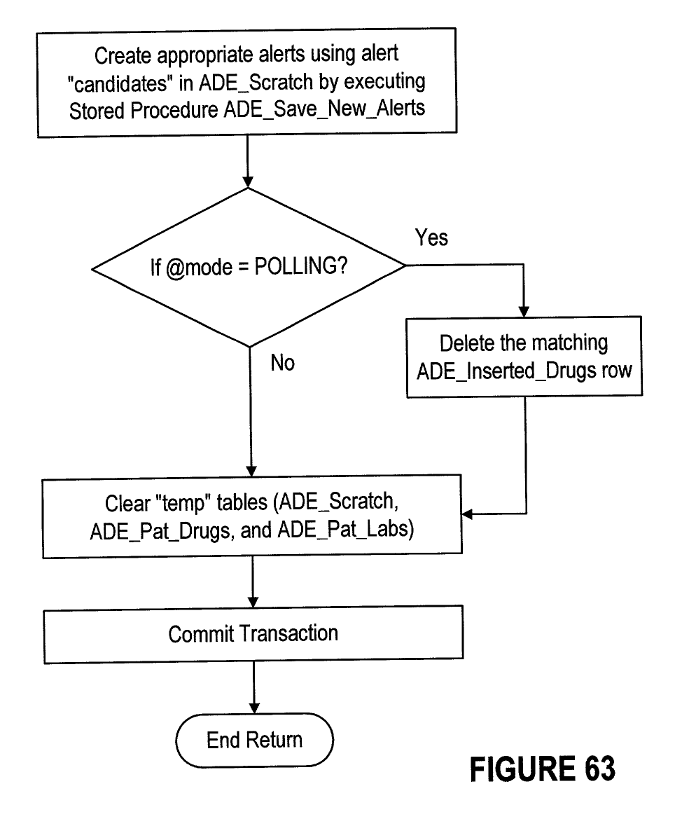

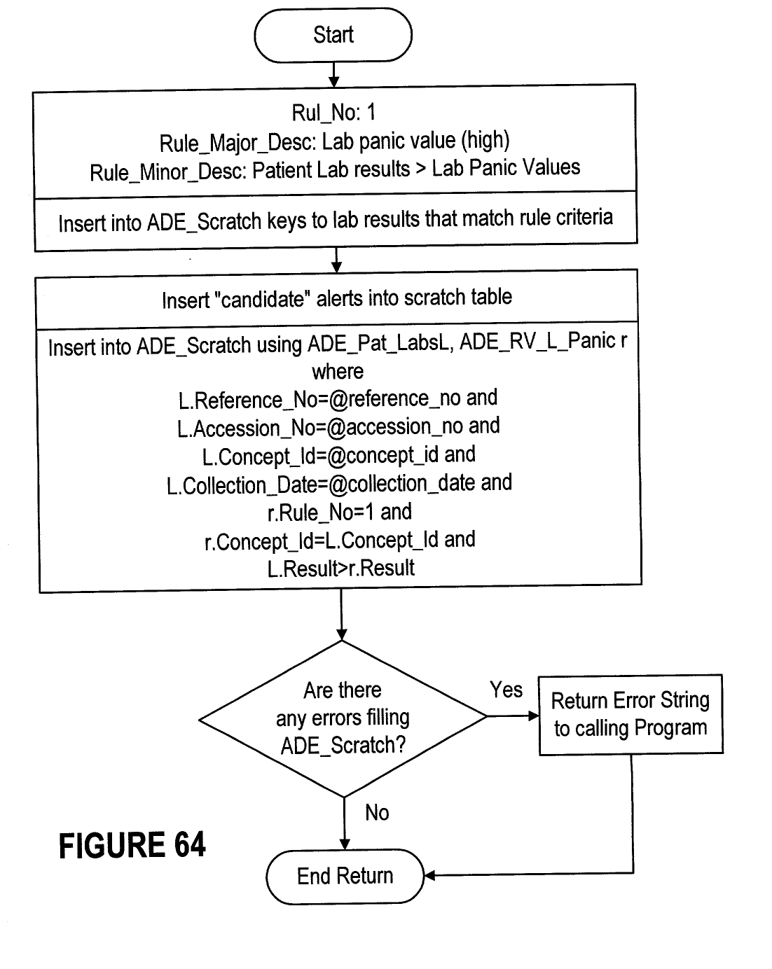

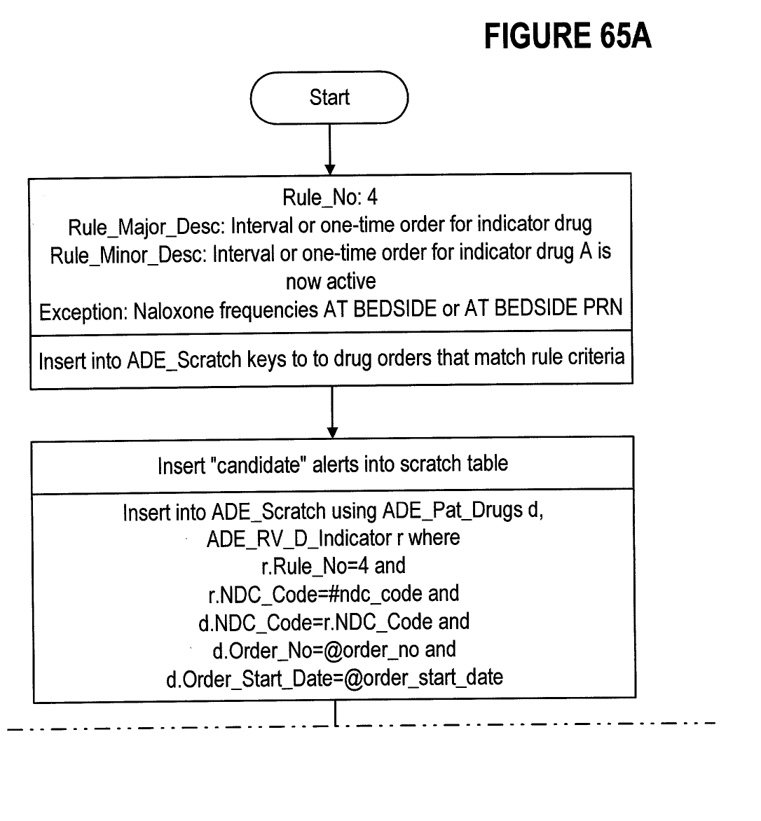

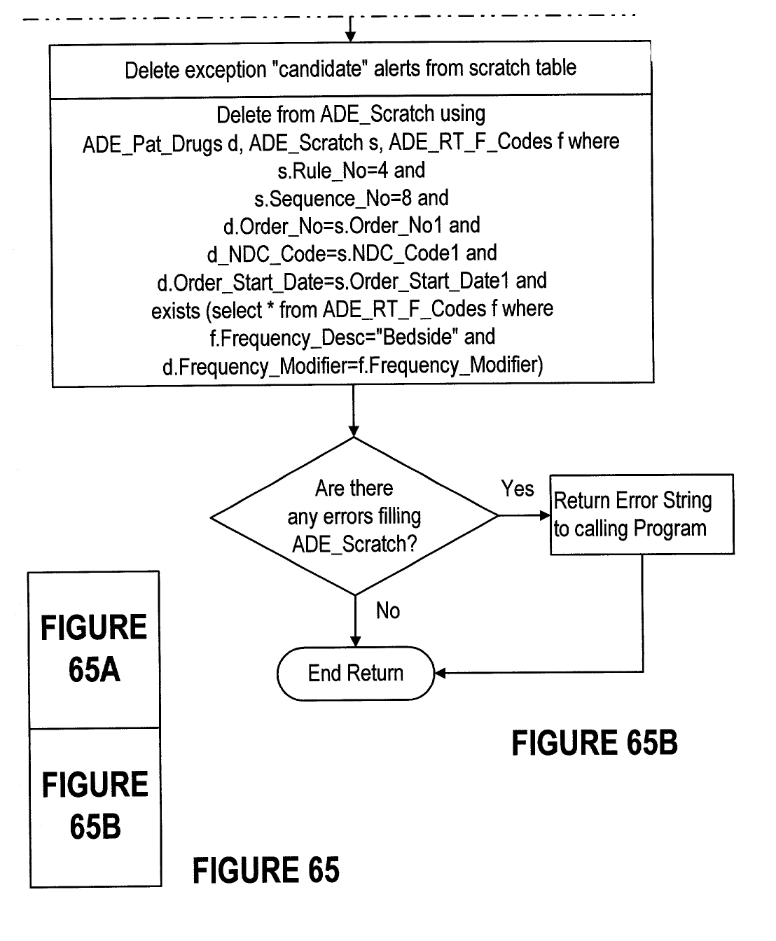

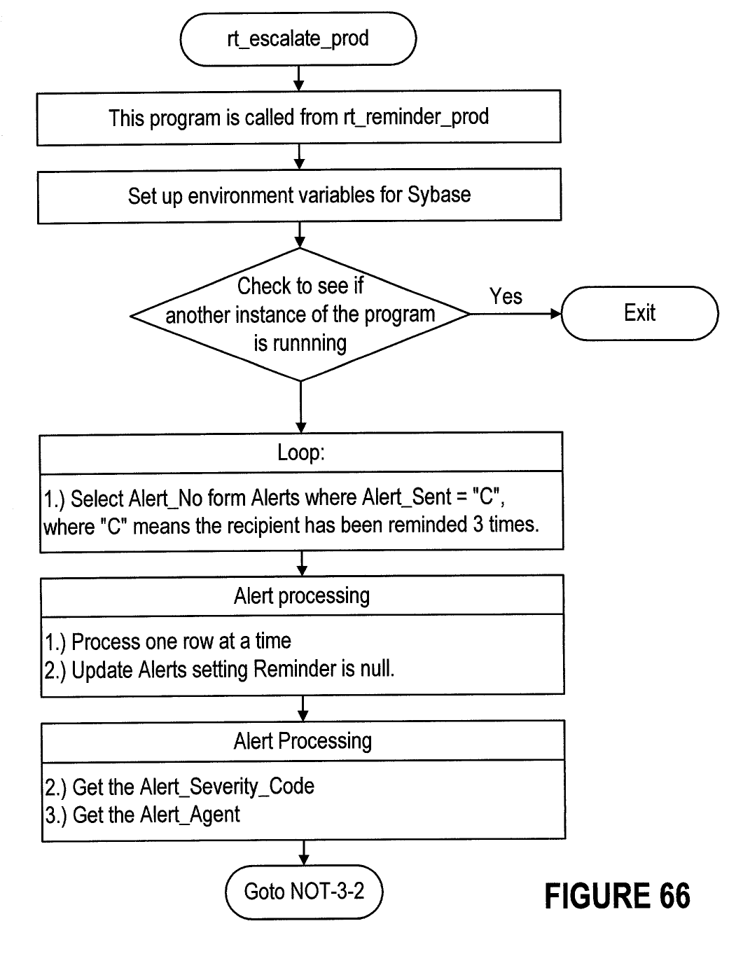

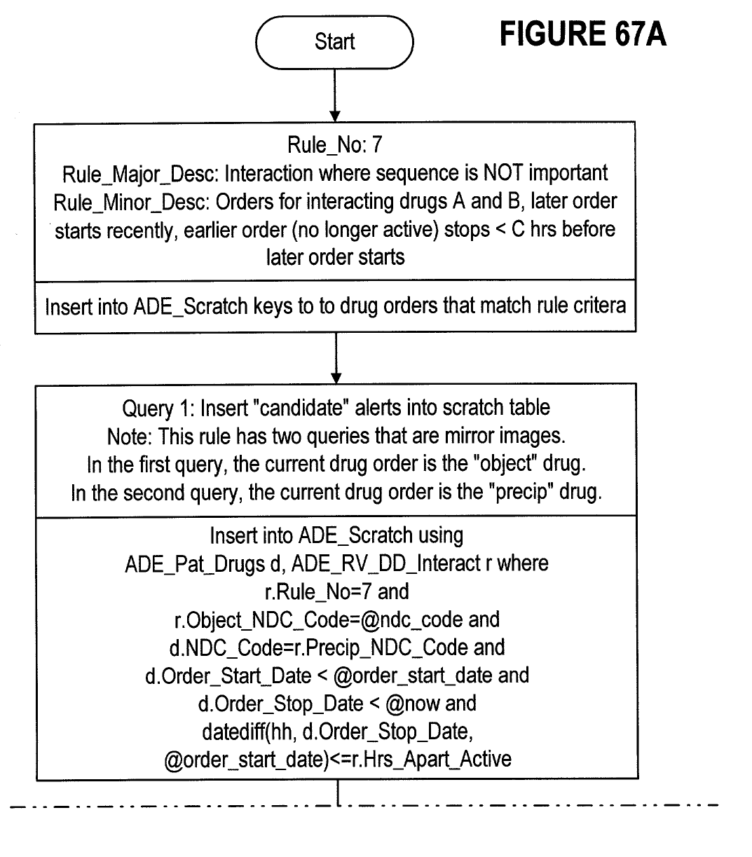

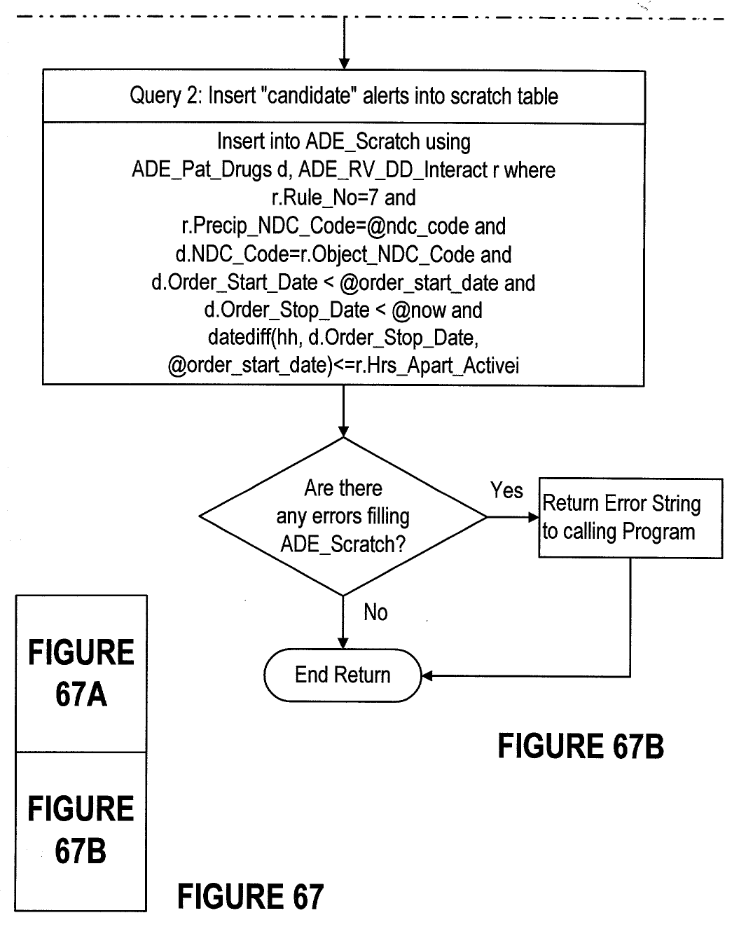

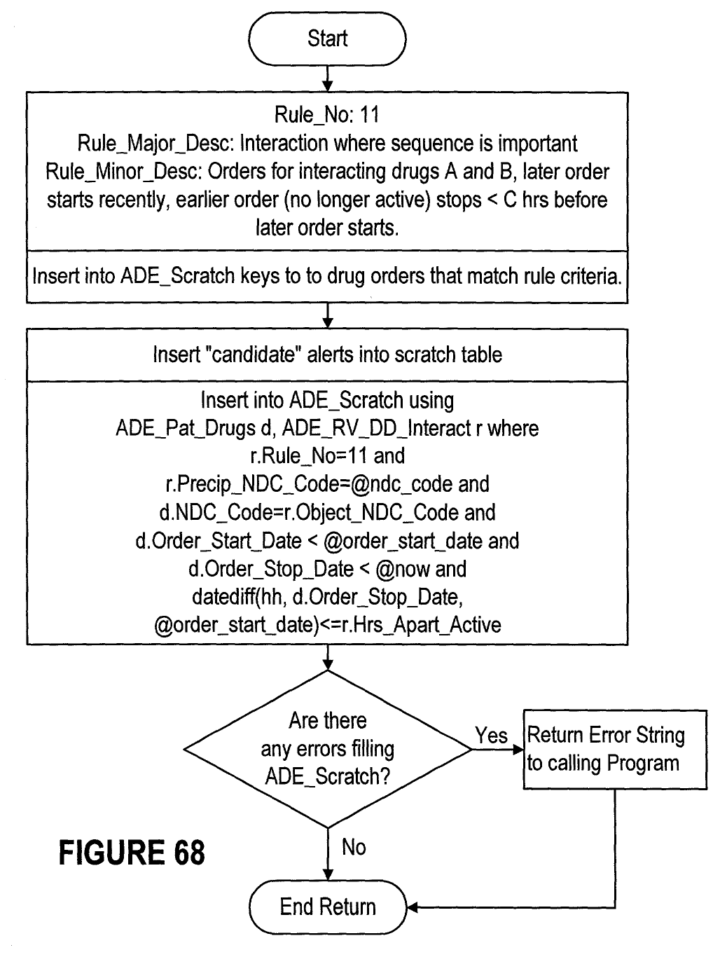

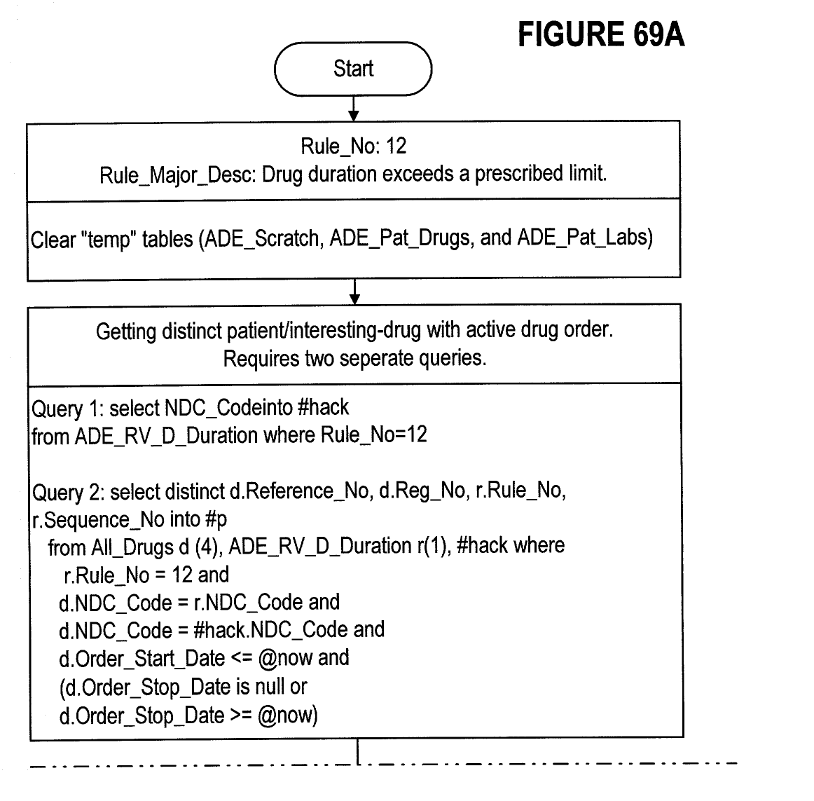

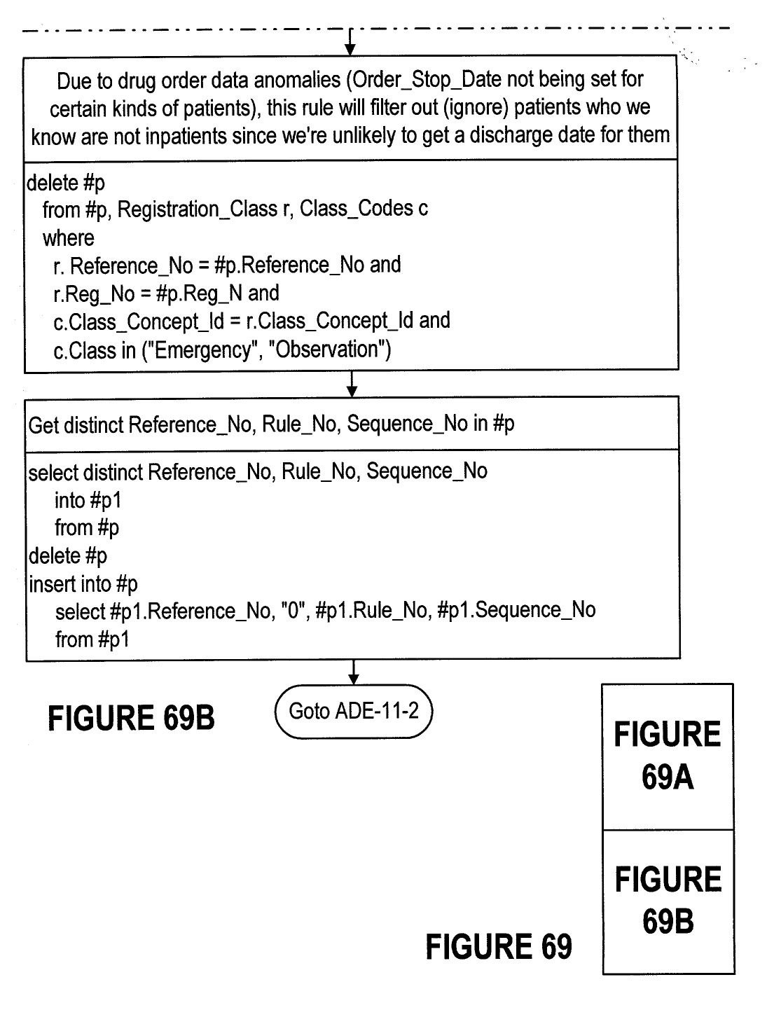

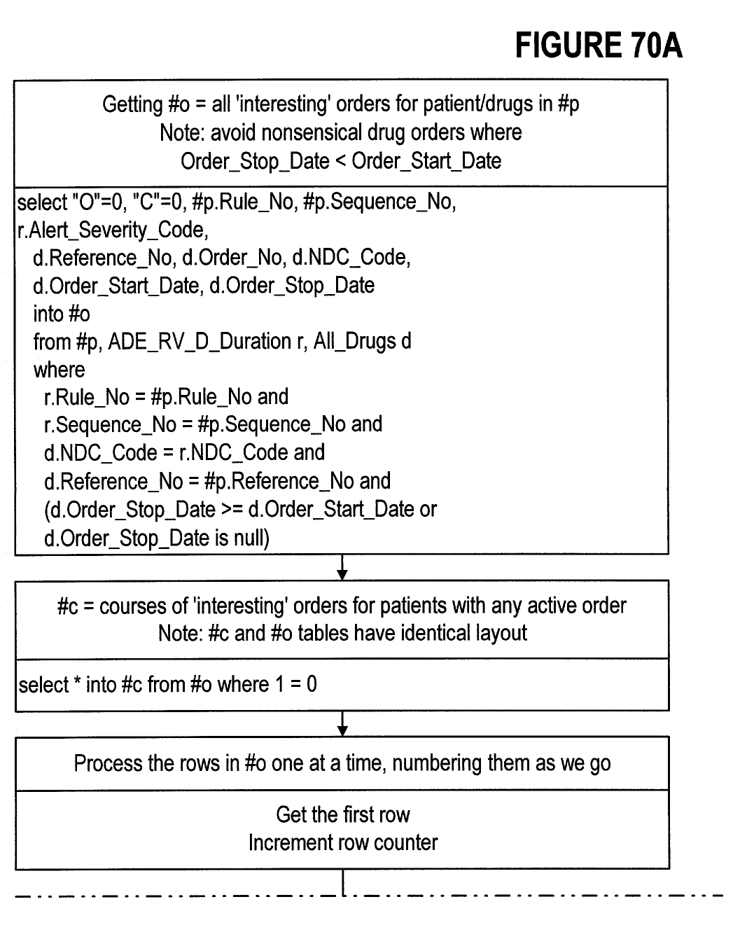

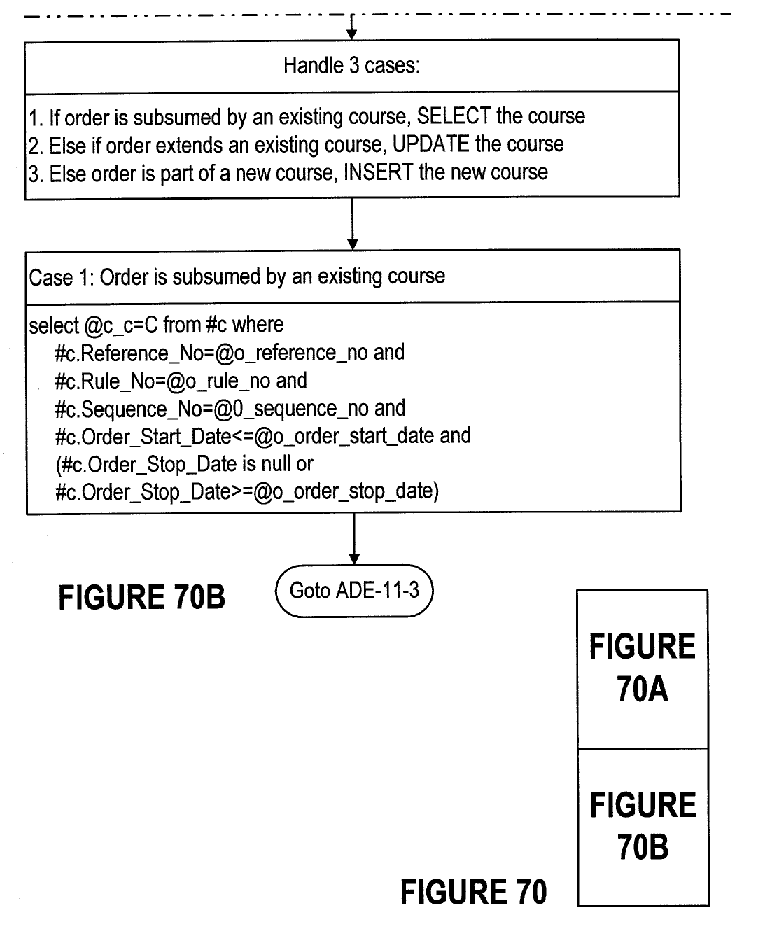

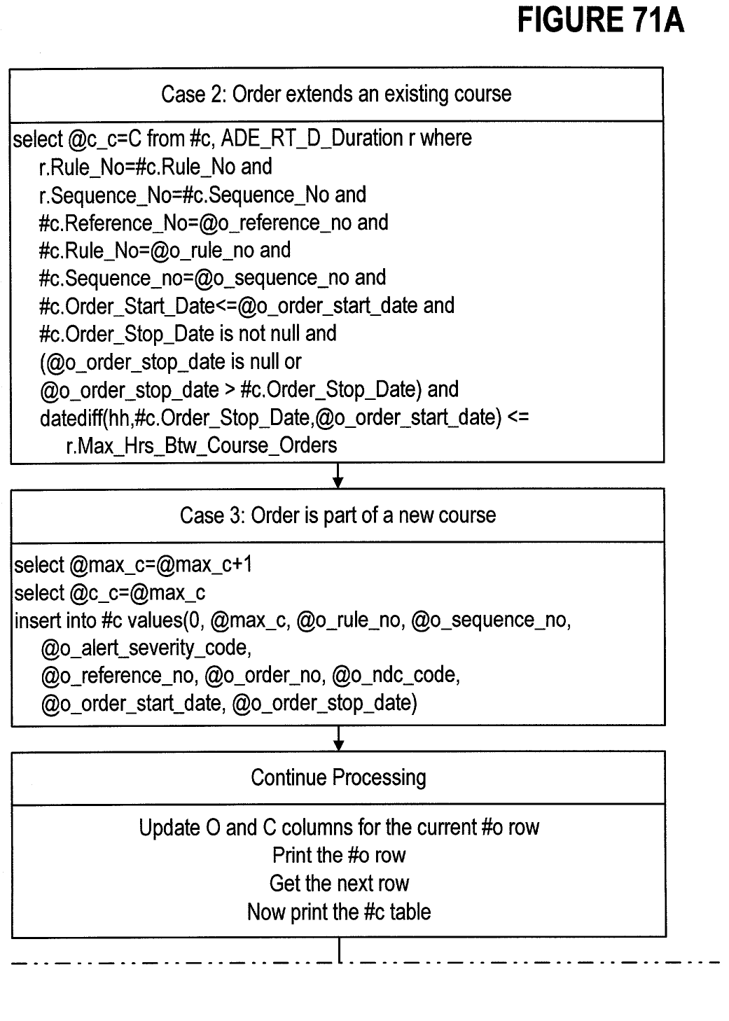

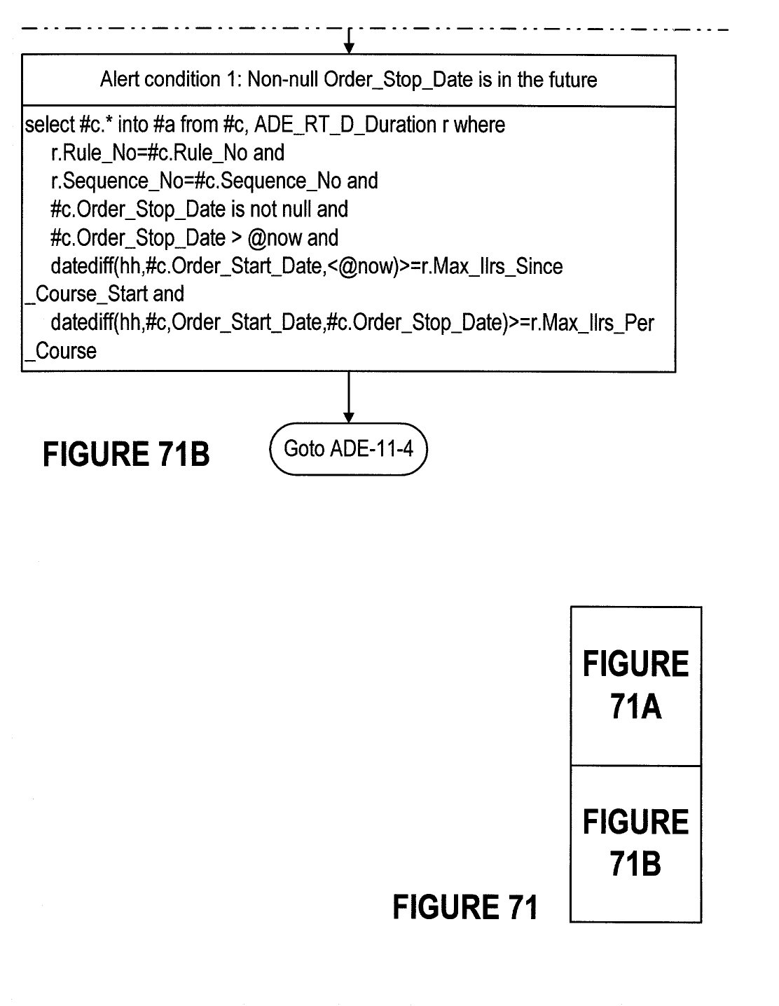

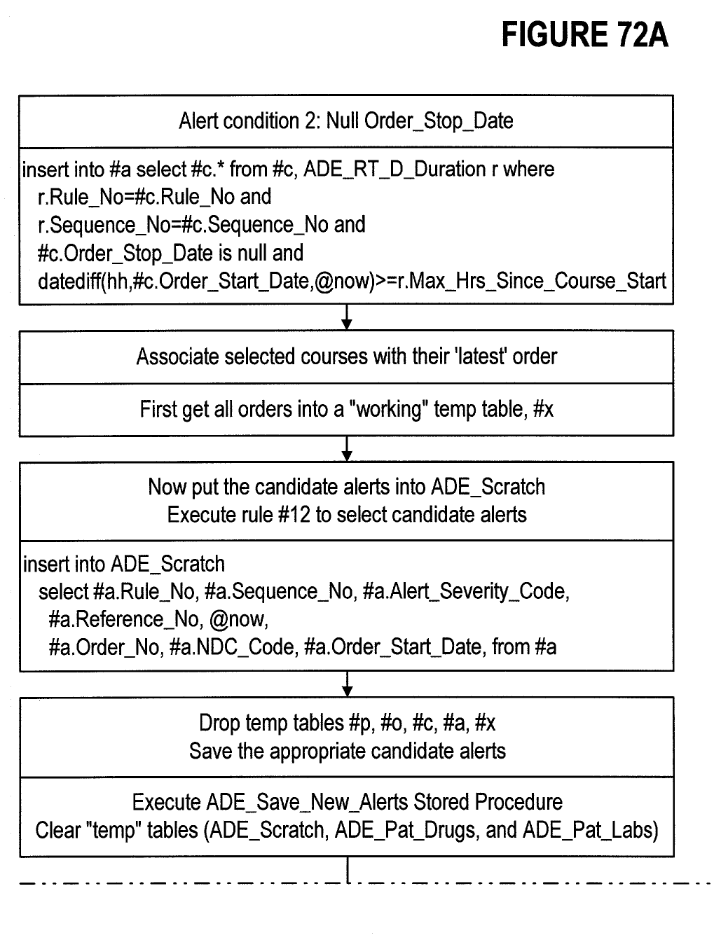

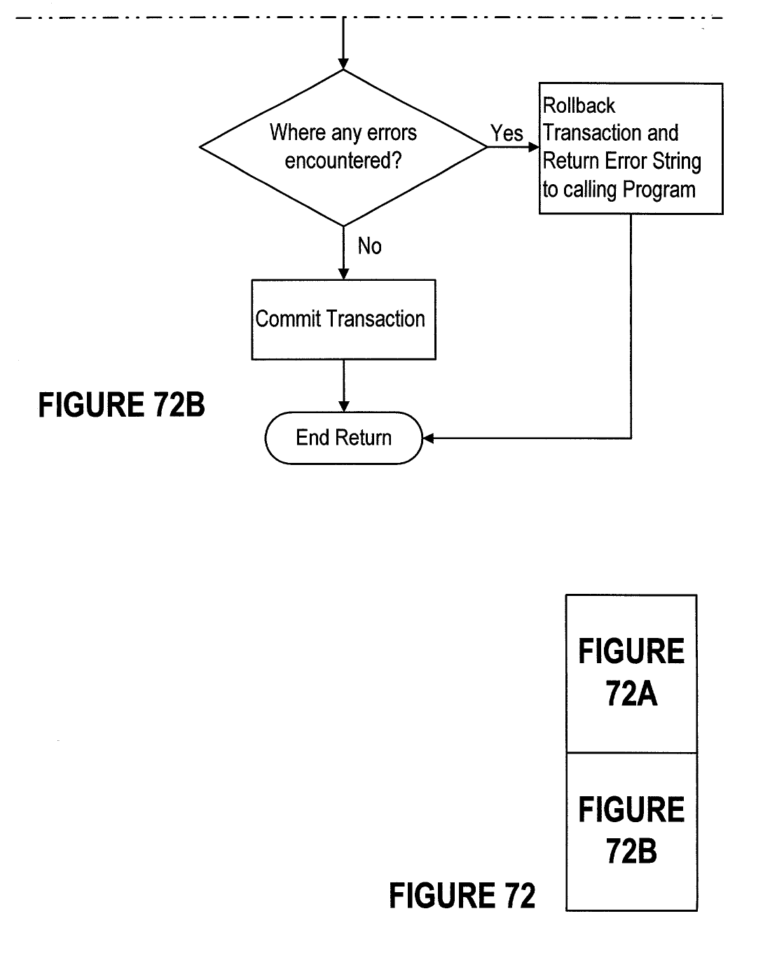

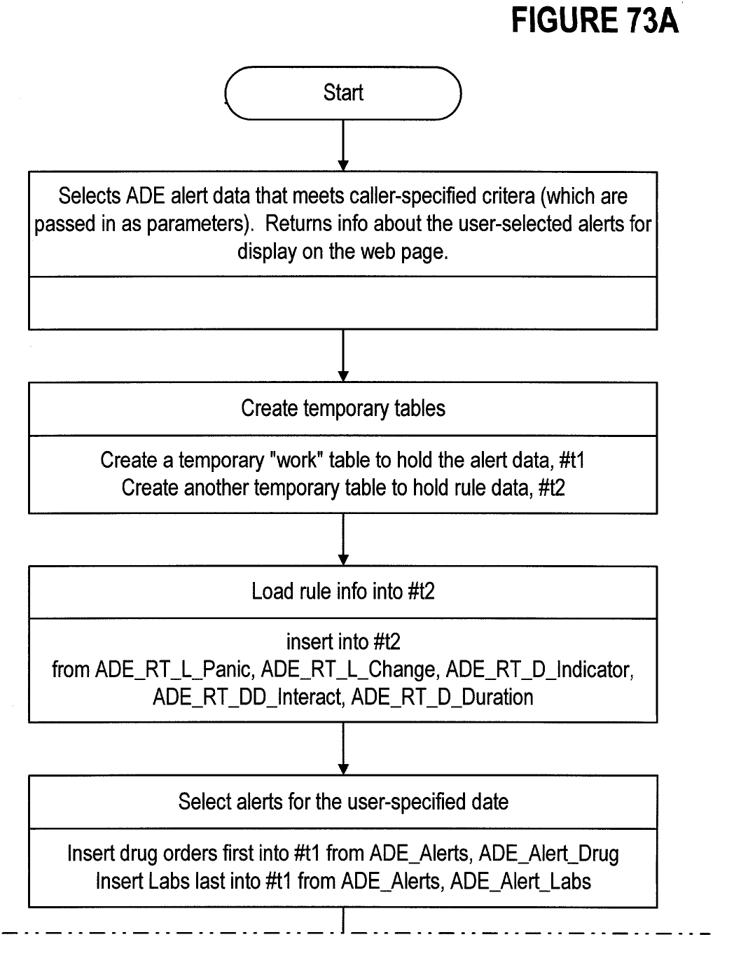

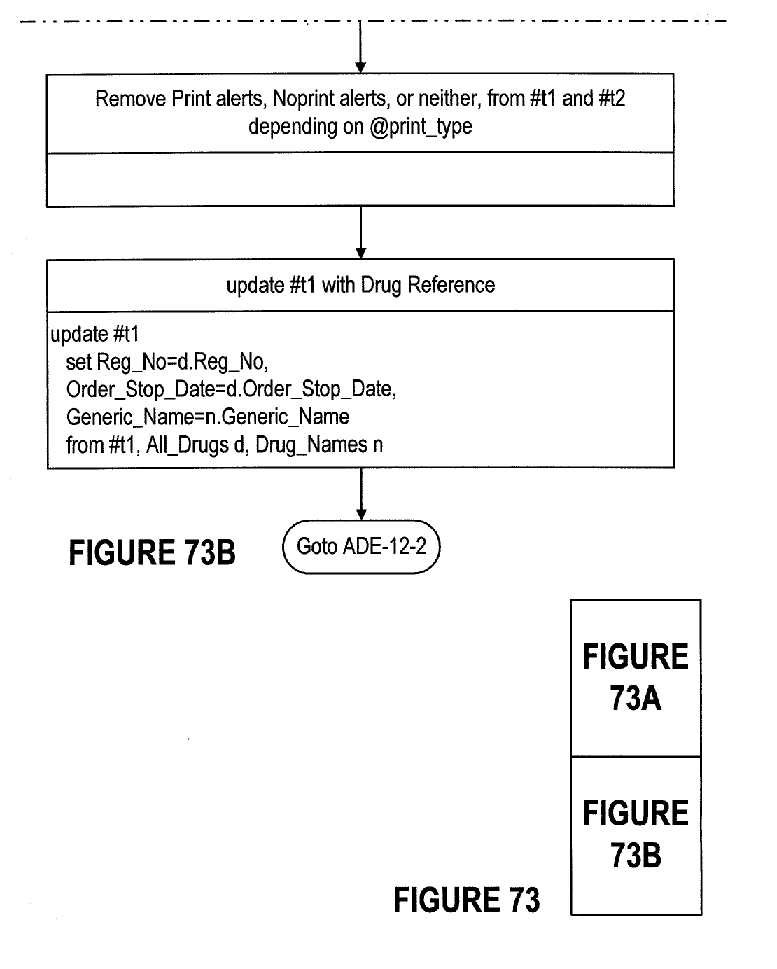

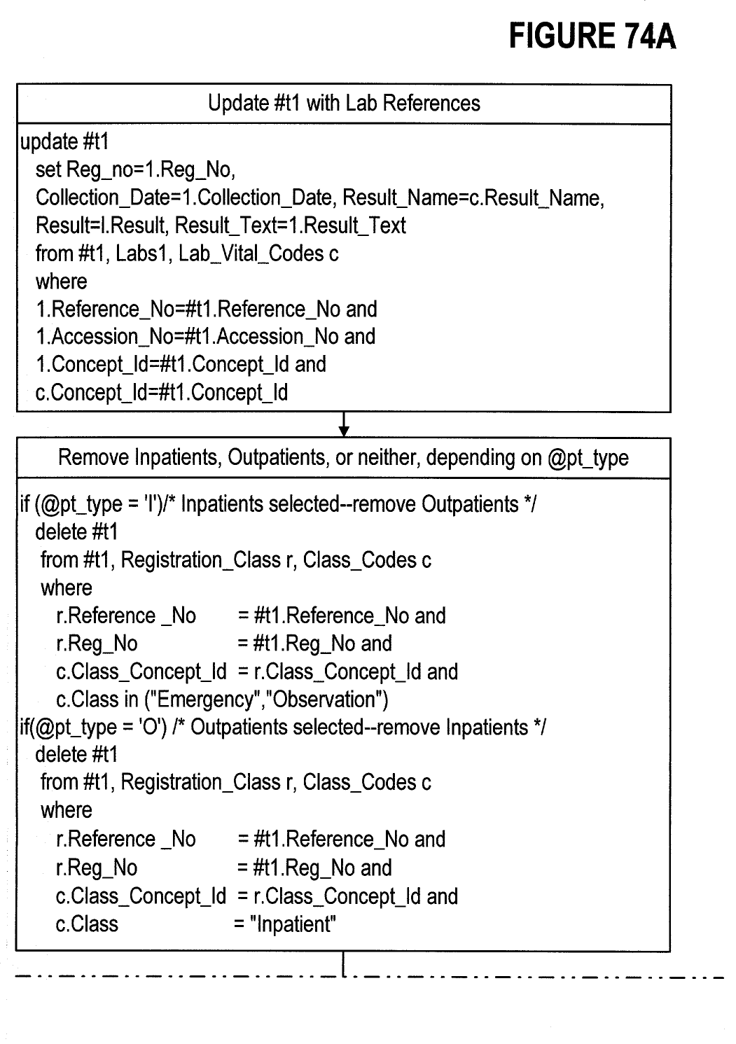

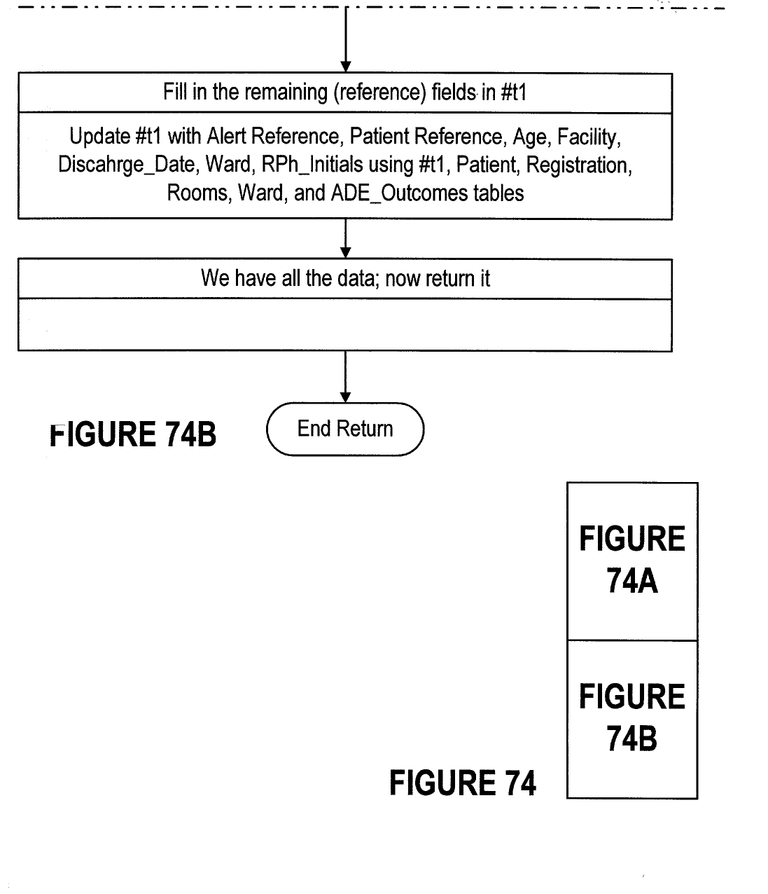

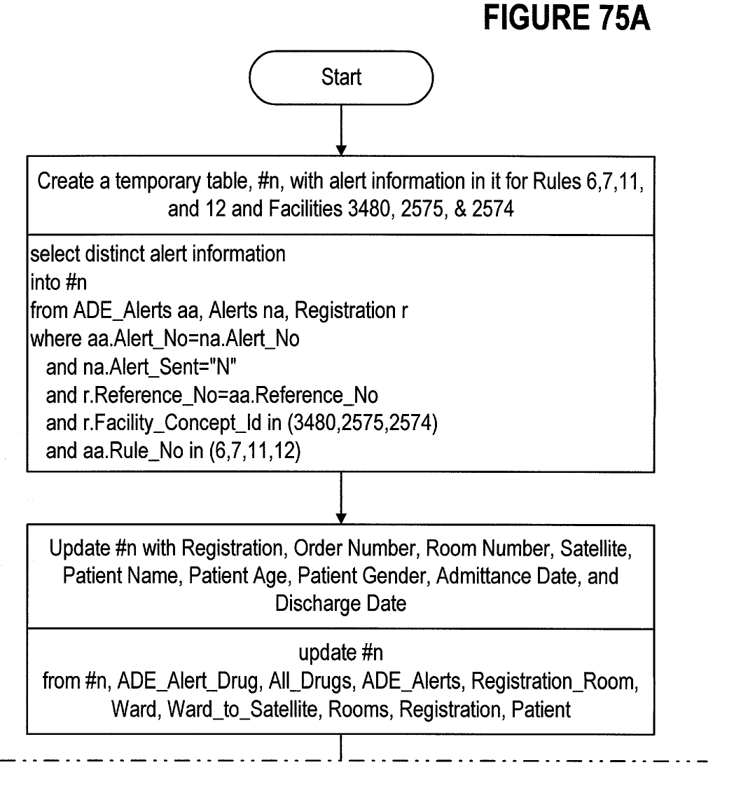

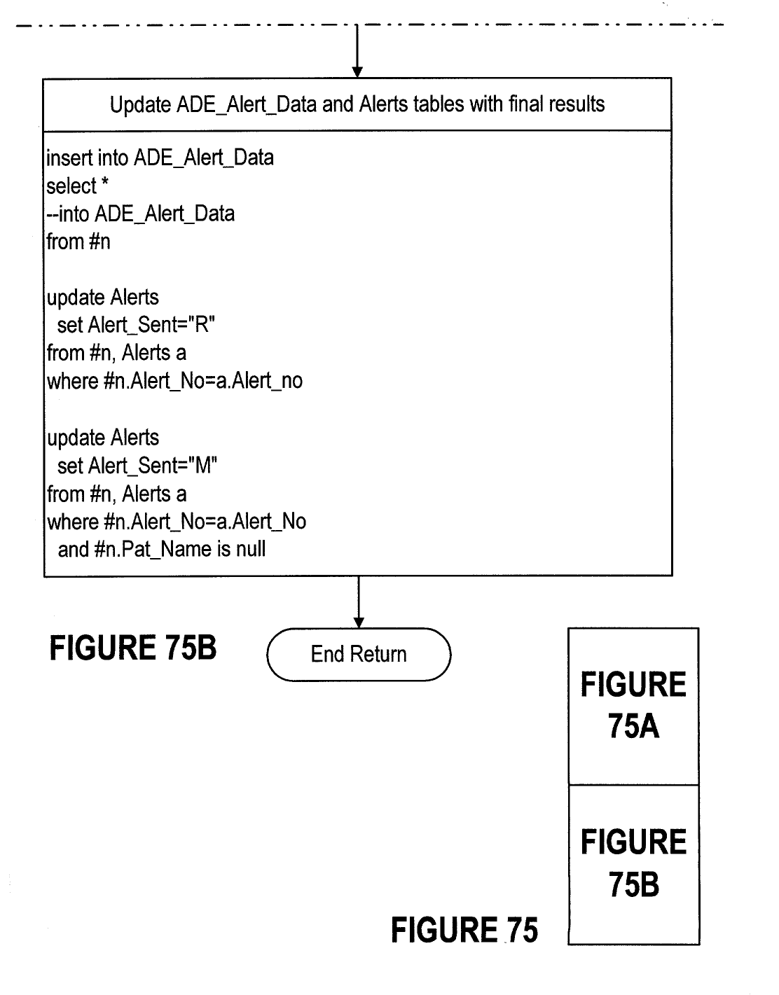

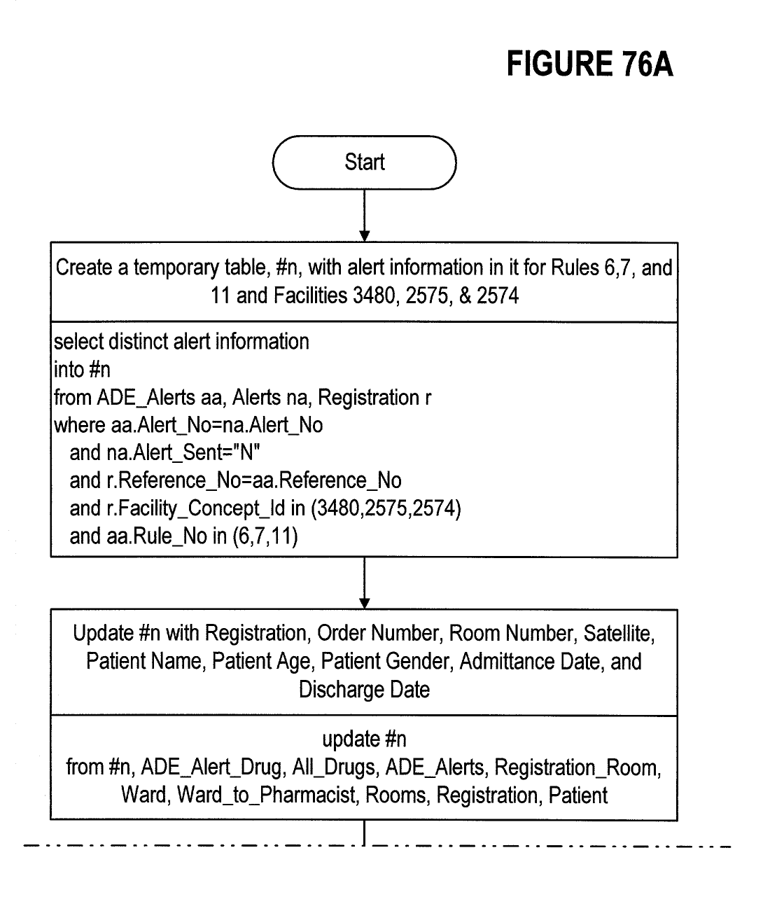

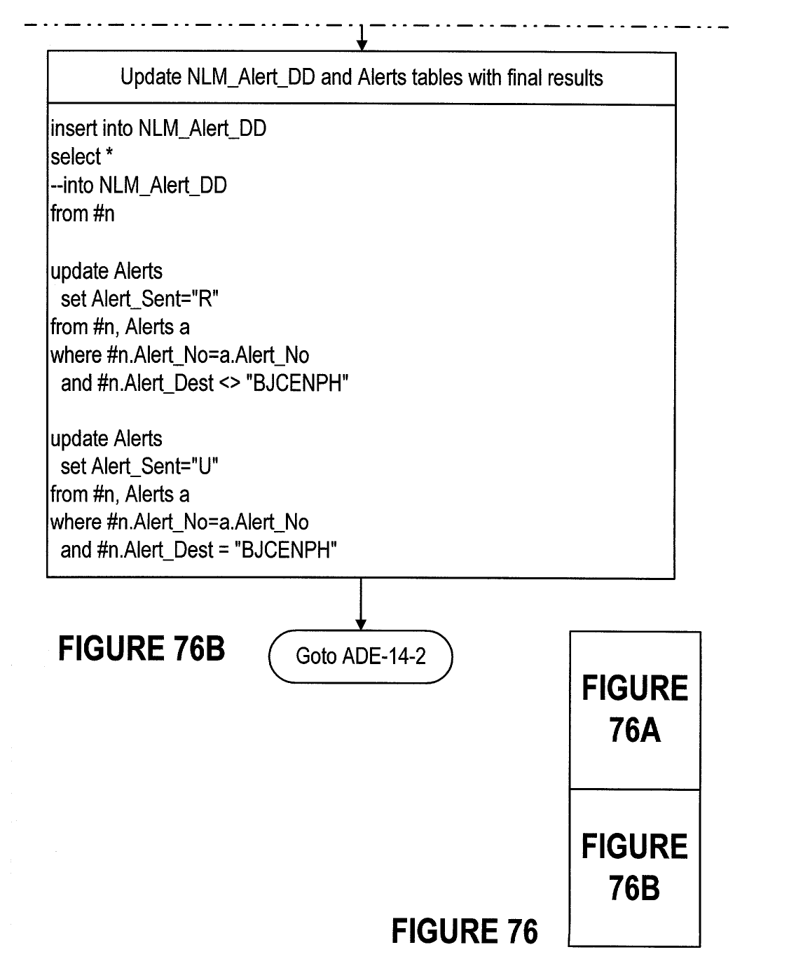

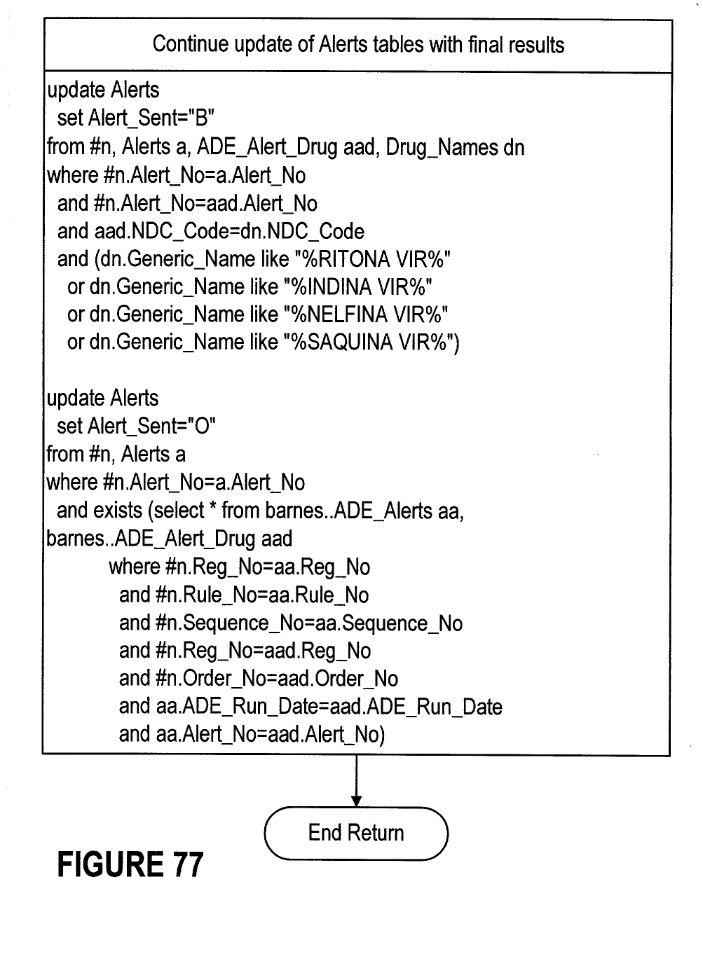

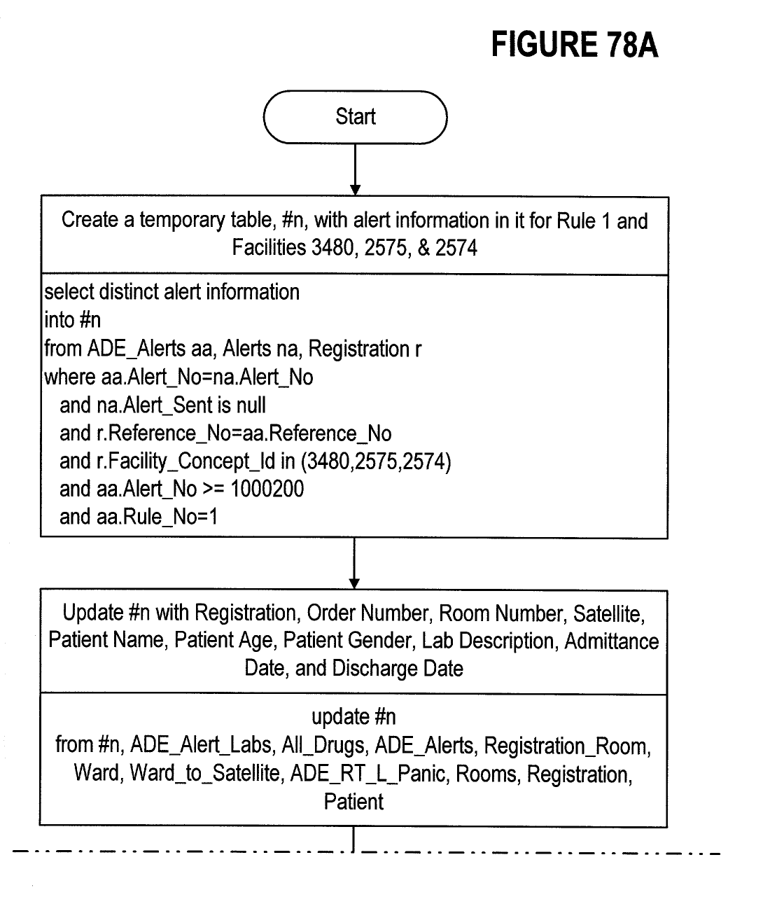

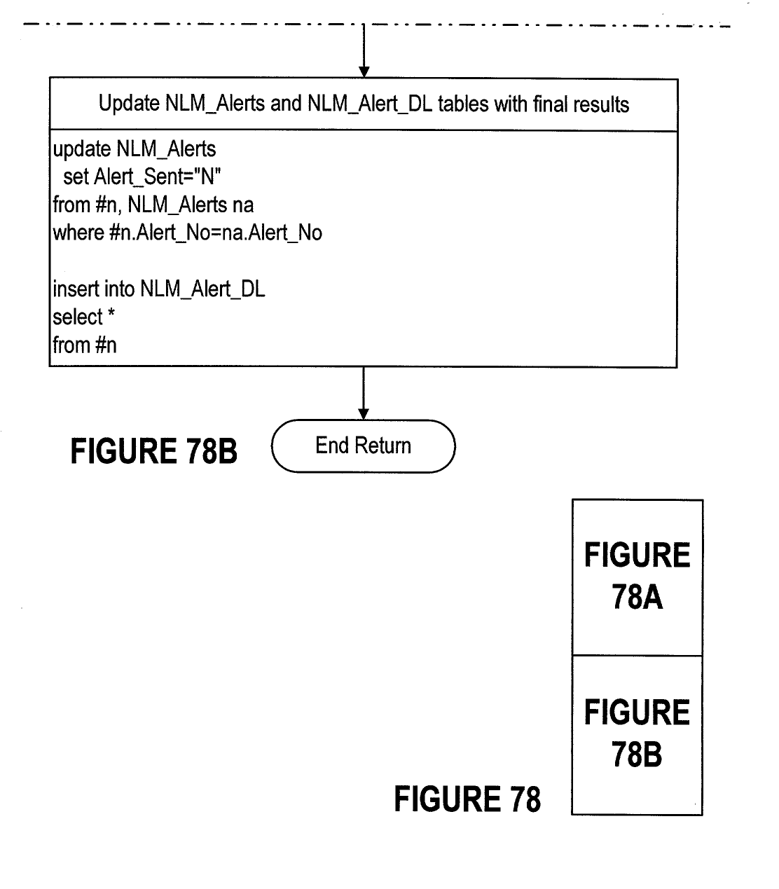

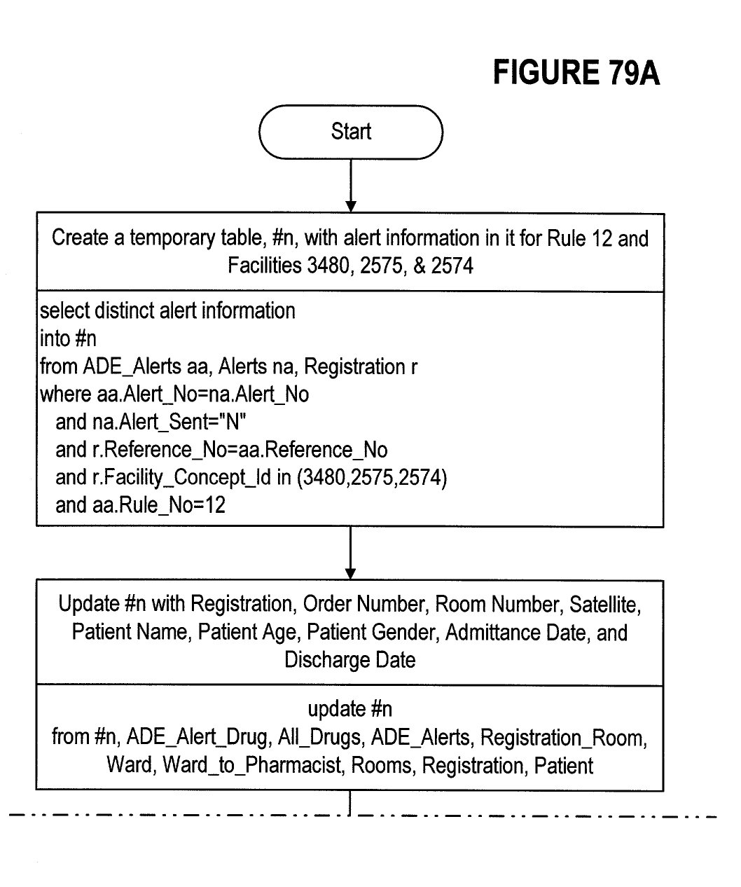

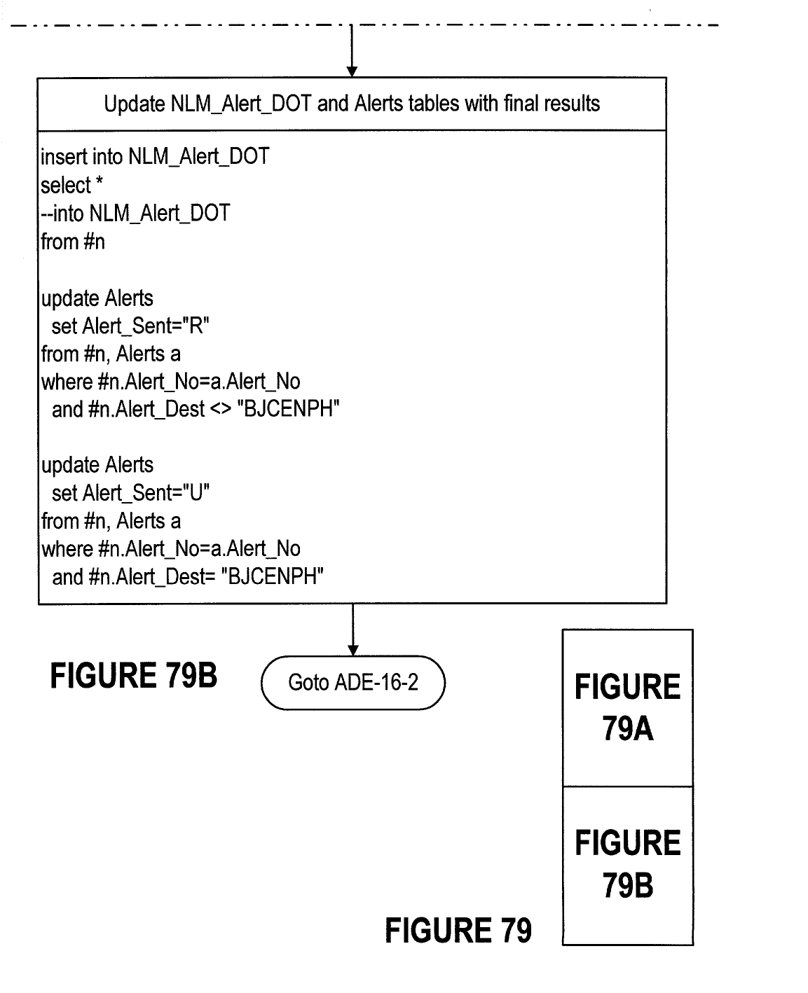

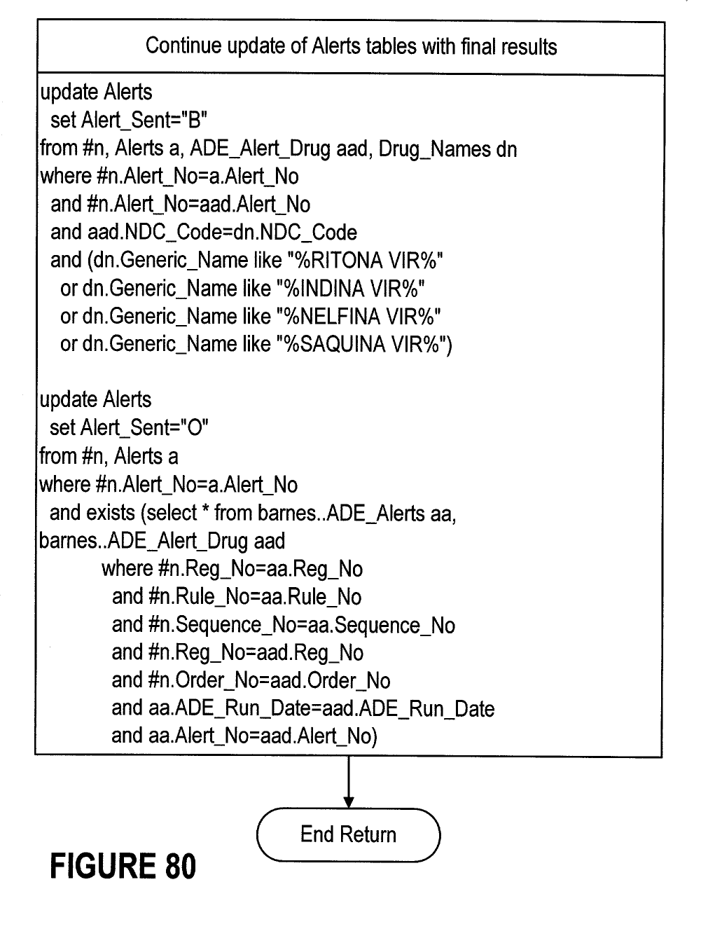

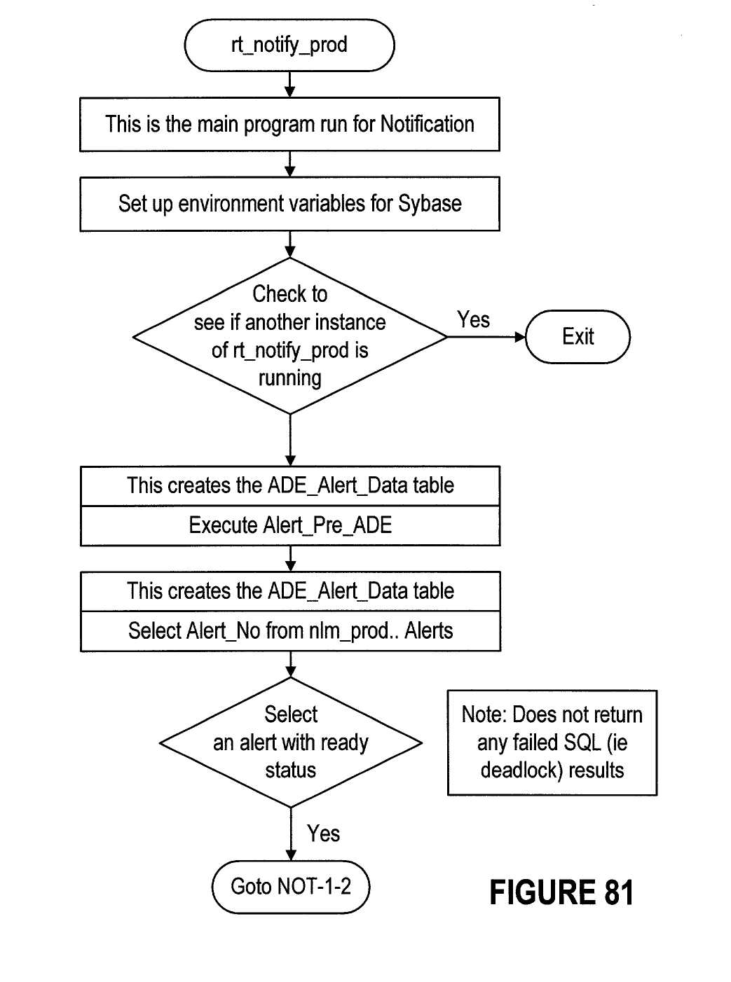

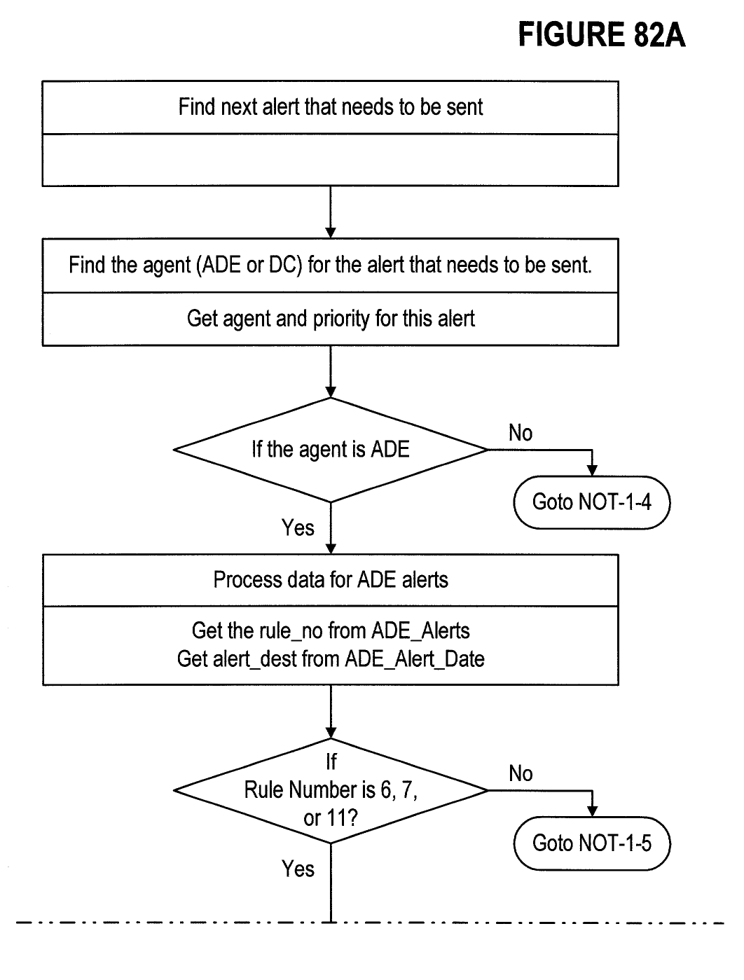

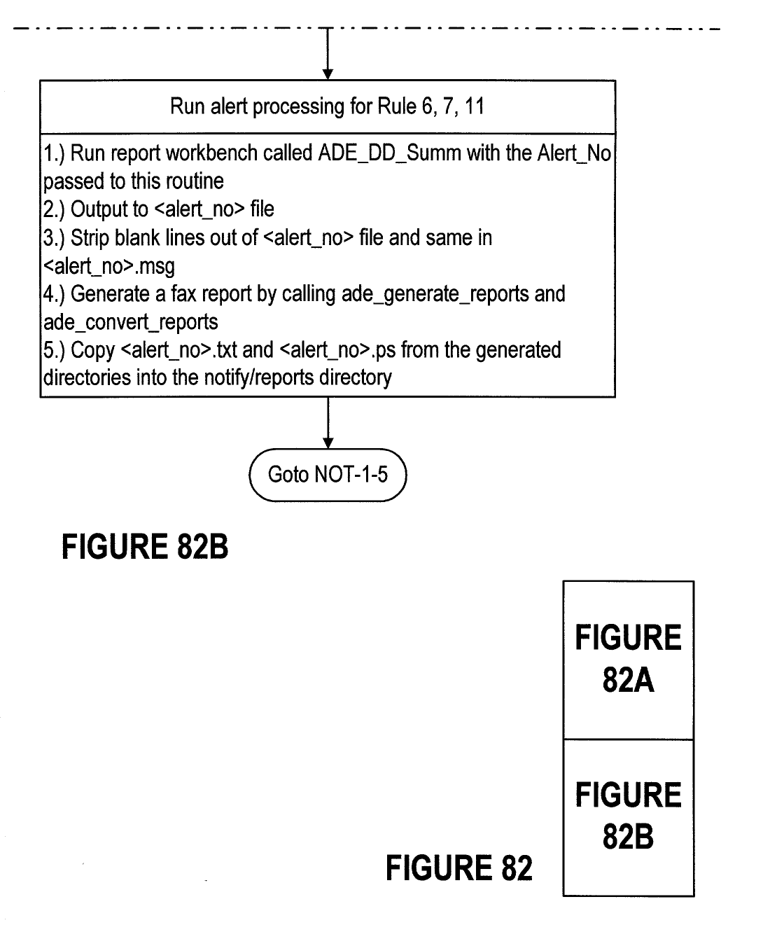

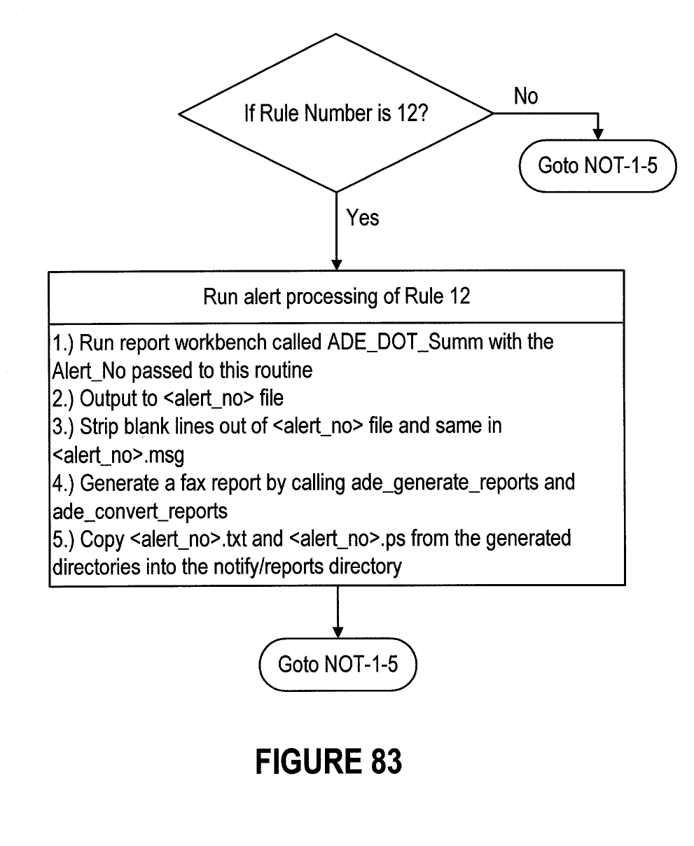

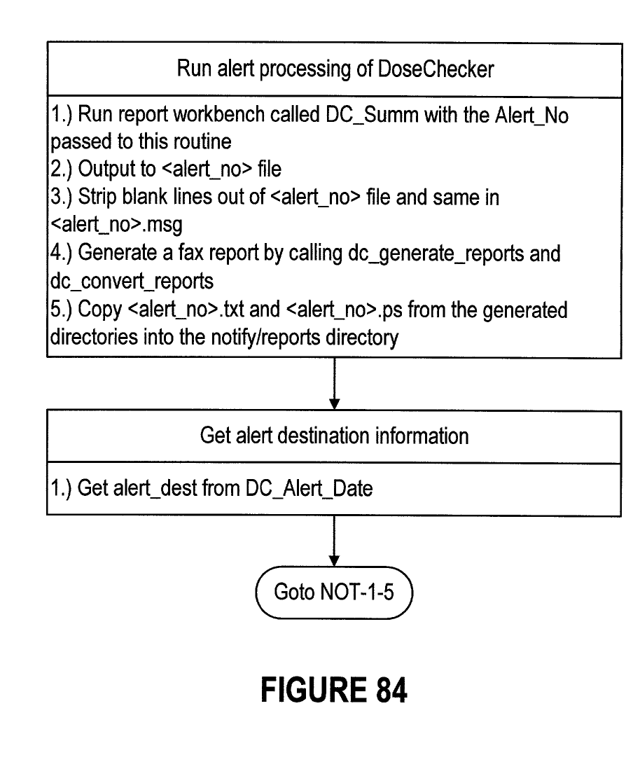

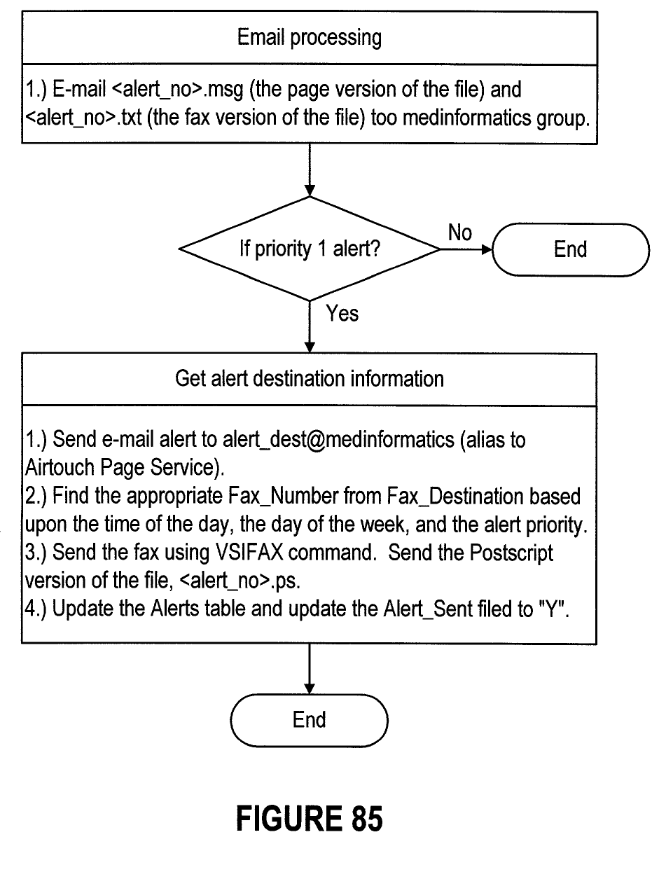

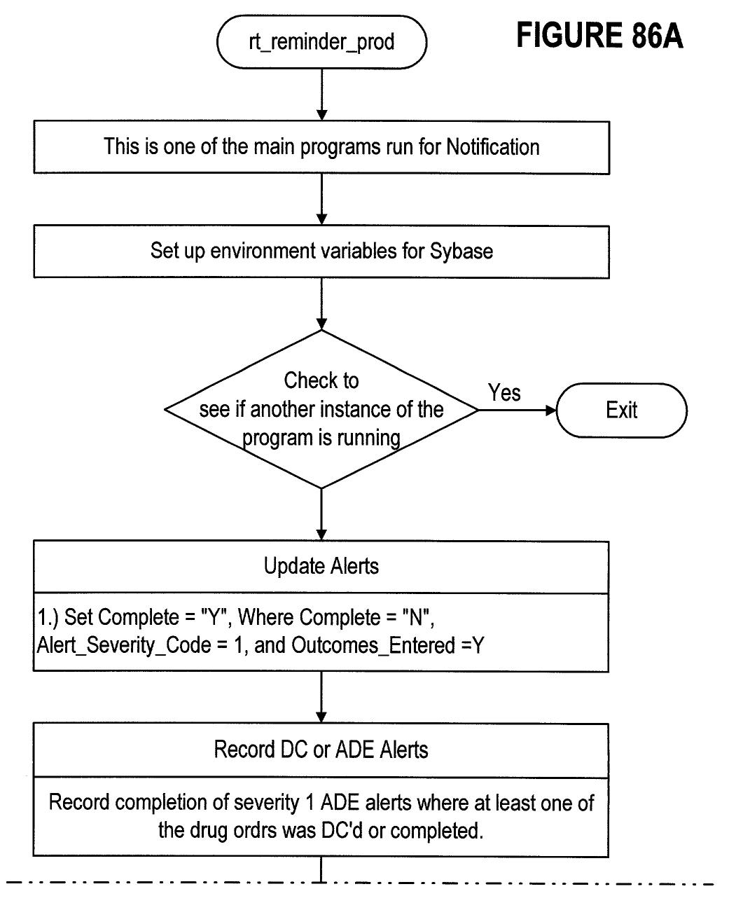

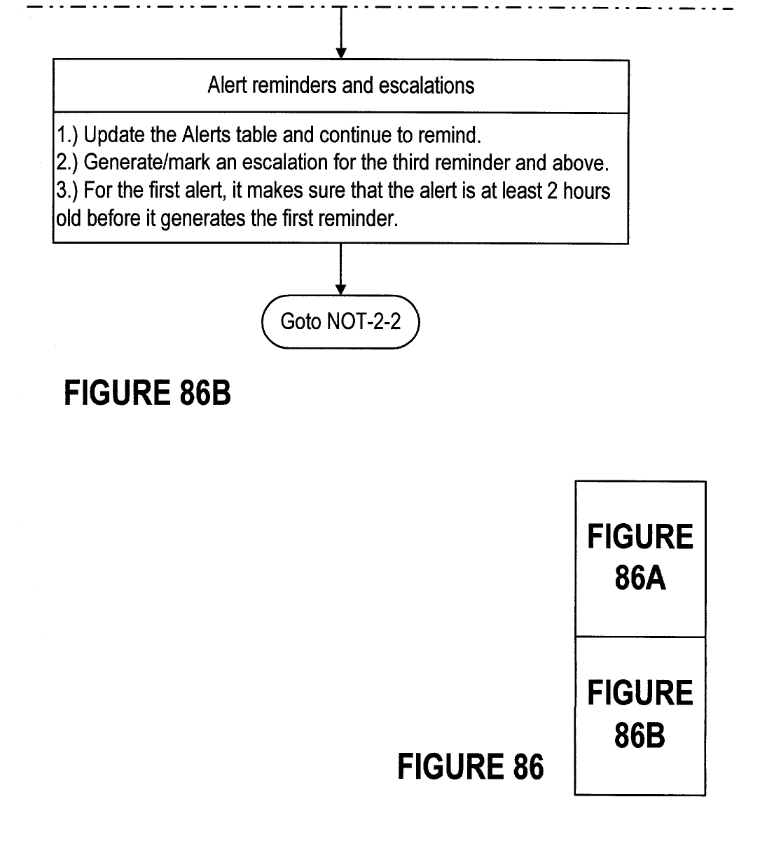

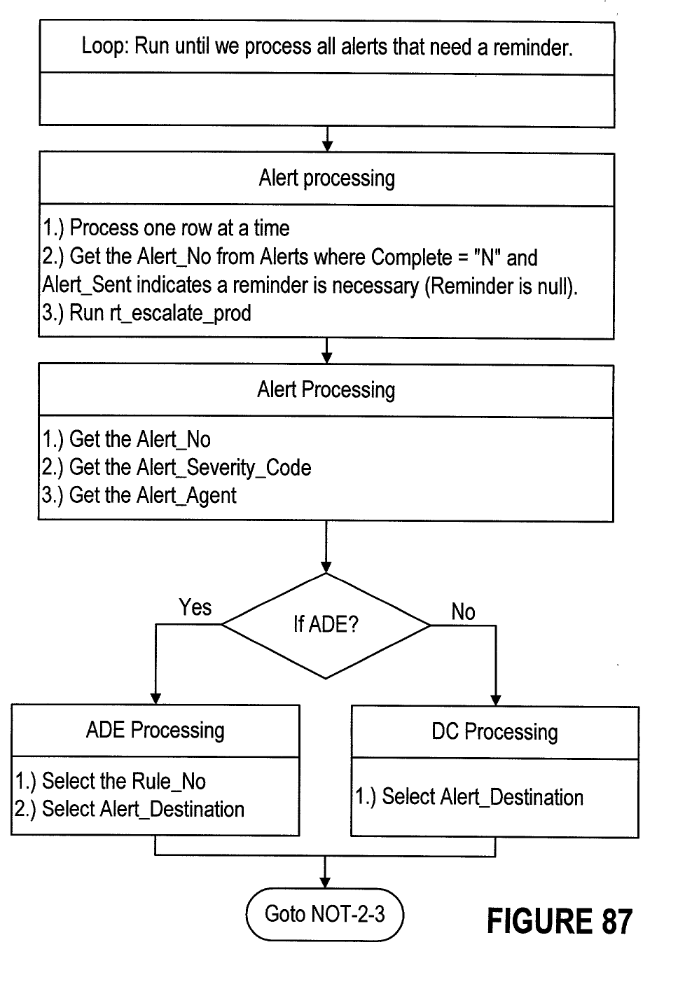

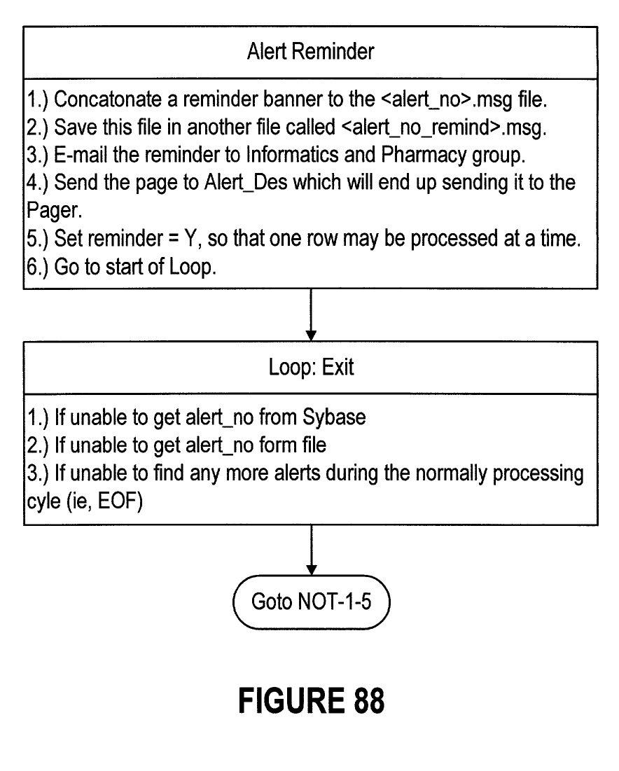

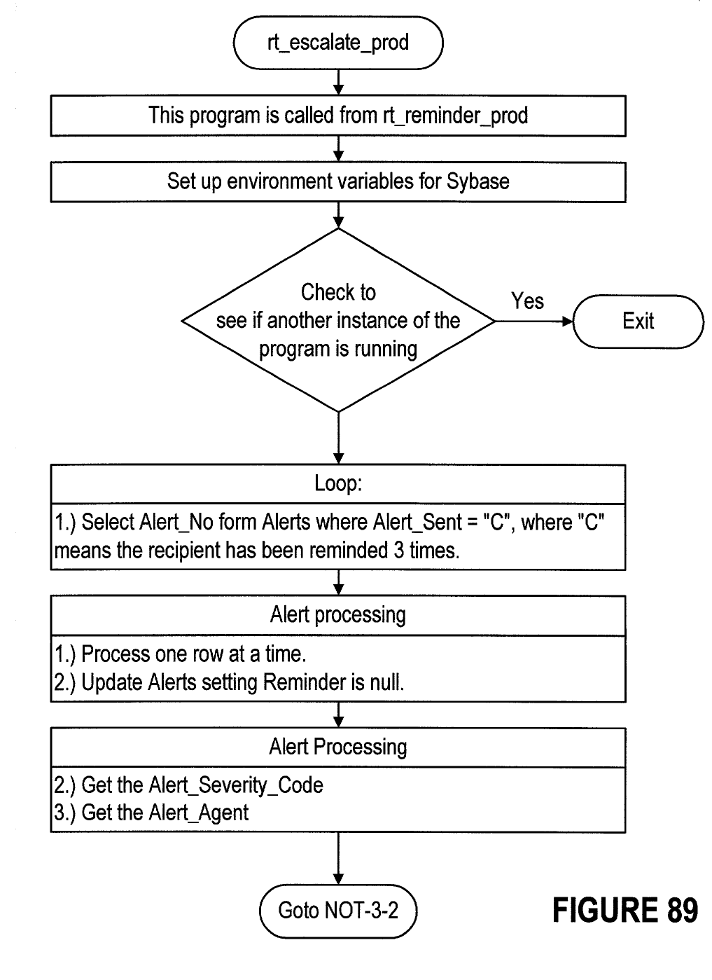

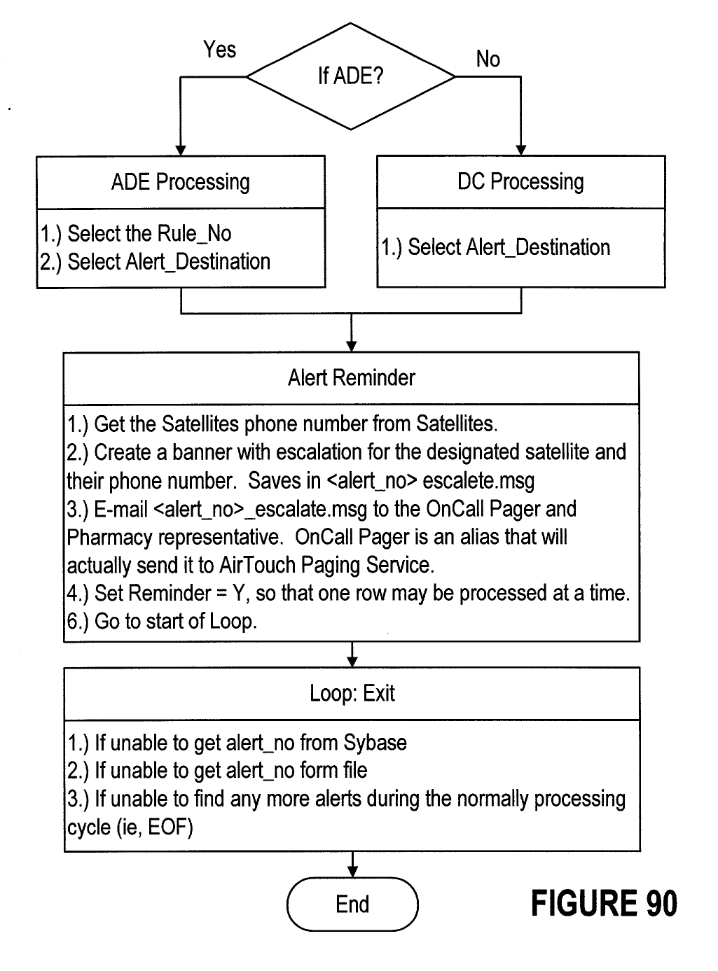

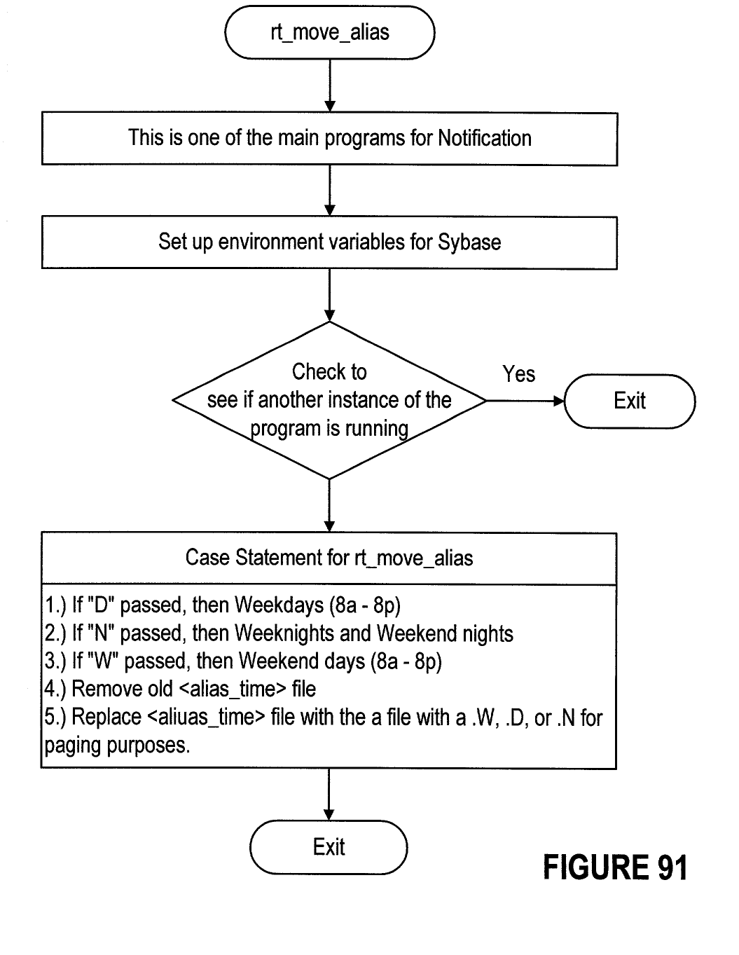

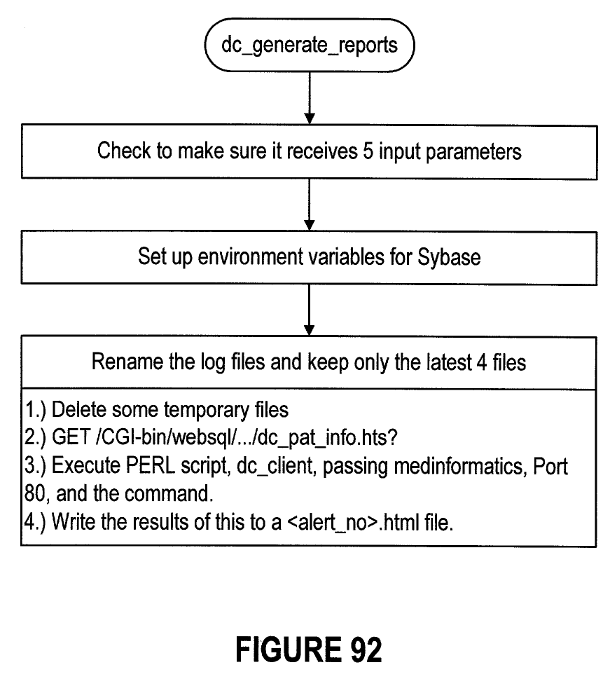

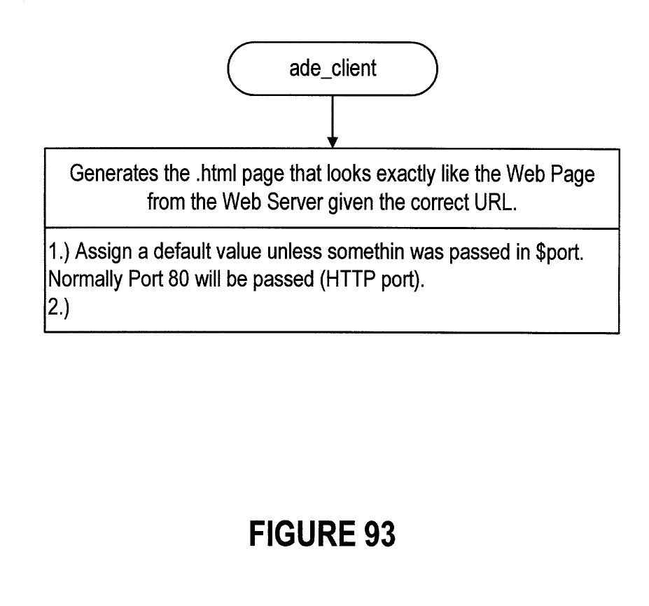

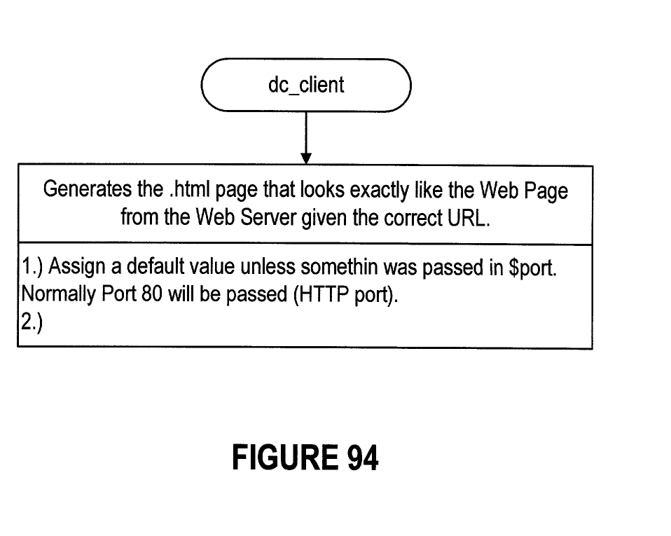

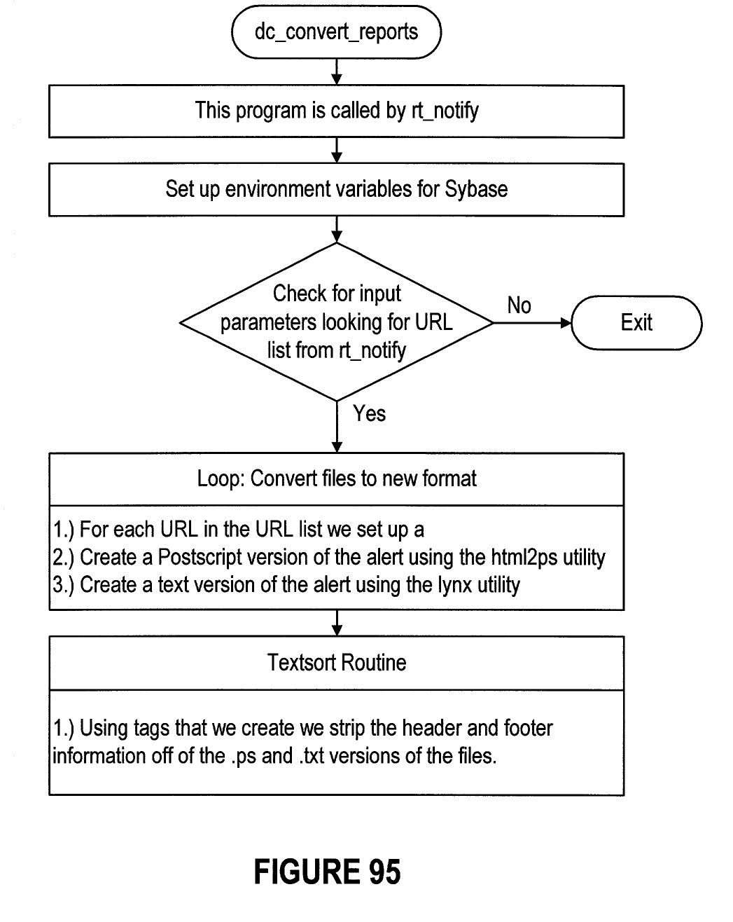

Alert manager 114 formats a dosage alert message in step 2010 by presenting the various information of the alert message in a readable manner, including the patient's name and location, the drug order to which the dosage alert pertains, and the recommended dosage of the drug order as retrieved from recommendations 306 (FIG. 3). FIG. 25 shows a screen view of a dosage alert in HTML format. FIG. 26 shows a more detailed report of a dosage alert available to the clinician receiving the alert.

After either step 2008 or step 2010, alert manager 114 (FIG. 1) sends the formatted alert message to a designated clinician by electronic mail (e-mail). In this illustrative embodiment, the designated clinician is a pharmacist. Pharmacists are particularly capable of assessing the risks involved with alerted drug orders. If the pharmacist determines that the dosing error or the ADE risk associated with interacting drug orders possesses a serious risk to the patient, the pharmacist consults with the physician caring for the particular patient and the pharmacist and physician together arrive at a course of treatment. Alert manager 114 determines to which clinician to send the e-mail according to scheduled contact information. Such scheduled contact information specified which clinicians are to receive ADE and dosage alerts during which times of the day for each day of the week. The scheduled contact information can be modified as work schedules change for various clinicians. The particular clinician to whom alert messages are to be directed according to the scheduled contact information is sometimes referred to as the designated clinician.

In test step 2014, alert manager 114 determines whether the subject alert message has urgent priority. If so, alert manager 114 sends the alert message through various channels in an attempt to capture the attention of the designated clinician. For example, in this illustrative embodiment, alert manager 114 sends the formatted subject alert message to an alphanumeric pager, a printer, and a fax machine. Each of these devices, along with a network address for reaching the device, is specified in the scheduled contact information. If the subject alert message is not urgent, step 2016 is skipped by alert manager 114.

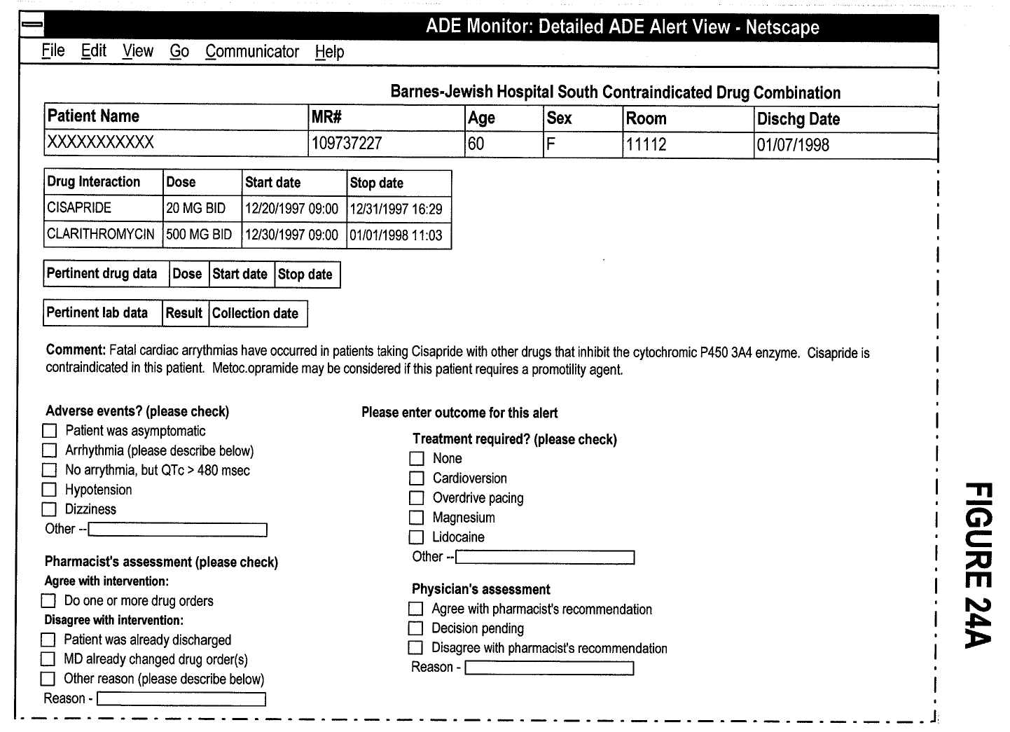

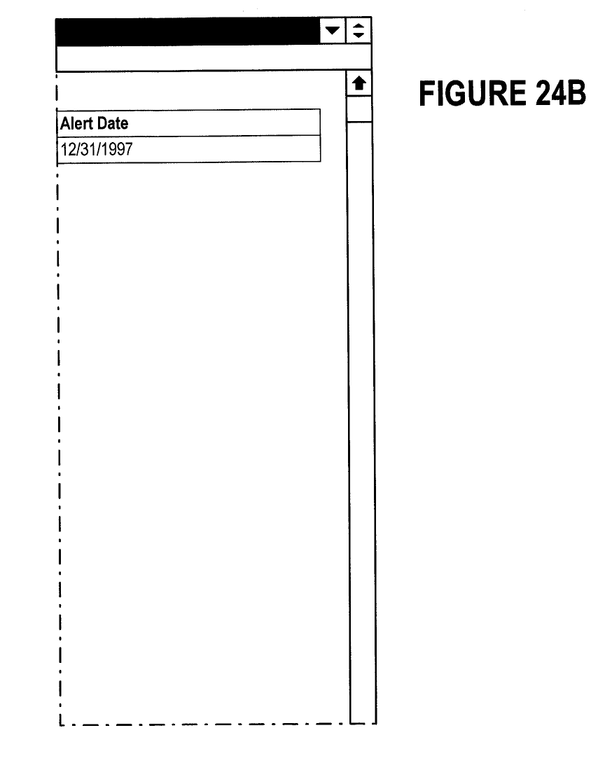

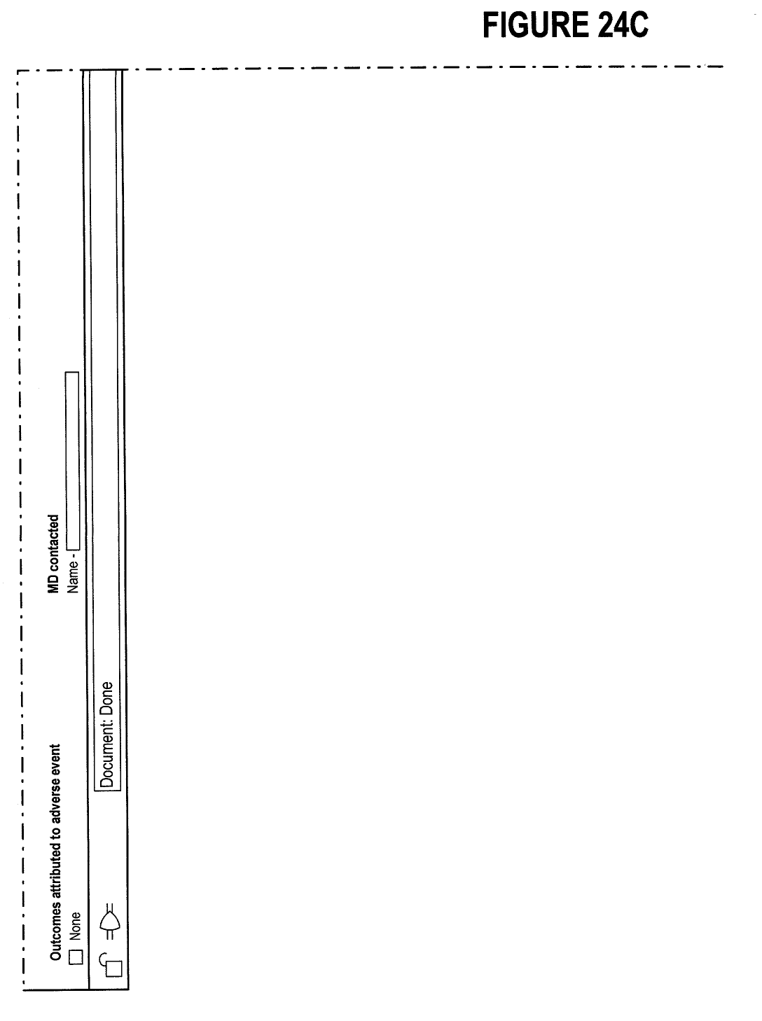

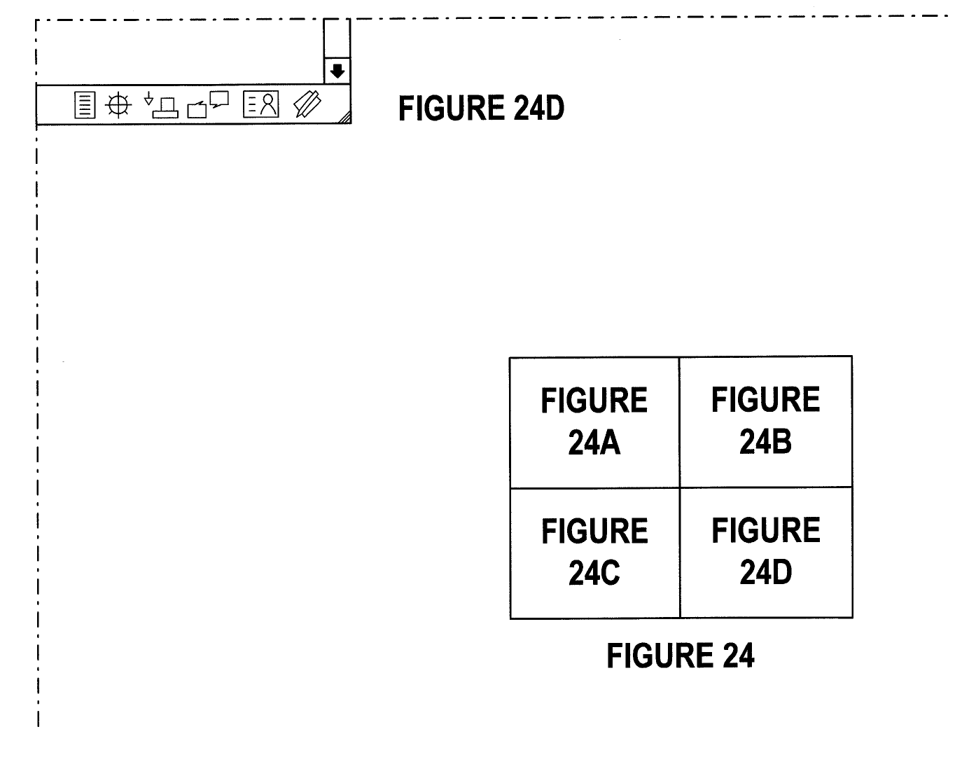

After steps 2014-2016, alert manager 114 processes the next alert message according to the loop of steps 2002-2018 until all alert messages have been processed. Once an alert message is processed by alert manager 114, the alert message is not immediately removed from the alert queue. Instead, the alert message remains on the alert queue until the designated clinician, or another clinician, removes the alert. The clinician can remove the alert by sending a user-generated signal indicating that the alert is acknowledged but disregarded, by sending a user-generated signal representing a change in the drug order or orders to which the alert pertains. FIG. 24 shows an HTML form by which the clinician acknowledges and ADE alert and enters the outcome of the alerted condition. FIG. 26 shows an HTML form by which the clinician acknowledges a dosage alert and enters data representing the outcome of the alerted condition.

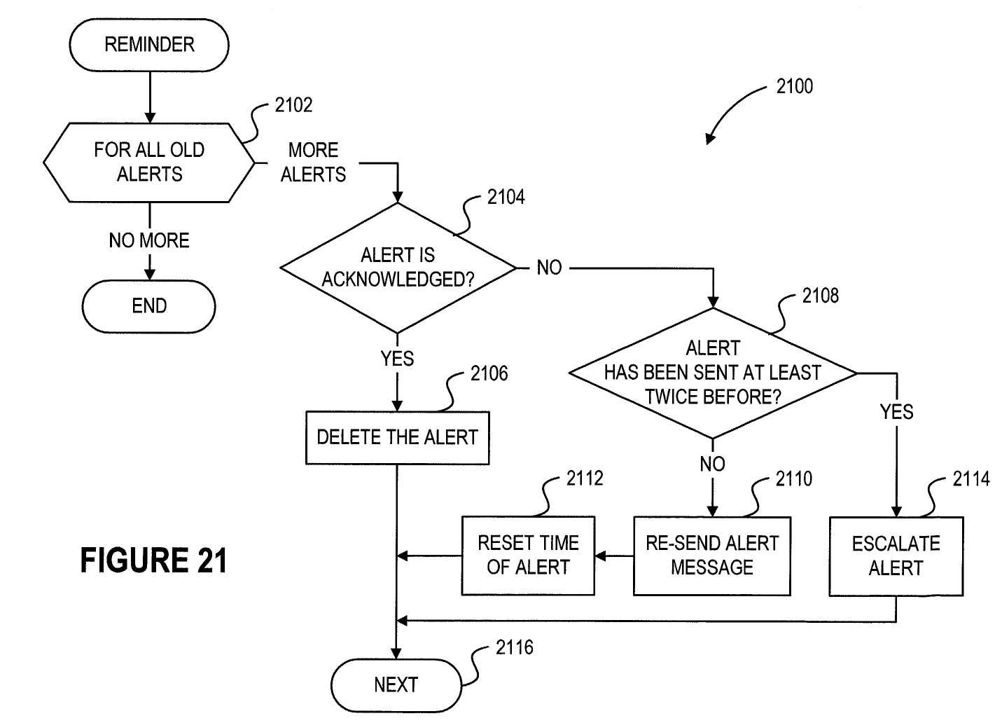

Logic flow diagram 2100 (FIG. 21) shows processing by alert manager 114 when alert messages have been in the alert queue for at least a predetermined period of time, e.g., one hour. Such alert messages are sometimes referred to herein as old alert messages. Loop step 2102 and next step 2116 define a loop in which each old alert message is processed according to steps 2104-2114. During each iteration of the loop of steps 2102-2116, the particular old alert message processed by alert manager 114 is sometimes referred to as the subject old alert message.

In test step 2104, alert manager 114 determines whether the subject old alert message has been acknowledge, e.g., by use of the HTML forms of either FIG. 24 or FIG. 26. If the subject old alert message has been acknowledged, alert manager 114 deletes the subject old alert message from the alert queue in step 2106 and the next old alert message is processed according to the loop of steps 2102-2116. Conversely, if the subject old alert message has not been acknowledged, processing transfers from test step 2104 to test step 2108.

In test step 2108, alert manager 114 determines the number of times the subject old alert message has been sent. Alert manager 114 maintains a times-sent record for each alert message in the alert queue. If the subject old alert message has been sent less than three times before, alert manager 114 re-sends the subject old alert message in step 2110 and records the time of last sending for the subject old alert message in the alert queue. If, on the other hand, the subject old alert message has been sent at least three times before, alert message escalates the alert message in step 2114.

Alert manager 114 escalates an alert message by including an escalation banner in the alert message to indicate the urgency of the alert message. In addition, alert manager 114 sends the alert message to a wireless telephone as a voice message and/or to a pager according to the scheduled contact information, in addition to the other methods of alert message delivery described above.

Thus, alert manager 114 processes alerts from both dosage monitor 102 and ADE monitor in an orderly manner and ensures that the alert messages go to the appropriate person. In addition, if an alert message goes unacknowledged for a predetermined amount of time, alert manager 114 escalates the alert message and tries more direct methods of reaching a designated clinician. In this manner, alert manager 114, dosage monitor 102, and ADE monitor 104 cooperate to reduce significant risks associated with ADEs and dosage errors and do so without significant interruption of the daily routines of clinicians serving the needs of patient in a healthcare organization.

Alert Viewing

Alert manager 114 providers users with the ability to view alert summaries or details via a wide area computer network such as the World Wide Web (the WEB). At the summary level, alert manager 114 provides a full range of sorting options including alert date, alert severity, alert destination, patient name, etc. Full ranges of filtering options are also available including: alert destination, alert date ranges, alert severity, etc. The summary page provides a link to the detailed information about an alert. At the detail level, all relevant information about an alert is visible as well as links to specific information about the drugs that are in question.

The alert links can be referenced from any other WEB based application, which makes it easy to include Drug Alert information in a patient medical record.

Rule Viewing and Writing

Dosage monitor 102 and ADE monitor 104 provider users with the ability to view the rules for drugs within the system 100. The interface provides filtering options for drug name, implementation date, firing frequency, alerting frequency and rule status (e.g. development, test, production). Rules can be sorted by drug name, implementation date, firing frequency, alerting frequency and rule status. Printing is fully functional. All users are allowed to view alerts.

This interface also provides an authorized user to write new rules. The interface does extensive error checking to ensure that rules meet the criteria of the application and gives explicit guidance where errors are discovered. Users select the rule type they wish to create (e.g. drug-drug interaction, drug dosing, drug-lab, drug-allergy) and are then presented with the information that needs to be completed to write the rules. Selection lists are available for most fields so that the user can specify difficult-to-remember items easily. The system is designed so that many users can write rules and monitor their performance. However, it takes an administrator of the system to move rules from test into production. This provides the capability to control the rules that are operating within an environment.

Outcome Entry and Analysis

For each drug alert, a customized outcome form exists. This form is sent via fax to the appropriate user along with the alert information. Users may either respond to an alert by entering the outcome information via the WEB (accessible from the Alert Viewing application) or by completing the form and faxing it back to an information systems group where it is scanned and entered into the database.

Several analysis and reporting processes exist to analyze the effectiveness of the clinical decision support applications. These procedures also help identify differences between pharmacist agreement rates by drug, hospital location, and individual user. Using this information, an institution can identify rules that may need adjustments or clinical staff that may need additional training regarding the clinical information that dosage monitor 102 presents.

The application contains several reports and charts which can be displayed on the WEB. The application also contains a robust data extraction process, including ODBC capabilities which allow users to use their own reporting and analysis tools (e.g. Excel, SAS, Crystal Reports).

The above description is illustrative only and is not limiting. Instead, the present invention is defined solely by the claims which follow and their full range of equivalents.

what is claimed is:

1. A method for detecting dosage errors in one or more drugs administered to a patient, the method comprising:
for each of the one or more drugs:
comparing an order of the drug to one or more predetermined limits; and
determining that the drug is dosed in error if the order of the drug exceeds the one or more predetermined limits.

2. The method of claim 1 wherein the order of the drug is a course of administration of the drug.

3. The method of claim 1 wherein the one or more predetermined limits include one or more allowable dosage amounts of the drug.

4. The method of claim 4 wherein the one or more allowable dosage amounts includes a range of allowable dosage amounts.

5. The method of claim 4 wherein the one or more predetermined limits further include one or more dosage frequencies.

6. The method of claim 4 wherein comparing comprises:
weighting the one or more allowable dosage amounts according to a weight of the patient to produce one or more weighted allowable dosage amounts; and
comparing the order of the drug to the one or more weighted allowable dosage amounts.

7. The method of claim 6 wherein the weight of the patient is an actual measured weight of the patient.

8. The method of claim 6 wherein the weight of the patient is a dosage weight of the patient which is calculated from an actual measured weight of the patient.

9. The method of claim 8 wherein the dosage weight of the patient is further calculated from a measure serum creatinine level of the patient.

10. The method of claim 9 wherein the dosage weight of the patient is calculated according to a creatinine clearance estimation.

11. The method of claim 1 further comprising, for each of the one or more drug orders:
alerting a clinician if the drug is determined to be dosed in error.

12. The method of claim 11 wherein alerting comprises:
sending an alert message to the clinician by e-mail.

13. The method of claim 11 wherein alerting comprises:
sending an alert message to the clinician by an electronic paging device.

14. The method of claim 11 wherein alerting comprises:
sending an alert message to the clinician by telephone.

15. The method of claim 11 wherein alerting comprises:
sending an alert message to the clinician by fax.

16. The method of claim 11 wherein alerting comprises:
receiving an acknowledgment from the clinician in response to the alerting.

17. The method of claim 11 wherein alerting comprises:
determining a level of priority of the alerting; and
alerting the clinician through a communications channel which is chosen in accordance with the level of priority.

18. The method of claim 11 wherein alerting comprises:
sending an alert message with a first degree of priority; and
sending the alert message with a second, higher degree of priority if the alert message is not acknowledged within a predetermined amount of time from the first-mentioned sending.

19. The method of claim 11 wherein alerting comprises:
sending an alert message to the clinician, wherein the alert message includes one or more recommended dosage limits for the drug.

20. The method of claim 19 wherein the one or more recommended dosage limits include one or more recommended dosage amounts.
